(19) United States
(12) Patent Application Publication
(10) Pub. No.: US 2025/0040539 A1
(43) Pub. Date: Feb. 6, 2025

(54) COMPOSITION COMPRISING AN ANTIMICROBIAL AGENT AND A CARBOXAMIDE

(71) Applicant: BASF SE, Ludwigshafen am Rhein (DE)

(72) Inventors: Hauke ROHWER, Grenzach-Wyhlen (DE); Juergen WIETHAN, Grenzach-Wyhlen (DE)

(73) Assignee: BASF SE, Ludwigshafen am Rhein (DE)

(21) Appl. No.: 18/720,170

(22) PCT Filed: Dec. 16, 2022
(86) PCT No.: PCT/EP2022/086415

§ 371 Date: Jun. 14, 2024

(30) Foreign Application Priority Data
Dec. 17, 2021 (EP) 21215671.5

(51) Int. Cl. A01N 31/14; A01N 25/02; A01N 31/16; A01N 43/80; A01P 1/00

(52) U.S. Cl. CPC A01N 31/14; A01N 25/02; A01N 31/16; A01N 43/80; A01P 1/00

(57) ABSTRACT

The present invention relates to a composition comprising an antimicrobial agent (a) as defined in the claims and the description and a specific carboxamide (b) of formula (I), (I), wherein the variables are as defined in the claims and the description; to the use of said carboxamide for enhancing the antimicrobial, in particular the preserving, activity of the antimicrobial agent (a), to a method for enhancing the antimicrobial, in particular the preserving, activity of the antimicrobial agent (a), comprising using the antimicrobial agent (a) in combination with said carboxamide, and to a mixture consisting of at least one antimicrobial agent (a), at least one carboxamide compound of the formula (I) and optionally at least one solvent [different from the carboxamide compounds of the formula (I)].

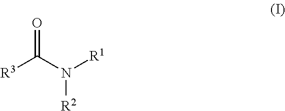

The present invention relates to a composition comprising an antimicrobial agent (a) as defined below and a specific carboxamide (b) of formula (I) as defined below, to the use of a carboxamide compound of the formula (I) as defined below for enhancing the antimicrobial, in particular the preserving, activity of the antimicrobial agent (a), to the use of said antimicrobial agent (a) in combination with said carboxamide (I) for combating microbes; to a method for enhancing the antimicrobial, in particular the preserving, activity of the antimicrobial agent (a) comprising using the antimicrobial agent (a) in combination with the carboxamide (I), and to a mixture consisting of at least one antimicrobial agent (a) as defined below, at least one carboxamide compound of the formula (I) as defined below and optionally at least one solvent [different from the carboxamide compounds of the formula (I)].

### TECHNICAL BACKGROUND

Antimicrobial agents, like those listed below as component (a), are well established preservatives or biocides in a vast range of application areas. A number of products and materials is susceptible to microbial attack or degradation, which attack not only reduces the economic value of such products or materials, but may even pose a health hazard for the user. Microbial degradation in aqueous systems can become manifest in many forms, such as loss of viscosity, emulsion breaking, change of pH, color change, unpleasant odor, fouling, gas formation, slime formation, to name just a few and easily identifiable indicators. Some of these manifestation also occur in non-aqueous systems, e.g. fouling in fuels, heating oils, crude oils and the like. Antimicrobial agents are either incorporated into susceptible products or materials to preserve them, or are used as such or in suitable formulations to treat infected products or materials. Examples for products, materials and formulations containing antimicrobial agents are homecare compositions and articles, compositions and articles for cleaning or disinfecting on an industrial scale, personal care compositions and articles, process water, water in fish or shrimp ponds, water in drinking troughs, metal working fluids; water based raw materials, polymer solutions, polymer dispersions, polymer emulsions, inorganic slurries, organic slurries, surfactant compositions; compositions for treating animal hide, leather, textiles, lumber, or paper or the precursor materials thereof during papermaking processes; crop protection compositions; pharmaceutical compositions; paints, glues, adhesives, sealants, dyes, pigments and dispersions thereof, inks and the like.

However, some established antimicrobial agents have been found to cause health risks. For instance, formaldehyde-releasing antimicrobials have lost acceptance because formaldehyde is classified as carcinogenic, mutagenic and as having reproductive toxicity. Halogenated organic antimicrobials, too, have lost ground because they exhibit a certain level of toxic effects, especially when combined with certain other ingredients usually present in the compositions which they are to preserve.

The remaining antimicrobials which are not or at least less hazardous, like 2-phenoxyethanol, are often not very effective and need to be used in rather high concentrations to achieve an acceptable antimicrobial effect. In many applications, high concentrations are however not acceptable; for instance because of formulation issues or malodour or because beyond a certain concentration these products become hazardous, too. Moreover, under certain circumstances even high concentrations fail to give the desired effect.

Therefore, at least in certain applications it is not yet possible to renounce completely more hazardous, but very effective antimicrobials. It is however desired to reduce their amount to a minimum.

Altogether it is desirable to reduce the amount of antimicrobials, since intrinsically all of them pose a certain, albeit small, health or environmental risk (otherwise they wouldn't have an antimicrobial effect), but at the same time the desired antimicrobial effect should not be compromised.

Accordingly, there is a need to improve the effect of antimicrobials. Specifically, in case of non- or less hazardous, but less effective antimicrobials, it is desired to boost their effect so that they can be applied in low or at least reasonable concentrations. In the specific case of more hazardous, but efficacious antimicrobials, it is desired to boost their effect so that their concentrations can be minimized to an extent which makes their application acceptable.

US 2013/0101530 relates to the preservation of personal care formulations containing synergistic blends of an n-undecylenic acid derivative, an n-octanoic acid derivative and an alcohol ether selected from 2-phenoxyethanol, 2-ethylhexylgylceryl ether and mixtures thereof. The undecylenic acid derivative is either an amide carrying one or two short-chained alkyl groups (C₁-C₃) substituted by OH, COOH or various amino or ammonium groups, or is an anhydride or an ester. The octanoic acid derivative is an amide carrying one or two methyl or ethyl groups substituted by OH or COOH.

WO 96/38043 relates to the use of certain N—(C₆-C₁₈-alkyl) heterocyclic compounds which are said to potentiate the biocidal activity of the micobicides 5-chloro-2-methyl-4-isothiazolin-3-one, 2-methyl-4-isothiazolin-3-one, bronopol (2-bromo-2-nitropropane-1,3-diol), IPBC (iodopropargyl butyl carbamate), IPC (iodopropargyl carbamate), DBNPA (2,2-dibromo-3-nitrilopropionamide), tribromophenol or BIT (1,2-benzisothiazolin-3-one). The N—(C₆-C₁₈-alkyl) heterocyclic compounds tested are dodecyl morpholine and dodecyl imidazole.

KR 10-2005-0077408 relates to a liquid detergent composition containing a quaternary ammonium salt, a polyhexamethyl bisguanidine as cationic disinfectant, an oil-soluble solvent, a fat-soluble solvent, a penetrating agent, an alkali agent and a surfactant.

Among many others, ethylene gylcol monophenyl ether (in other words 2-phenoxyethanol) is listed as fat-soluble solvent; it is however neither preferred nor exemplified. Penetrants are for example N-octyl- or N-dodecylpyrrolidone.

DE 102011082136 A1 relates to a non-aqueous cleaning composition for removing cured casting resins, adhesives, assembly foams, paint films and paint residue present on surfaces of machine parts, tools, plant components, workpieces and components, comprising a polyglycol monoether compound, an aromatic substituted alkyl alcohol, a non-toxic nitrogen heterocyclic compound and an alkali metal hydroxide. Aromatic substituted alkyl alcohols are for example 2-phenoxyethanol, 1-phenylethanol and mixtures thereof. Among several others, N-methylpiperidone, N-ethylpyrrolidone and 1,5-dimethylpyrrolidone are listed as suitable nitrogen heterocyclic compound.

### SUMMARY OF THE INVENTION

The object of the present invention is to improve the effect of certain antimicrobials. A more specific object is to provide a composition with an improved preservative and/or biocidal effect.

The inventors of the present invention found that carboxamides of the formula (I) as defined below improve the preservative and/or biocidal effect of certain antimicrobials.

The present invention therefore relates to a composition comprising
(a) at least one (generally 1, 2 or 3, preferably 1 or 2, specifically 1) antimicrobial agent selected from the group consisting of 2-phenoxyethanol, phenoxyisopropanol, 4,4′-dichloro 2′-hydroxydiphenylether (diclosan), 2-bromo-2-nitropropane-1,3-diol (bronopol), glutaraldehyde, 2,4-dichlorobenzylalcohol, 1,3,5-tris-(2-hydroxyethyl)-1,3,5-hexahydrotriazine, formic acid and salts thereof, benzoic acid and salts thereof, sorbic acid and salts thereof, lactic acid and salts thereof, isothiazolinones selected from the group consisting of 1,2-benzisothiazol-3(2H)-one (BIT), 2-methyl-2H-isothiazol-3-one (MIT), 2-octyl-2H-isothiazol-3-one (OIT), 5-chloro-2-methyl-2H-isothiazol-3-one (CMIT), and 2-butyl-benzo[d]isothiazol-3-one (BBIT); 3-iodo-2-propynylbutylcarbamate (IPBC); benzyl alcohol, pyridine-2-thiol 1-oxide and salts thereof; 2,2-dibromo-2-cyanoacetamide (DBNPA), N-(3-aminopropyl)-N-dodecylpropane-1,3-diamine (Diamine), tetrakis(hydroxymethyl)phosphonium sulphate(2:1) (THPS), 2,2-dithiobis[N-methylbenzamide](DTBMA), 2-bromo-2-(bromomethyl)pentanedinitril (DBDCB), biphenyl-2-ol (synonyms 2-phenylphenol, o-phenylphenol) and salts thereof; and mixtures thereof; and
(b) a carboxamide compound of the formula (I) or a mixture of different carboxamide compounds of the formula (I) [the mixture generally comprising 2, 3 or 4, preferably 2 or 3, in particular 2 different carboxamide compounds of the formula (I)]

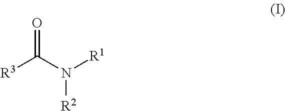

where
R¹ is hydrogen or C₁-C₈-alkyl;
R² is C₆-C₁₈-alkyl or C₆-C₁₈-alkenyl; and
R³ is C₂-C₆-alkenyl which carries a group —C(O)OH or C(O)O⁻M⁺, where M⁺ is a cation equivalent;
or
R¹ and R², independently of each other, are C₁-C₈-alkyl; and
R³ is C₁-C₁₃-alkyl or C₄-C₁₂-alkenyl;
where R¹, R² and R³ have in sum from 6 to 18 carbon atoms;
or
R¹ and R², together with the nitrogen atom to which they are bound, form a 5-, 6-, or 7-membered saturated, partially unsaturated or maximally unsaturated heterocyclic ring which may contain a further heteroatom or heteroatom group selected from O, N, S, S(O) or S(O)₂ as ring member, where the heterocyclic ring may carry one or more substituents R⁴;
R³ is C₁-C₁₃-alkyl; and
each R⁴ is independently selected from the group consisting of halogen, CN, NO₂, OH, SH, NH₂, C(O)OH, C(O)O⁻M⁺, where M⁺ is a cation equivalent; C(O)NH₂, oxo and C₁-C₄-alkyl;
or
R¹ and R³, together with the atoms to which they are bound, form a 5-, 6-, or 7-membered saturated, heterocyclic ring which may contain a further heteroatom or heteroatom group selected from O, N, S, S(O) or S(O)₂ as ring member, where the heterocyclic ring may carry one or more substituents R⁴; and
R² is hydrogen or C₁-C₅-alkyl; and
each R⁴ is independently selected from the group consisting of halogen, CN, NO₂, OH, SH, NH₂, C(O)OH, C(O)O⁻M⁺, where M⁺ is a cation equivalent; C(O)NH₂, oxo and C₁-C₄-alkyl;
where components (a) and (b) are present in an overall weight ratio of from 500:1 to 1:1000;
preferably with the proviso that the composition does not contain poly(hexamethylene biguanidine) and salts thereof; and preferably with the proviso that in case the composition is non-aqueous, the composition does not contain any alkali metal hydroxide; and further preferably with the proviso that the carboxamide compound of the formula
(I) is not N-methylpyrrolidione;
that the composition does not contain an alkyl lactate if the antimicrobial agent is benzyl alcohol and simultaneously in the carboxamide compound of the formula (I) R¹ and R² are C₁-C₄-alkyl and R³ is C₅-C₁₃-alkyl;
that the antimicrobial agent is not formic acid or benzoic acid or lactic acid or a salt thereof if in the carboxamide compound of the formula (I) R¹ and R² are C₁-C₈-alkyl; and R³ is C₁-C₁₃-alkyl;
that the composition does not contain any parabene if the antimicrobial agent is 2-phenoxyethanol and simultaneously in the carboxamide compound of the formula (I) R¹ and R² methyl and R³ is C₃-C₁₃-alkyl; and
that the composition does not contain simultaneously benzyl alcohol, N,N-dimethyloctanamide, N,N-dimethyldecanamide, castor oil ethoxylate, EO/PO copolymer and an ethoxylated phosphate ester.

The invention relates moreover to the use of a carboxamide compound of the formula (I) as defined above as component (b) for enhancing the antimicrobial, in particular the preserving, activity of the antimicrobial agent as defined above as component (a).

The invention relates furthermore to the use of said antimicrobial agent as defined above as component (a) in combination with said carboxamide compound of the formula (I) as defined above as component (b) for combating microbes.

The invention relates also to a method for enhancing the antimicrobial, in particular the preserving, activity of the antimicrobial agent as defined above as component (a), comprising using the antimicrobial agent (a) in combination with the carboxamide (I).

The invention relates also to a method for combating microbes, comprising applying said antimicrobial agent in combination with the carboxamide (I) to a composition, surface, area or space in or on which microbes are to be combated.

The invention relates further to a kit of parts comprising at least two parts, where the first part comprises at least one (generally 1, 2 or 3, preferably 1 or 2, specifically 1) antimicrobial agent as defined above as component (a); the second part comprises at least one (generally 1, 2 or 3, preferably 1 or 2, specifically 1) carboxamide compound of the formula (I) as defined above as component (b) and optionally at least one (generally 1, 2 or 3, preferably 1 or 2, specifically 1) organic solvent [different from the carboxamide compounds of the formula (I)]; and an optional third part comprises at least one (generally 1, 2 or 3, preferably 1 or 2, specifically 1) organic solvent [different from the carboxamide compounds of the formula (I)].

The invention relates also to a mixture consisting of at least one (generally 1, 2 or 3, preferably 1 or 2, specifically 1) antimicrobial agent as defined above as component (a), at least one (generally 1, 2 or 3, preferably 1 or 2, specifically 1) carboxamide compound of the formula (I) as defined above as component (b) and optionally at least one solvent [different from the carboxamide compounds of the formula (I)].

### DETAILED DESCRIPTION OF THE INVENTION

### Definitions

An antimicrobial agent or short antimicrobial is an agent that combats or controls microbes. Unless specified otherwise, in terms of the present invention, the expressions “microbicide” and “biocide” are used as synonyms for antimicrobials.

Microbes in the terms of the present invention are undesired harmful microorganisms and comprise bacteria, fungi (including yeasts and molds), microscopic algae, protozoans and, despite the fact that they are generally not considered as living beings, also viruses.

An antimicrobial effect encompasses a preservative as well as a biocidal effect Preservative or preserving effect in terms of the present invention means that the material or product as such comprising an antimicrobial agent is protected against deterioration by microbial attack. As a consequence, the thusly protected material or product has for example a longer storage stability. Just by way of example, an antimicrobial is used in a laundry detergent composition as a preservative to keep the composition storage-stable by avoiding or reducing the proliferation or growth of microbes present therein and thus avoiding or reducing the deterioration of the properties of the composition, such as the formation of malodours, a change in viscosity or pH, a phase separation etc. Biocidal effect in terms of the present invention means that the composition comprising an antimicrobial agent exerts its antimicrobial effect on a product or material treated with and different from this composition. To stay with the example of a laundry detergent composition containing an antimicrobial, this composition exerts a biocidal effect in terms of the present invention if microorganisms on or in laundry treated therewith are killed or hampered in their proliferation or growth by the application of said composition. Another example of a biocidal application is a disinfectant or sanitizer composition which exerts its biocidal effect on materials or products treated therewith.

The biocidal effect has to be fast, since microbes on or in the treated materials or products have to be eliminated or reduced within seconds or minutes, whereas the preservative effect is a long-term effect, since it has to prevail throughout the shelf-life of the product, which can be years. Many antimicrobials have both a preservative and a biocidal effect, the prevalence depending mainly on the concentration of the antimicrobial in the composition.

Phenoxyisopropanol is 1-phenoxy-propan-2-ol. Commercially available phenoxyisopropanol may however also contain minor amounts (i.e. up to 5% by weight) of the isomeric 2-phenoxy-propan-2-ol; such mixtures also fall under the term “phenoxyisopropanol” as used in context of the present invention. Phenoxyisopropanol contains a stereogenic center and can thus be present in form of the essentially pure S enantiomer, the essentially pure R enantiomer and mixtures of the two enantiomers, including racemic mixtures. The present invention encompasses both the use of the essentially pure enantiomers and of mixtures of the two enantiomers, including racemic mixtures. Generally, however, the racemate is used, since this is the commercially most common form thereof.

The organic moieties mentioned below are—like the term halogen—collective terms for individual listings of the individual group members. The prefix Cₙ-Cₘ indicates in each case the possible number of carbon atoms in the group.

The term halogen denotes in each case fluorine, bromine, chlorine or iodine, in particular fluorine, chlorine or bromine.

The term “alkyl” as used herein and in the alkyl moieties of alkoxy refers to saturated straight-chain (linear) or branched hydrocarbon radicals having 1 or 2 (“C₁-C₂ alkyl”), 1 to 3 (“C₁-C₃-alkyl”), 1 to 4 (“C₁-C₄-alkyl”), 1 to 5 (“C₁-C₅-alkyl”), 1 to 8 (“C₁-C₈- alkyl”), 1 to 12 (“C₁-C₁₂-alkyl”), 1 to 13 (“C₁-C₁₃-alkyl”), 3 to 8 (“C₃-C₈-alkyl”), 4 to 8 (“C₄-C₈-alkyl”), 5 to 13 (“C₅-C₁₃-alkyl”), 6 to 12 (“C₆-C₁₂-alkyl”), 6 to 18 (“C₆-C₁₈-alkyl”) or 7 to 11 (“C₇-C₁₁-alkyl”) carbon atoms. C₁-C₂-Alkyl denotes a saturated linear or branched aliphatic radical with 1 or 2 carbon atoms. Examples are methyl and ethyl. C₁-C₃-Alkyl denotes a saturated linear or branched aliphatic radical with 1 to 3 carbon atoms. Examples are methyl, ethyl, n-propyl or isopropyl. C₁-C₄-Alkyl denotes a saturated linear or branched aliphatic radical with 1 to 4 carbon atoms. Examples are methyl, ethyl, n-propyl, isopropyl, n-butyl, sec-butyl, isobutyl and tert-butyl. C₁-C₅-Alkyl denotes a saturated linear or branched aliphatic radical with 1 to 5 carbon atoms. Examples are, in addition to those mentioned for C₁-C₄-alkyl, n-pentyl, 1-methylbutyl, 2-methylbutyl, 3-methylbutyl, 2,2-dimethylpropyl, 1-ethylpropyl, 1,1-dimethylpropyl and 1,2-dimethylpropyl. C₁-C₆-Alkyl denotes a saturated linear or branched aliphatic radical with 1 to 6 carbon atoms. Examples are, in addition to those mentioned for C₁-C₅-alkyl, n-hexyl, 1-methylpentyl, 2-methylpentyl, 3-methylpentyl, 4-methylpentyl, 1,1-dimethylbutyl, 1,2-dimethylbutyl, 1,3-dimethylbutyl, 2,2-dimethylbutyl, 2,3-dimethylbutyl, 3,3-dimethylbutyl, 1-ethylbutyl, 2-ethylbutyl, 1,1,2-trimethylpropyl, 1,2,2-trimethylpropyl, 1-ethyl-1-methylpropyl, or 1-ethyl-2-methylpropyl. C₁-C₈-Alkyl denotes a saturated linear or branched aliphatic radical with 1 to 8 carbon atoms. Examples are, in addition to those mentioned for C₁-C₆-alkyl, n-heptyl, structural isomers thereof, n-octyl, 2-ethylhexyl and other structural isomers thereof. C₁-C₁₂-Alkyl denotes a saturated linear or branched aliphatic radical with 1 to 12 carbon atoms. Examples are, in addition to those mentioned for C₁-C₈-alkyl, n-nonyl, n-decyl, n-undecyl, n-dodecyl and structural isomers thereof. C₁-C₁₃-Alkyl denotes a saturated linear or branched aliphatic radical with 1 to 13 carbon atoms. Examples are, in addition to those mentioned for C₁-C₁₂-alkyl, tridecyl and structural isomers thereof. C₄-C₈-Alkyl denotes a saturated linear or branched aliphatic radical with 4 to 8 carbon atoms. Examples are n-butyl, sec-butyl, isobutyl, tert-butyl, n-pentyl, 1-methylbutyl, 2-methylbutyl, 3-methylbutyl, 2,2-dimethylpropyl, 1-ethylpropyl, 1,1-dimethylpropyl, 1,2-dimethylpropyl, n-hexyl, 1-methylpentyl, 2-methylpentyl, 3-methylpentyl, 4-methylpentyl, 1,1-dimethylbutyl, 1,2-dimethylbutyl, 1,3-dimethylbutyl, 2,2-dimethylbutyl, 2,3-dimethylbutyl, 3,3-dimethylbutyl, 1-ethylbutyl, 2-ethylbutyl, 1,1,2-trimethylpropyl, 1,2,2-trimethylpropyl, 1-ethyl-1-methylpropyl, 1-ethyl-2-methylpropyl, n-heptyl, structural isomers thereof, n-octyl, 2-ethylhexyl and other structural isomers thereof. C₃-C₈-Alkyl denotes a saturated linear or branched aliphatic radical with 3 to 8 carbon atoms. Examples are in addition to those listed above for C₄-C₈-alkyl, n-propyl and isopropyl. C₇-C₁₁-Alkyl denotes a saturated linear or branched aliphatic radical with 7 to 11 carbon atoms. Examples are n-heptyl, n-octyl, 2-ethylhexyl, n-nonyl, n-decyl, n-undecyl and structural isomers thereof. C₆-C₁₂-Alkyl denotes a saturated linear or branched aliphatic radical with 6 to 12 carbon atoms. Examples are, in addition to those mentioned for C₇-C₁₁-alkyl, n-hexyl, 1-methylpentyl, 2-methylpentyl, 3-methylpentyl, 4-methylpentyl, 1,1-dimethylbutyl, 1,2-dimethylbutyl, 1,3-dimethylbutyl, 2,2-dimethylbutyl, 2,3-dimethylbutyl, 3,3-dimethylbutyl, 1-ethylbutyl, 2-ethylbutyl, 1,1,2-trimethylpropyl, 1,2,2-trimethylpropyl, 1-ethyl-1-methylpropyl, 1-ethyl-2-methylpropyl, n-dodecyl and structural isomers thereof. C₅-C₁₃-Alkyl denotes a saturated linear or branched aliphatic radical with 5 to 13 carbon atoms. Examples are, in addition to those mentioned for C₆-C₁₂-alkyl, n-pentyl, 1-methylbutyl, 2-methylbutyl, 3-methylbutyl, 2,2-dimethylpropyl, 1-ethylpropyl, 1,1-dimethylpropyl, 1,2-dimethylpropyl, tridecyl and structural isomers thereof. C₆-C₁₈-Alkyl denotes a saturated linear or branched aliphatic radical with 6 to 18 carbon atoms. Examples are, in addition to those mentioned for C₆-C₁₂-alkyl, tridecyl, tetradecyl, pentadecyl, hexadecyl, heptadecyl, octadecyl and structural isomers thereof.

The term “alkenyl” as used herein indicates monounsaturated (i.e. containing one C—C double bond) straight-chain or branched aliphatic hydrocarbon radicals having 2 to 6 (“C₂-C₆-alkenyl”) or 4 to 12 (“C₄-C₁₂-alkenyl”) or 7 to 11 (“C₇-C₁₁-alkenyl”) or 6 to 18 (“C₆-C₁₈-alkenyl”) carbon atoms. C₂-C₆-Alkenyl is a monounsaturated straight-chain or branched aliphatic hydrocarbon radical having 2 to 6 carbon atoms. Examples are ethenyl, 1-propenyl, 2-propenyl, 1-methylethenyl, 1-butenyl, 2-butenyl, 3-butenyl, 1-methyl-1-propenyl, 2-methyl-1-propenyl, 1-methyl-2-propenyl, 2-methyl-2-propenyl, 1-pentenyl, 2-pentenyl, 3-pentenyl, 4-pentenyl, 1-methyl-1-butenyl, 2-methyl-1-butenyl, 3-methyl-1-butenyl, 1-methyl-2-butenyl, 2-methyl-2-butenyl, 3-methyl-2-butenyl, 1-methyl-3-butenyl, 2-methyl-3-butenyl, 3-methyl-3-butenyl, 1,1-dimethyl-2-propenyl, 1,2-dimethyl-1-propenyl, 1,2-dimethyl-2-propenyl, 1-ethyl-1-propenyl, 1-ethyl-2-propenyl, 1-hexenyl, 2-hexenyl, 3-hexenyl, 4-hexenyl, 5-hexenyl, 1-methyl-1-pentenyl, 2-methyl-1-pentenyl, 3-methyl-1-pentenyl, 4-methyl-1-pentenyl, 1-methyl-2-pentenyl, 2-methyl-2-pentenyl, 3-methyl-2-pentenyl, 4-methyl-2-pentenyl, 1-methyl-3-pentenyl, 2-methyl-3-pentenyl, 3-methyl-3-pentenyl, 4-methyl-3-pentenyl, 1-methyl-4-pentenyl, 2-methyl-4-pentenyl, 3-methyl-4-pentenyl, 4-methyl-4-pentenyl, 1,1-dimethyl-2-butenyl, 1,1-dimethyl-3-butenyl, 1,2-dimethyl-1-butenyl, 1,2-dimethyl-2-butenyl, 1,2-dimethyl-3-butenyl, 1,3-dimethyl-1-butenyl, 1,3-dimethyl-2-butenyl, 1,3-dimethyl-3-butenyl, 2,2-dimethyl-3-butenyl, 2,3-dimethyl-1-butenyl, 2,3-dimethyl-2-butenyl, 2,3-dimethyl-3-butenyl, 3,3-dimethyl-1-butenyl, 3,3-dimethyl-2-butenyl, 1-ethyl-1-butenyl, 1-ethyl-2-butenyl, 1-ethyl-3-butenyl, 2-ethyl-1-butenyl, 2-ethyl-2-butenyl, 2-ethyl-3-butenyl, 1,1,2-trimethyl-2-propenyl, 1-ethyl-1-methyl-2-propenyl, 1-ethyl-2-methyl-1-propenyl, 1-ethyl-2-methyl-2-propenyl and the like. C₄-C₁₂-Alkenyl is a monounsaturated straight-chain or branched aliphatic hydrocarbon radical having 4 to 12 carbon atoms. Examples are, 1-butenyl, 2-butenyl, 3-butenyl, 1-methyl-1-propenyl, 2-methyl-1-propenyl, 1-methyl-2-propenyl, 2-methyl-2-propenyl, 1-pentenyl, 2-pentenyl, 3-pentenyl, 4-pentenyl, 1-methyl-1-butenyl, 2-methyl-1-butenyl, 3-methyl-1-butenyl, 1-methyl-2-butenyl, 2-methyl-2-butenyl, 3-methyl-2-butenyl, 1-methyl-3-butenyl, 2-methyl-3-butenyl, 3-methyl-3-butenyl, 1,1-dimethyl-2-propenyl, 1,2-dimethyl-1-propenyl, 1,2-dimethyl-2-propenyl, 1-ethyl-1-propenyl, 1-ethyl-2-propenyl, 1-hexenyl, 2-hexenyl, 3-hexenyl, 4-hexenyl, 5-hexenyl, 1-methyl-1-pentenyl, 2-methyl-1-pentenyl, 3-methyl-1-pentenyl, 4-methyl-1-pentenyl, 1-methyl-2-pentenyl, 2-methyl-2-pentenyl, 3-methyl-2-pentenyl, 4-methyl-2-pentenyl, 1-methyl-3-pentenyl, 2-methyl-3-pentenyl, 3-methyl-3-pentenyl, 4-methyl-3-pentenyl, 1-methyl-4-pentenyl, 2-methyl-4-pentenyl, 3-methyl-4-pentenyl, 4-methyl-4-pentenyl, 1,1-dimethyl-2-butenyl, 1,1-dimethyl-3-butenyl, 1,2-dimethyl-1-butenyl, 1,2-dimethyl-2-butenyl, 1,2-dimethyl-3-butenyl, 1,3-dimethyl-1-butenyl, 1,3-dimethyl-2-butenyl, 1,3-dimethyl-3-butenyl, 2,2-dimethyl-3-butenyl, 2,3-dimethyl-1-butenyl, 2,3-dimethyl-2-butenyl, 2,3-dimethyl-3-butenyl, 3,3-dimethyl-1-butenyl, 3,3-dimethyl-2-butenyl, 1-ethyl-1-butenyl, 1-ethyl-2-butenyl, 1-ethyl-3-butenyl, 2-ethyl-1-butenyl, 2-ethyl-2-butenyl, 2-ethyl-3-butenyl, 1,1,2-trimethyl-2-propenyl, 1-ethyl-1-methyl-2-propenyl, 1-ethyl-2-methyl-1-propenyl, 1-ethyl-2-methyl-2-propenyl, 1-heptenyl, 2-heptenyl, 3-heptenyl, 4-heptenyl, 5-heptenyl, 6-heptenyl, 1-octenyl, 2-octenyl, 3-octenyl, 4-octenyl, 5-octenyl, 6-octenyl, 7-octenyl, 1-nonenyl, 2-nonenyl, 3-nonenyl, 4-nonenyl, 5-nonenyl, 6-nonenyl, 7-nonenyl, 8-nonenyl, 1-decenyl, 2-decenyl, 3-decenyl, 4-decenyl, 5-decenyl, 6-decenyl, 7-decenyl, 8-decenyl, 9-decenyl, 1-undecenyl, 2-undecenyl, 3-undecenyl, 4-undecenyl, 5-undecenyl, 6-undecenyl, 7-undecenyl, 8-undecenyl, 9-undecenyl, 10-undecenyl, 1-, 2-, 3-, 4-, 5-, 6-, 7-, 8-, 9-, 10- and 11-dodecenyl, and the structural isomers thereof. C₇-C₁₁-Alkenyl is a monounsaturated straight-chain or branched aliphatic hydrocarbon radical having 7 to 11 carbon atoms. Examples are 1-heptenyl, 2-heptenyl, 3-heptenyl, 4-heptenyl, 5-heptenyl, 6-heptenyl, 1-octenyl, 2-octenyl, 3-octenyl, 4-octenyl, 5-octenyl, 6-octenyl, 7-octenyl, 1-nonenyl, 2-nonenyl, 3-nonenyl, 4-nonenyl, 5-nonenyl, 6-nonenyl, 7-nonenyl, 8-nonenyl, 1-decenyl, 2-decenyl, 3-decenyl, 4-decenyl, 5-decenyl, 6-decenyl, 7-decenyl, 8-decenyl, 9-decenyl, 1-undecenyl, 2-undecenyl, 3-undecenyl, 4-undecenyl, 5-undecenyl, 6-undecenyl, 7-undecenyl, 8-undecenyl, 9-undecenyl, 10-undecenyl, and the structural isomers thereof. C₆-C₁₈-Alkenyl is a monounsaturated straight-chain or branched aliphatic hydrocarbon radical having 6 to 18 carbon atoms. Examples are 1-hexenyl, 2-hexenyl, 3-hexenyl, 4-hexenyl, 5-hexenyl, 1-methyl-1-pentenyl, 2-methyl-1-pentenyl, 3-methyl-1-pentenyl, 4-methyl-1-pentenyl, 1-methyl-2-pentenyl, 2-methyl-2-pentenyl, 3-methyl-2-pentenyl, 4-methyl-2-pentenyl, 1-methyl-3-pentenyl, 2-methyl-3-pentenyl, 3-methyl-3-pentenyl, 4-methyl-3-pentenyl, 1-methyl-4-pentenyl, 2-methyl-4-pentenyl, 3-methyl-4-pentenyl, 4-methyl-4-pentenyl, 1,1-dimethyl-2-butenyl, 1,1-dimethyl-3-butenyl, 1,2-dimethyl-1-butenyl, 1,2-dimethyl-2-butenyl, 1,2-dimethyl-3-butenyl, 1,3-dimethyl-1-butenyl, 1,3-dimethyl-2-butenyl, 1,3-dimethyl-3-butenyl, 2,2-dimethyl-3-butenyl, 2,3-dimethyl-1-butenyl, 2,3-dimethyl-2-butenyl, 2,3-dimethyl-3-butenyl, 3,3-dimethyl-1-butenyl, 3,3-dimethyl-2-butenyl, 1-ethyl-1-butenyl, 1-ethyl-2-butenyl, 1-ethyl-3-butenyl, 2-ethyl-1-butenyl, 2-ethyl-2-butenyl, 2-ethyl-3-butenyl, 1,1,2-trimethyl-2-propenyl, 1-ethyl-1-methyl-2-propenyl, 1-ethyl-2-methyl-1-propenyl, 1-ethyl-2-methyl-2-propenyl, 1-heptenyl, 2-heptenyl, 3-heptenyl, 4-heptenyl, 5-heptenyl, 6-heptenyl, 1-octenyl, 2-octenyl, 3-octenyl, 4-octenyl, 5-octenyl, 6-octenyl, 7-octenyl, 1-nonenyl, 2-nonenyl, 3-nonenyl, 4-nonenyl, 5-nonenyl, 6-nonenyl, 7-nonenyl, 8-nonenyl, 1-decenyl, 2-decenyl, 3-decenyl, 4-decenyl, 5-decenyl, 6-decenyl, 7-decenyl, 8-decenyl, 9-decenyl, 1-undecenyl, 2-undecenyl, 3-undecenyl, 4-undecenyl, 5-undecenyl, 6-undecenyl, 7-undecenyl, 8-undecenyl, 9-undecenyl, 10-undecenyl, 1-, 2-, 3-, 4-, 5-, 6-, 7-, 8-, 9-, 10- and 11-dodecenyl, 1-, 2-, 3-, 4-, 5-, 6-, 7-, 8-, 9-, 10-, 11- and 12-tridecenyl, 1-, 2-, 3-, 4-, 5-, 6-, 7-, 8-, 9-, 10-, 11-, 12- and 13-tetradecenyl, 1-, 2-, 3-, 4-, 5-, 6-, 7-, 8-, 9-, 10-, 11-, 12-, 13- and 14-pentadecenyl, 1-, 2-, 3-, 4-, 5-, 6-, 7-, 8-, 9-, 10-, 11-, 12-, 13-, 14- and 15-hexadecenyl, 1-, 2-, 3-, 4-, 5-, 6-, 7-, 8-, 9-, 10-, 11-, 12-, 13-, 14-, 15- and 16-heptadecenyl, 1-, 2-, 3-, 4-, 5-, 6-, 7-, 8-, 9-, 10-, 11-, 12-, 13-, 14-, 15-, 16- and 17-octadecenyl, and the structural isomers thereof.

The term “C₁-C₄-alkoxy” refers to a C₁-C₄-alkyl group, as defined above, attached via an oxygen atom to the remainder of the molecule. Examples are methoxy, ethoxy, n-propoxy, 1-methylethoxy (isopropoxy), n-butoxy, 1-methylpropoxy (sec-butoxy), 2-methylpropoxy (isobutoxy) or 1,1-dimethylethoxy (tert-butoxy).

Alkylene is a linear or branched divalent alkanediyl radical. C₃-C₅-Alkylene is a linear or branched divalent alkyl radical having 3 to 5 carbon atoms. Examples are —CH₂CH₂CH₂—, —CH(CH₃)CH₂—, —CH₂CH(CH₃)—, —C(CH₃)₂—, —CH₂CH₂CH₂CH₂—, —CH(CH₃)CH₂CH₂—, —CH₂CH₂CH(CH₃)—, —C(CH₃)₂CH₂—, —CH₂C(CH₃)₂—, —(CH₂)₅— and positional isomers thereof. Linear C₃-C₅-alkylene is —CH₂CH₂CH₂—, —CH₂CH₂CH₂CH₂— or —(CH₂)₅—.

Oxo is a group ═O (i.e. it replaces CH₂ by C═O).

M⁺ is a cation equivalent. It stands for a metal cation or an ammonium cation (ammonium in this case stands for both the ammonium cation NH₄⁺ in the proper sense, but also for substituted ammonium cations). In case of cations with double or triple charge, the cation equivalent can be depicted as (Mⁿ⁺)_{1/n}, where n is the charge number.

Heterocyclic rings contain one or more heteroatoms or heteroatom groups selected from O, N, S, S(O) or S(O)₂ and at least one carbon atom as ring members.

Saturated heterocyclic rings contain no unsaturated bond between ring members.

Unsaturated heterocyclic rings contain at least one C—C and/or C—N and/or N—N double bond(s). Maximally unsaturated rings contain as many conjugated C—C and/or C—N and/or N—N double bonds as allowed by the ring size. Maximally unsaturated 5- or 6-membered heteromonocyclic rings are generally aromatic (and thus not enclosed in the present term “heterocyclic ring” or “heterocyclyl”; exceptions being maximally unsaturated 6-membered rings containing O, S, SO and/or SO₂ as ring members, such as pyran and thiopyran, which are not aromatic. Partially unsaturated rings contain less than the maximum number of C—C and/or C—N and/or N—N double bond(s) allowed by the ring size.

Examples for 5-, 6-, or 7-membered saturated heterocyclic rings formed by R¹ and R² together with the nitrogen atom to which they are bound, which may contain a further heteroatom or heteroatom group selected from O, N, S, S(O) or S(O)₂ as ring member, are pyrrolidin-1-yl, pyrazolidin-1-yl, imidazolidin-1-yl, oxazolidin-3-yl, isoxazolidin-2-yl, thiazolidin-3-yl, isothiazolidin-2-yl, piperidin-1-yl, hexahydropyridazin-1-yl, hexahydropyrimidin-1-yl, piperazin-1-yl, morpholin-4-yl (morpholino), thiomorpholin-4-yl, 1-oxothiomorpholin-4-yl, 1,1-dioxothiomorpholin-4-yl, azepan-1-yl and the like.

Examples for 5-, 6-, or 7-membered partially saturated heterocyclic rings formed by R¹ and R² together with the nitrogen atom to which they are bound, which may contain a further heteroatom or heteroatom group selected from O, N, S, S(O) or S(O)₂ as ring member, are pyrrolin-1-yl, oxazolin-3-yl, isoxazolin-2-yl, thiazolin-3-yl, isothiazolin-3-yl, 2,3-dihydropyrazol-1-yl, 2,3-dihydropyrazol-2-yl, 3,4-dihydropyrazol-1-yl, 4,5-dihydropyrazol-1-yl, 2,3-dihydrooxazol-3-yl, 3,4-dihydrooxazol-3-yl, 2,3-dihydroisoxazol-2-yl, dihydropyridin-1-yl, tetrahydropyridin-1-yl, dihydropyridazin-1-yl, tetrahydropyridazin-1-yl, dihydropyrimidin-1-yl, tetrahydropyrimidin-1-yl, 2,3,4,5-tetrahydro[1H]azepin-1-yl, 2,3,4,7-tetrahydro[1H]azepin-1-yl, 2,3,6,7-tetrahydro[1H]azepin-1-yl and the like.

Examples for 5-, 6-, or 7-membered partially saturated heterocyclic rings formed by R¹ and R² together with the nitrogen atom to which they are bound, which may contain a further heteroatom or heteroatom group selected from O, N, S, S(O) or S(O)₂ as ring member, are 1-pyrrolyl, 1-pyrazolyl, 1-imidazolyl, azepin-1-yl and the like.

5-, 6-, or 7-membered saturated, heterocyclic rings formed by R¹ and R³, together with the atoms to which they are bound, which may contain a further heteroatom or heteroatom group selected from O, N, S, S(O) or S(O)₂ as ring member, are lactams. Examples are pyrrolidin-2-on-1-yl, piperidin-2-on-1-yl, piperazin-2-on-1-yl, morpholin-3-on-4-yl and ε-caprolactam.

### Embodiments (E.x) of the Invention

General and preferred embodiments E.x are summarized in the following, nonexhaustive list. Further preferred embodiments become apparent from the paragraphs following this list.

E.0 A composition comprising
(a) at least one antimicrobial agent selected from the group consisting of phenoxyethanol, phenoxyisopropanol, 4,4′-dichloro 2′-hydroxydiphenylether, 2-bromo-2-nitropropane-1,3-diol, glutaraldehyde, 2,4-dichlorobenzylalcohol, 1,3,5-tris-(2-hydroxyethyl)-1,3,5-hexahydrotriazine, formic acid and salts thereof, benzoic acid and salts thereof, sorbic acid and salts thereof, lactic acid and salts thereof, isothiazolinones selected from the group consisting of 1,2-benzisothiazol-3(2H)-one (BIT), 2-methyl-2H-isothiazol-3-one (MIT), 2-octyl-2H-isothiazol-3-one (OIT), 5-chloro-2-methyl-2H-isothiazol-3-one (CMIT), and 2-butyl-benzo[d]isothiazol-3-one (BBIT); 3-iodo-2-propynylbutylcarbamate (IPBC), benzyl alcohol, pyridine-2-thiol 1-oxide and salts thereof; 2,2-dibromo-2-cyanoacetamide (DBNPA), N-(3-aminopropyl)N-dodecylpropane-1,3-diamine (Diamine), tetrakis(hydroxymethyl)phosphonium sulphate(2:1) (THPS), 2,2-dithiobis[N-methylbenzamide](DTBMA), 2-bromo-2-(bromomethyl)pentanedinitril (DBDCB), biphenyl-2-ol (synonyms 2-phenylphenol, o-phenylphenol) and salts thereof; and mixtures thereof; and
(b) at least one carboxamide compound of the formula (I) or a mixture of different carboxamide compounds of the formula (I)

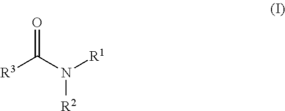

where
R¹, R² and R³, independently of each other, are selected from the group consisting of hydrogen, C₁-C₁₈-alkyl, C₁-C₁-haloalkyl, C₂-C₁-alkenyl, C₂-C₁₈-haloalkenyl, where the four aforementioned aliphatic groups may carry one or more substituents R⁵; C₃-C₆-cycloalkyl may carry one or more substituents R⁴; phenyl and a 3-, 4-, 5-, 6-, 7-, 8-, 9- or 10-membered or saturated, partially unsaturated or maximally unsaturated monocyclic or bicyclic heterocyclic ring containing 1, 2, 3 or 4 heteroatoms or heteroatom groups selected from O, N, S, S(O) or S(O)₂ as ring members, where phenyl and the heterocyclic ring may carry one or more substituents R⁴;
   with the proviso that at least one of or R¹, R² and R³ is not hydrogen;
or
R¹ and R², together with the nitrogen atom to which they are bound, form a 5-, 6-, or 7-membered saturated, partially unsaturated or maximally unsaturated heterocyclic ring which may contain a further heteroatom or heteroatom group selected from O, N, S, S(O) or S(O)₂ as ring member, where the heterocyclic ring may carry one or more substituents R⁴; and
R³ is as defined above;
or
R¹ and R³, together with the atoms to which they are bound, form a 5-, 6-, or 7-membered saturated, partially unsaturated or maximally unsaturated heterocyclic ring which may contain a further heteroatom or heteroatom group selected from O, N, S, S(O) or S(O)₂ as ring member, where the heterocyclic ring may carry one or more substituents R⁴; and
R² is as defined above;
each R⁴ is independently selected from the group consisting of halogen, CN, NO₂, OH, SH, NH₂, C(O)OH, C(O)O⁻M⁺, where M⁺ is a cation equivalent; C(O)NH₂, oxo and C₁-C₄-alkyl; and
each R⁵ is independently selected from the group consisting of CN, NO₂, SH, NH₂, OH, C(O)OH, C(O)O⁻M⁺, where M⁺ is a cation equivalent; and C(O)NH₂.

E.1. A composition comprising
(a) at least one antimicrobial agent selected from the group consisting of 2-phenoxyethanol, phenoxyisopropanol, 4,4′-dichloro 2′-hydroxydiphenylether, 2-bromo-2-nitropropane-1,3-diol, glutaraldehyde, 2,4-dichlorobenzylalcohol, 1,3,5-tris-(2-hydroxyethyl)-1,3,5-hexahydrotriazine, formic acid and salts thereof, benzoic acid and salts thereof, sorbic acid and salts thereof, lactic acid and salts thereof, isothiazolinones selected from the group consisting of 1,2-benzisothiazol-3(2H)-one (BIT), 2-methyl-2H-isothiazol-3-one (MIT), 2-octyl-2H-isothiazol-3-one (OIT), 5-chloro-2-methyl-2H-isothiazol-3-one (CMIT), and 2-butyl-benzo[d]isothiazol-3-one (BBIT); 3-iodo-2-propynylbutylcarbamate (IPBC), benzyl alcohol, pyridine-2-thiol 1-oxide and salts thereof; 2,2-dibromo-2-cyanoacetamide (DBNPA), N-(3-aminopropyl)-N-dodecylpropane-1,3-diamine (Diamine), tetrakis(hydroxymethyl)phosphonium sulphate(2:1) (THPS), 2,2-dithiobis[N-methylbenzamide](DTBMA), 2-bromo-2-(bromomethyl)pentanedinitril (DBDCB), biphenyl-2-ol (synonyms 2-phenylphenol, o-phenylphenol) and salts thereof; and mixtures thereof; and
(b) at least one carboxamide compound of the formula (I) or a mixture of different carboxamide compounds of the formula (I)

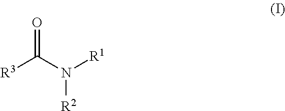

where
R¹ is hydrogen or C₁-C₈-alkyl;
R² is C₆-C₁₈-alkyl or C₆-C₁₈-alkenyl; and
R³ is C₂-C₆-alkenyl which carries a group —C(O)OH or C(O)O⁻M⁺, where M⁺ is a cation equivalent;
or
R¹ and R², independently of each other, are C₁-C₈-alkyl; and
R³ is C₁-C₁₃-alkyl or C₄-C₁₂-alkenyl;
where R¹, R² and R³ have in sum from 6 to 18 carbon atoms;
or
R¹ and R², together with the nitrogen atom to which they are bound, form a 5-, 6-, or 7-membered saturated, partially unsaturated or maximally unsaturated heterocyclic ring which may contain a further heteroatom or heteroatom group selected from O, N, S, S(O) or S(O)₂ as ring member, where the heterocyclic ring may carry one or more substituents R⁴;
R³ is C₁-C₁₃-alkyl; and
each R⁴ is independently selected from the group consisting of halogen, CN, NO₂, OH, SH, NH₂, C(O)OH, C(O)O⁻M⁺, where M⁺ is a cation equivalent; C(O)NH₂, oxo and C₁-C₄-alkyl;
or
R¹ and R³, together with the atoms to which they are bound, form a 5-, 6-, or 7-membered saturated, heterocyclic ring which may contain a further heteroatom or heteroatom group selected from O, N, S, S(O) or S(O)₂ as ring member, where the heterocyclic ring may carry one or more substituents R⁴;
R² is hydrogen or C₁-C₅-alkyl; and
each R⁴ is independently selected from the group consisting of halogen, CN, NO₂, OH, SH, NH₂, C(O)OH, C(O)O⁻M⁺, where M⁺ is a cation equivalent; C(O)NH₂, oxo and C₁-C₄-alkyl;
where components (a) and (b) are present in an overall weight ratio of from 500:1 to 1:1000;
with the proviso that the composition does not contain poly(hexamethylene biguanidine) and salts thereof; and with the proviso that in case the composition is non-aqueous, the composition does not contain any alkali metal hydroxide.

E.2. The composition according to embodiment E.0 or E.1,
where the carboxamide compound of the formula (I) is not N-methylpyrrolidione; where the composition does not contain an alkyl lactate if the antimicrobial agent is benzyl alcohol and simultaneously in the carboxamide compound of the formula (I) R¹ and R² are C₁-C₄-alkyl and R³ is C₅-C₁₃-alkyl;
where the antimicrobial agent is not formic acid or benzoic acid or lactic acid or a salt thereof if in the carboxamide compound of the formula (I) R¹ and R² are C₁-C₈-alkyl; and R³ is C₁-C₁₃-alkyl;
where the composition does not contain any parabene if the antimicrobial agent is 2-phenoxyethanol and simultaneously in the carboxamide compound of the formula (I) R¹ and R² methyl and R³ is C₃-C₁₃-alkyl; and
where the composition does not contain simultaneously benzyl alcohol, N,N-dimethyloctanamide, N,N-dimethyldecanamide, castor oil ethoxylate, EO/PO copolymer and an ethoxylated phosphate ester.

E.3. The composition according to any of embodiment E.0 to E.2, where the antimicrobial agent is selected from the group consisting of 2-phenoxyethanol, phenoxyisopropanol, 4,4′-dichloro 2′-hydroxydiphenylether, 2-bromo-2-nitropropane-1,3-diol and isothiazolinones selected from the group consisting of 1,2-benzisothiazol-3(2H)-one (BIT), 2-methyl-2H-isothiazol-3-one (MIT), 2-octyl-2H-isothiazol-3-one (OIT), 5-chloro-2-methyl-2H-isothiazol-3-one (CMIT) and 2-butyl-benzo[d]isothiazol-3-one (BBIT).

E.4. The composition according to embodiment E.3, where the antimicrobial agent is selected from the group consisting of 2-phenoxyethanol, phenoxyisopropanol, 4,4′-dichloro 2′-hydroxydiphenylether, 2-bromo-2-nitropropane-1,3-diol and 1,2-benzisothiazol-3(2H)one (BIT).

E.5. The composition according to embodiment E.4, where the antimicrobial agent is selected from the group consisting of 2-phenoxyethanol, 4,4′-dichloro 2′-hydroxydiphenylether and 1,2-benzisothiazol-3(2H)one (BIT).

E.6. The composition according to embodiment E.5, where the antimicrobial agent is 2-phenoxyethanol.

E.7. The composition according to embodiment E.4, where the antimicrobial agent is phenoxyisopropanol.

E.8. The composition according to any of the preceding embodiments, where
R¹ is hydrogen or C₁-C₈-alkyl;
R² is C₆-C₁₈-alkyl or C₆-C₁₈-alkenyl; and
R³ is C₂-C₆-alkenyl which carries a group —C(O)OH or C(O)O⁻M⁺, where M⁺ is a cation equivalent;
or
R¹ and R², independently of each other, are C₁-C₈-alkyl; and
R³ is C₁-C₁₃-alkyl;
where R¹, R² and R³ have in sum from 6 to 18 carbon atoms;
or
R¹ and R², independently of each other are C₁-C₈-alkyl; and
R³ is C₄-C₁₂-alkenyl;
where R¹, R² and R³ have in sum from 6 to 18 carbon atoms;
or
R¹ and R², together with the nitrogen atom to which they are bound, form a 5-, 6-, or 7-membered saturated, partially unsaturated or maximally unsaturated heterocyclic ring which may contain a further heteroatom or heteroatom group selected from O, N, S, S(O) or S(O)₂ as ring member, where the heterocyclic ring may carry one or more substituents R⁴;
R³ is C₁-C₁₃-alkyl; and
each R⁴ is independently selected from the group consisting of halogen, CN, NO₂, OH, SH, NH₂, C(O)OH, C(O)O⁻M⁺, where M⁺ is a cation equivalent; C(O)NH₂, oxo and C₁-C₄-alkyl;
or
R¹ and R³, together with the atoms to which they are bound, form a 5-, 6-, or 7-membered saturated, heterocyclic ring which may contain a further heteroatom or heteroatom group selected from O, N, S, S(O) or S(O_{b} as ring member, where the heterocyclic ring may carry one or more substituents R⁴;
R² is hydrogen or C₁-C₅-alkyl; and
each R⁴ is independently selected from the group consisting of halogen, CN, NO₂, OH, SH, NH₂, C(O)OH, C(O)O⁻M⁺, where M⁺ is a cation equivalent; C(O)NH₂, oxo and C₁-C₄-alkyl.

E.9. The composition according to embodiment E.8, where
R¹ is hydrogen or C₁-C₈-alkyl;
R² is C₆-C₁₈-alkyl or C₆-C₁₈-alkenyl; and
R³ is C₂-C₆-alkenyl which carries a group —C(O)OH or C(O)O⁻M⁺, where M⁺ is a cation equivalent;
or
R¹ and R², independently of each other, are C₁-C₈-alkyl; and
R³ is C₁-C₁₃-alkyl;
where R¹, R² and R³ have in sum from 6 to 18 carbon atoms;
or
R¹ and R², independently of each other are C₁-C₈-alkyl; and
R³ is C₄-C₁₂-alkenyl;
where R¹, R² and R³ have in sum from 6 to 18 carbon atoms;
or
R¹ and R², together with the nitrogen atom to which they are bound, form a 5-, 6-, or 7-membered saturated, partially unsaturated or maximally unsaturated heterocyclic ring which may contain a further heteroatom or heteroatom group selected from O, N, S, S(O) or S(O)₂ as ring member, where the heterocyclic ring may carry one or more substituents R⁴;
R³ is C₁-C₁₃-alkyl; and
each R⁴ is independently selected from the group consisting of halogen, CN, NO₂, OH, SH, NH₂, C(O)OH, C(O)O⁻M⁺, where M⁺ is a cation equivalent; C(O)NH₂, oxo and C₁-C₄-alkyl;
or
R¹ and R³, together with the atoms to which they are bound, form a 5-, 6-, or 7-membered saturated, heterocyclic ring which may contain a further heteroatom or heteroatom group selected from O, N, S, S(O) or S(O)₂ as ring member, where the heterocyclic ring may carry one or more substituents R⁴;
R² is hydrogen or C₁-C₅-alkyl; and
each R⁴ is independently selected from the group consisting of halogen, CN, NO₂, OH, SH, NH₂, C(O)OH, C(O)O⁻M⁺, where M⁺ is a cation equivalent; C(O)NH₂, oxo and C₁-C₄-alkyl.

E.10. The composition according to embodiment E.9, where
R¹ is hydrogen or C₁-C₈-alkyl;
R² is C₆-C₁₈-alkyl or C₆-C₁₈-alkenyl; and
R³ is C₂-C₆-alkenyl which carries a group —C(O)OH or C(O)O⁻M⁺, where M⁺ is a cation equivalent;
or
R¹ and R², independently of each other, are C₁-C₈-alkyl; and
R³ is C₁-C₁₃-alkyl or C₄-C₁₂-alkenyl;
where R¹, R² and R³ have in sum from 6 to 18 carbon atoms;
or
R¹ and R², together with the nitrogen atom to which they are bound, form a 5-, 6-, or 7-membered saturated, partially unsaturated or maximally unsaturated heterocyclic ring which may contain a further heteroatom or heteroatom group selected from O, N, S, S(O) or S(O)₂ as ring member, where the heterocyclic ring may carry one or more substituents R⁴;
R³ is C₁-C₁₃-alkyl; and
each R⁴ is independently selected from the group consisting of halogen, CN, NO₂, OH, SH, NH₂, C(O)OH, C(O)O⁻M⁺, where M⁺ is a cation equivalent; C(O)NH₂, oxo and C₁-C₄-alkyl.

E.11. The composition according to any of the preceding embodiments, where
R¹ is hydrogen or C₁-C₈-alkyl; R² is C₆-C₁₈-alkyl or C₆-C₁₈-alkenyl; and R³ is —CH═CH—COOH or —CH═CH—C(O)O⁻M⁺; or
R¹ and R² are C₁-C₄-alkyl; and R³ is C₅-C₁₃-alkyl; or
R¹ and R² are C₄-C₈-alkyl; and R³ is C₁-C₃-alkyl; or
R¹ and R² are C₁-C₄-alkyl; and R³ is C₇-C₁₁-alkenyl; or
R¹ and R², together with the nitrogen atom to which they are bound, form a 6-membered saturated heterocyclic ring which contains a further heteroatom selected from 0 and N as ring member; and R³ is C₁-C₁₃-alkyl.

E.12. The composition according to embodiment E.11, where in case that R¹ and R², together with the nitrogen atom to which they are bound, form a 6-membered saturated heterocyclic ring which contains a further heteroatom selected from 0 and N as ring member, R³ is C₅-C₁₃-alkyl.

E.13. The composition according to any of embodiments E.11 or E.12, where
R¹ is hydrogen; R² is C₆-C₁₂-alkyl; and R³ is —CH═CH—COOH or —CH═CH—C(O)O⁻M⁺, where M⁺ is an alkali metal cation or an ammonium cation of the formula [NR^{a}R^{b}R^{c}R^{d}]⁺, where R^{a}, R^{b}, R^{c} and R^{d}, independently of each other, are selected from the group consisting of hydrogen, C₁-C₄-alkyl and C₁-C₄-alkoxy; or
R¹ and R² are C₁-C₂-alkyl; and R³ is C₇-C₁₁-alkyl; or
R¹ and R² are C₁-C₂-alkyl; and R³ is C₇-C₁₁-alkenyl; or
R¹ and R² form together a bridging group —CH₂—CH₂—O—CH₂—CH₂—; and R³ is C₅-C₁₃-alkyl.

E.14. The composition according to embodiment E.13, where
R¹ is hydrogen; R² is C₆-C₁₂-alkyl; and R³ is —CH═CH—COOH or —CH═CH—C(O)O⁻M⁺, where M⁺ is an alkali metal cation or an ammonium cation of the formula [NR^{a}R^{b}R^{c}R^{d}]⁺, where R^{a}, R^{b}, R^{c} and R^{d}, independently of each other, are selected from the group consisting of hydrogen, C₁-C₄-alkyl and C₁-C₄-alkoxy; and is preferably —CH═CH—COOH; or
R¹ and R² form together a bridging group —CH₂—CH₂—O—CH₂—CH₂—; and R³ is C₅-C₁₃-alkyl.

E.15. The composition according to any of embodiments E.13 or E.14, where in case that R¹ and R² form together a bridging group —CH₂—CH₂—O—CH₂—CH₂—, R³ is C₇-C₁₁-alkyl.

E.16. The composition according to any of the preceding embodiments, where the carboxamide compound of the formula (I) is selected from the group consisting of:
n-decanoyl-N,N-dimethylamide (i.e. a compound of the formula (I), wherein R¹ and R² are methyl and R³ is n-nonyl);
n-octanoyl-N,N-dimethylamide (i.e. a compound of the formula (I), wherein R¹ and R² are methyl and R³ is n-heptyl);
a mixture of n-decanoyl-N,N-dimethylamide and n-octanoyl-N,N-dimethylamide;
n-decanoylmorpholine (i.e. a compound of the formula (I), wherein R¹ and R² form together a bridging group —CH₂—CH₂—O—CH₂—CH₂—and R³ is n-nonyl);
n-octanoylmorpholine (i.e. a compound of the formula (I), wherein R¹ and R² form together a bridging group —CH₂—CH₂—O—CH₂—CH₂—and R³ is n-heptyl);
a mixture of n-decanoylmorpholine and n-octanoylmorpholine; and
N,N-dimethyl 9-decenamide (i.e. a compound of the formula (I), wherein R¹ and R² are methyl and R³ is non-8-en-1-yl [—(CH₂)₇—CH═CH₂]).

E.17. The composition according to any of embodiment E.1 to E.7, where
R¹ and R³, together with the atoms to which they are bound, form a 5-, 6-, or 7-membered saturated heterocyclic ring which may contain a further heteroatom or heteroatom group selected from O, N, S, S(O) or S(O)₂ as ring member, where the heterocyclic ring may carry one or more substituents R⁴; and
R² is selected from the group consisting of hydrogen and C₁-C₄-alkyl.

E.18. The composition according to embodiment E.17, where the composition does not comprise N-methylpyrrolidone.

E.19. The composition according to any of embodiments E.17 or E.18, where
R¹ and R³ together form a C₃-C₅-alkylene bridging group; and
R² is hydrogen or C₁-C₄-alkyl.

E.20. The composition according to embodiment E.19, where R¹ and R³ form together a bridging group —(CH₂)—; and R² is hydrogen or C₁-C₄-alkyl.

E.21. The composition according to embodiment E.20, where R² is hydrogen.

E.22. The composition according to any of the preceding embodiments, where the antimicrobial agent and the carboxamide compound of the formula (I) are present in a weight ratio of from 200:1 to 1:500.

E.23. The composition according to embodiment E.22, where the antimicrobial agent and the carboxamide compound of the formula (I) are present in a weight ratio of from 100:1 to 1:200.

E.24. The composition according to embodiment E.23, where the antimicrobial agent and the carboxamide compound of the formula (I) are present in a weight ratio of from 15:1 to 1:15.

E.25. The composition according to embodiment E.24, where the antimicrobial agent and the carboxamide compound of the formula (I) are present in a weight ratio of from 10:1 to 1:10.

E.26. The composition according to any of the preceding embodiments, further comprising at least one organic solvent [of course different from components (a) and (b)].

E.27. The composition according to embodiment E.26, where the organic solvent is selected from the group consisting of C₁-C₈-alkanols, C₂-C₈-alkanediols, C₁-C₈-alkylmonoethers of C₂-C₈-alkanediols, polyetherpolyols, C₁-C₈-alkylmonoethers of polyetherpolyols, 5-, 6- or 7-membered lactones which may be substituted by one or more C₁-C₁₂-alkyl groups; 5-, 6- or 7-membered cyclic carbonates which may be substituted by one or more C₁-C₁₂-alkyl groups; aliphatic esters, carboxamides different from component (b), aliphatic or alicyclic amine-N-oxides and mixtures of the afore-mentioned solvents.

E.28. The composition according to embodiment E.27, where the solvent is selected from C₁-C₈-alkylmonoethers of C₂-C₈-alkanediols and 5-, 6- or 7-membered lactones which may carry one or more C₁-C₁₂-alkyl groups.

E.29. The composition according to embodiment E.28, where the solvent is selected from 5-, 6- or 7-membered lactones which may carry one or more C₁-C₁₂-alkyl groups,

E.30. The composition according to embodiment E.29, where the solvent is selected from the group consisting of γ-butyrolactone, γ-valerolactone, γ-octalactone, γ-nonalactone, δ-valerolactone, δ-decanolactone, δ-dodecanolactone, ε-caprolactone and mixtures thereof.

E.31. The composition according to embodiment E.30, where the solvent is selected from the group consisting of γ-butyrolactone, γ-valerolactone, γ-octalactone, γ-nonalactone, ε-caprolactone and mixtures thereof.

E.32. The composition according to embodiment E.28, where the solvent is selected from C₁-C₆-alkylmonoethers of C₂-C₄-alkanediols; preferably from C₁-C₄-alkylmonoethers of C₂-C₃-alkanediols.

E.33. The composition according to embodiment E.32, where the solvent is selected from the group consisting of ethyleneglycol mono-n-propyl ether, ethyleneglycol mono-n-butyl ether, propyleneglycol mono-n-propyl ether, propyleneglycol mono-n-butyl ether and mixtures thereof.

E.34. The composition according to embodiment E.27, where the solvent is a C₂-C₈-alkanediol.

E.35. The composition according to embodiment E.34, where the solvent is a C₂-C₃-alkanediol.

E.36. The composition according to embodiment E.35, where the solvent is propylene glycol.

E.37. The composition according to embodiment E.27, where the solvent a C₁-C₄-alkanol.

E.38. The composition according to embodiment E.37, where the solvent is a C₂-C₃-alkanol; i.e. is selected from the group consisting of ethanol, n-propanol, isopropanol and mixtures thereof.

E.39. The composition according to any of the preceding embodiments, where the antimicrobial agent is selected from the group consisting of 2-phenoxyethanol, 4,4′-dichloro 2′-hydroxydiphenylether and 1,2-benzisothiazol-3(2H)one (BIT); in the carboxamide compound of the formula (I)
R¹ is hydrogen; R² is C₆-C₁₂-alkyl; and R³ is —CH═CH—COOH or —CH═CH—C(O)O⁻M⁺, where M⁺ is an alkali metal cation or an ammonium cation of the formula [NR^{a}R^{b}R^{c}R^{d}]⁺, where R^{a}, R^{b}, R^{c} and R^{d}, independently of each other, are selected from the group consisting of hydrogen, C₁-C₄-alkyl and C₁-C₄-alkoxy; or
R¹ and R² are C₁-C₂-alkyl; and R³ is C₇-C₁₁-alkyl; or
R¹ and R² are C₁-C₂-alkyl; and R³ is C₇-C₁₁-alkenyl; or
R¹ and R² form together a bridging group —CH₂—CH₂—O—CH₂—CH₂—; and R³ is C₅-C₁₃-alkyl, in particular C₇-C₁₁-alkyl
and the antimicrobial agent and the carboxamide compound of the formula (I) are present in an overall weight ratio of from 15:1 to 1:15;
where in case that the antimicrobial agent is 2-phenoxyethanol and in compounds (I) R¹ and R² are C₁-C₂-alkyl and R³ is C₇-C₁₁-alkyl, 2-phenoxyethanol and compounds (I) are present in an overall weight ratio of from 15:1 to 1:1, preferably from 10:1 to 1:1.

E.40. The composition according to embodiment E.39, where the antimicrobial agent and the carboxamide compound of the formula (I) are present in an overall weight ratio of from 15:1 to 1:1, preferably from 10:1 to 1:1, if the antimicrobial agent is 2-phenoxyethanol; and the antimicrobial agent and the carboxamide compound of the formula (I) are present in an overall weight ratio of from 1:1 to 1:15, preferably from 1:1 to 1:10, if the antimicrobial agent is 4,4′-dichloro 2′-hydroxydiphenylether and 1,2-benzisothiazol-3(2H)one (BIT).

E.41. The composition according to any of the preceding embodiments, which is selected from the group consisting of biocide concentrates, homecare compositions, compositions for cleaning or disinfecting on an industrial scale, personal care compositions, process water, water in fish or shrimp ponds, water in drinking troughs, metal working fluids; water based raw materials, polymer solutions, polymer dispersions, polymer emulsions, inorganic slurries, organic slurries, surfactant compositions; compositions for treating animal hide; compositions for treating leather; compositions for treating textiles during the manufacturing process thereof; compositions for treating lumber; compositions for treating paper or the precursor material during papermaking processes; crop protection compositions; pharmaceutical compositions; paints, glues, adhesives, sealants, dyes, pigments and dispersions thereof, inks, and wet wipes.

E.42. The composition according to embodiment E.41, which is a biocide concentrate, comprising
(a) 0.01 to 99.9% by weight, relative to the total weight of the composition, of at least one antimicrobial agent as defined in any of embodiments E.1 to E.7;
(b) 0.1 to 99.99% by weight, relative to the total weight of the composition, of at least one carboxamide compound of the formula (I) or a mixture of different carboxamide compounds of the formula (I) as defined in any of embodiments E.0 or E.1 and E.8 to E.21;
(c) 0 to 20% by weight, relative to the total weight of the composition, of at least one further additive;
(d) 0 to 99.4% by weight, relative to the total weight of the composition, of one or more organic solvents; and
(e) 0 to 99.4% by weight, relative to the total weight of the composition, of water.

E.43. The composition according to embodiment E.42, where the one or more organic solvents are as defined in any of embodiments E.26 to E.38.

E.44. The composition according to any of embodiment E.41, which is a homecare composition.

E.45. The composition according to embodiment E.44, which is selected from the group consisting of dishwashing compositions, laundry compositions, surface cleaning compositions, non-cosmetic deodorants, disinfectants, surface protecting and/or polishing compositions, and rug shampoos.

E.46. The composition according to embodiment E.45, which is selected from the group consisting of dishwashing compositions, laundry compositions, surface cleaning compositions, and rug shampoos.

E.47. The composition according to embodiment E.46, comprising
(a) 0.001 to 7% by weight, relative to the total weight of the composition, of at least one antimicrobial agent as defined in any of embodiments E.1 to E.7;
(b) 0.001 to 7% by weight, relative to the total weight of the composition, of a carboxamide compound of the formula (I) or a mixture of different carboxamide compounds of the formula (I) as defined in any of embodiments E.0 or E.1 and E.8 to E.21;
(c) 0.1 to 40% by weight, relative to the total weight of the composition, of at least one surfactant [different from component (b)];
(d) 0 to 15% by weight, relative to the total weight of the composition, of at least one organic solvent [different from component (b) (and of course also from said antimicrobial agent)];
(e) 0 to 2% by weight, relative to the total weight of the composition, of at least one enzyme;
(f) 0 to 5% by weight, relative to the total weight of the composition, of at least one sequestrant;
(g) 0 to 8% by weight, relative to the total weight of the composition, of at least one defoamer and/or foam stabilizer;
(h) 0 to 50% by weight, relative to the total weight of the composition, of at least one further additive; and
(i) 10 to 94.998% by weight, relative to the total weight of the composition, of water;
where components (a) to (i) add to 100% by weight.

E.48. The composition according to any of embodiments E.44 to E.47, which is a refill concentrate, comprising
(a) 0.01 to 10% by weight, relative to the total weight of the composition, of at least one antimicrobial agent as defined in any of embodiments E.1 to E.7;
(b) 0.01 to 10% by weight, relative to the total weight of the composition, of a carboxamide compound of the formula (I) or a mixture of different carboxamide compounds of the formula (I) as defined in any of embodiments E.0 or E.1 and E.8 to E.21;
(c) 1 to 60% by weight, relative to the total weight of the composition, of at least one surfactant [different from component (b)];
(d) 0 to 30% by weight, relative to the total weight of the composition, of at least one organic solvent [different from component (b) (and of course also from said antimicrobial agent)];
(e) 0 to 10% by weight, relative to the total weight of the composition, of at least one enzyme;
(f) 0 to 10% by weight, relative to the total weight of the composition, of at least one sequestrant;
(g) 0 to 10% by weight, relative to the total weight of the composition, of at least one defoamer and/or foam stabilizer;
(h) 0 to 50% by weight, relative to the total weight of the composition, of at least one further additive; and
(i) 0 to 20% by weight, relative to the total weight of the composition, of water;
where components (a) to (i) add to 100% by weight.

E.49. The composition according to any of embodiments E.42 to E.48, where the one or more organic solvents are as defined in any of embodiments E.26 to E.38.

E.50. The composition according to any of the preceding embodiments, where the composition has a pH of from 2 to 11.

E.51. The composition according to embodiment E.50, where the composition has a pH of from 4 to 10.

E.52. The composition according to embodiment E.51, where the composition has a pH of from 4 to 9.

E.53. Kit of parts comprising at least two parts, where the first part comprises at least one antimicrobial agent as defined in any of embodiments E.1 to E.7; the second part comprises at least one carboxamide compound of the formula (I) as defined in any of embodiments E.0 or E.1 and E.8 to E.21 and optionally at least one organic solvent [different from the carboxamide compounds of the formula (I) (and of course also from said antimicrobial agent)], preferably as defined in any of embodiments E.26 to E.38; and an optional third part comprises at least one organic solvent [different from the carboxamide compounds of the formula (I) (and of course also from said antimicrobial agent)], preferably as defined in any of embodiments E.26 to E.38;
where the first part does not comprise any carboxamide compound of the formula (I) as defined in any of embodiments E.0 or E.1 and E.8 to E.21;
where the second part does not comprise any antimicrobial agent as defined in any of embodiments E.1 to E.7;
where the optional third part does not comprise any antimicrobial agent as defined in any of embodiments E.1 to E.7 nor any carboxamide compound of the formula (I) as defined in any of embodiments E.0 or E.1 and E.8 to E.21; and where the first and second parts contain the at least one antimicrobial agent as defined in any of embodiments E.1 to E.7 and the at least one carboxamide compound of the formula (I) as defined in any of embodiments E.0 or E.1 and E.8 to E.21 in such amounts that when the first and the second part are mixed the resulting overall weight ratio is as defined in embodiments E.1 or E.22 to E.25.

E.54. The kit of parts according to embodiment E.53, which is a kit of two parts, where the first part comprises at least one antimicrobial agent as defined in any of embodiments E.1 to E.7; and the second part comprises at least one carboxamide compound of the formula (I) as defined in any of embodiments E.0 or E.1 and E.8 to E.21 and at least one organic solvent [different from the carboxamide compounds of the formula (I) (and of course also from said antimicrobial agent)], preferably as defined in any of embodiments E.26 to E.38.

E.55. The kit of parts according to embodiment E.53, which is a kit of three parts, where the first part comprises at least one antimicrobial agent as defined in any of embodiments E.1 to E.7; the second part comprises at least one carboxamide compound of the formula (I) as defined in any of embodiments E.0 or E.1 and E.8 to E.21; and the third part comprises at least one organic solvent [different from the carboxamide compounds of the formula (I) (and of course also from said antimicrobial agent)], preferably as defined in any of embodiments E.26 to E.38.

E.56. The use of a carboxamide compound of the formula (I) as defined in any of embodiments E.0 or E.1 and E.8 to E.21 for enhancing the antimicrobial activity of the antimicrobial agent as defined in any of embodiments E.1 to E.7.

E.57. The use according to embodiment E.56, for enhancing the preserving activity of the antimicrobial agent as defined in any of embodiments E.1 to E.7.

E.58. The use according to any of embodiments E.56 or E.57, of a carboxamide compound of the formula (I) as defined in any of embodiments E.8 to E.16.

E.59. The use according to any of embodiments E.56 to E.58, of a carboxamide compound of the formula (I) as defined in any of embodiments E.1 and E.8 to E.21 for enhancing the antimicrobial, in particular the preserving, activity of 2-phenoxyethanol.

E.60. The use according to any of embodiments E.56 to E.58, of a carboxamide compound of the formula (I) as defined in any of embodiments E.1 and E.8 to E.21 for enhancing the antimicrobial, in particular the preserving, activity of phenoxyisopropanol.

E.61. The use according to any of embodiments E.56 to E.60, for enhancing the antimicrobial, in particular the preserving, activity of the antimicrobial agent in an aqueous liquid composition as defined in any of embodiments E.41 to E.52.

E.62. The use according to any of embodiments E.56 to E.61, of a carboxamide compound of the formula (I) as defined in any of embodiments E.1 and E.8 to E.21 in combination with an organic solvent as defined in any of embodiments E.26 to E.38, for enhancing the antimicrobial, in particular the preserving, activity of the antimicrobial agent as defined in any of embodiments E.1 to E.7.

E.63. The use of the antimicrobial activity of the antimicrobial agent as defined in any of embodiments E.1 to E.7 in combination with the carboxamide compound of the formula (I) as defined in any of embodiments E.1 and E.8 to E.21 for combating microbes.

E.64. Mixture, consisting of
(a) at least one antimicrobial agent as defined in any of embodiments E.1 to E.7;
(b) at least one carboxamide compound of the formula (I) as defined in any of embodiments E.1 and E.8 to E.21; and
(c) optionally at least one organic solvent [different from component (b)], preferably as defined in any of embodiments E.26 to E.38.

E.65. The mixture according to embodiment E.64, consisting of
(a) 2-phenoxyethanol;
(b) at least one carboxamide compound of the formula (I) as defined in any of embodiments E.8 to E.16; and
(c) optionally at least one organic solvent [different from component (b)], preferably as defined in any of embodiments E.26 to E.38.

E.66. A method for enhancing the antimicrobial, in particular the preserving, activity of the antimicrobial agent as defined in any of embodiments E.1 to E.7, comprising using the antimicrobial agent (a) in combination with the compound of the formula (I) as defined in any of embodiments E.1 and E.8 to E.21.

E.67. A method for combating microbes, comprising applying at least one antimicrobial agent as defined in any of embodiments E.1 to E.7 in combination with at least one carboxamide compound of the formula (I) as defined in any of embodiments E.1 and E.8 to E.21 to a composition, surface, area or space in or on which microbes are to be combated.

Unless specified otherwise, the above and below remarks to suitable and preferred antimicrobial agent, carboxamides (I), weight ratios in which these are used and compositions in which these are used apply both to the compositions and mixtures of the inventions as well as to the uses and methods of the invention.

The composition of the invention does not contain poly(hexamethylene biguanidine) and salts thereof. Such compounds are for example used in the compositions of KR 10-2005-0077408.

In case the composition is non-aqueous, the composition does not contain any alkali metal hydroxide. “Non-aqueous” means in this context that the composition contains less than 5% by weight, preferably less than 2% by weight, in particular less than 1% by weight, relative to the total weight of the composition, of water.

In a particular embodiment, the carboxamide compound of the formula (I) is not N-methylpyrrolidione.

In a particular embodiment, the composition of the invention does not contain an alkyl lactate if the antimicrobial agent is benzyl alcohol and simultaneously in the carboxamide compound of the formula (I) R¹ and R² are C₁-C₄-alkyl and R³ is C₅-C₁₃-alkyl.

In a particular embodiment, the antimicrobial agent is not formic acid or benzoic acid or lactic acid or a salt thereof if in the carboxamide compound of the formula (I) R¹ and R² are C₁-C₈-alkyl; and R³ is C₁-C₁₃-alkyl.

In a particular embodiment, the composition does not contain any parabene if the antimicrobial agent is 2-phenoxyethanol and simultaneously in the carboxamide compound of the formula (I) R¹ and R² methyl and R³ is C₃-C₁₃-alkyl.

In a particular embodiment, the composition does not contain simultaneously benzyl alcohol, N,N-dimethyloctanamide, N,N-dimethyldecanamide, castor oil ethoxylate, EO/PO copolymer and an ethoxylated phosphate ester.

The antimicrobial agent is inter alia selected from formic acid and salts thereof, benzoic acid and salts thereof, sorbic acid and salts thereof, lactic acid and salts thereof. Suitable salts of these acids are alkali metal salts, such as the lithium, sodium or potassium salts; earth alkaline metal salts, such as the magnesium and calcium salts, and ammonium salts, such as the salts containing an ammonium cation of the formula [NR^{a}R^{b}R^{c}R^{d}]⁺, where R^{a}, R^{b}, R^{c} and R^{d}, independently of each other, are selected from the group consisting of hydrogen, C₁-C₄-alkyl and C₁-C₄-alkoxy. Preferably, alkali metal salts, and in particular the sodium or potassium salts are used.

The antimicrobial agent is preferably selected from the group consisting of 2-phenoxyethanol, phenoxyisopropanol, 4,4′-dichloro 2′-hydroxydiphenylether (diclosan), 2-bromo-2-nitropropane-1,3-diol (bronopol) and isothiazolinones selected from the group consisting of 1,2-benzisothiazol-3(2H)-one (BIT), 2-methyl-2H-isothiazol-3-one (MIT), 2-octyl-2H-isothiazol-3-one (OIT), 5-chloro-2-methyl-2H-isothiazol-3-one (CMIT) and 2-butyl-benzo[d]isothiazol-3-one (BBIT), and more preferably from 2-phenoxyethanol, phenoxyisopropanol, 4,4′-dichloro 2′-hydroxydiphenylether (diclosan), 2-bromo-2-nitropropane-1,3-diol (bronopol) and 1,2-benzisothiazol-3(2H)one (BIT). In particular, the antimicrobial agent is selected from the group consisting of 2-phenoxyethanol, 4,4′-dichloro 2′-hydroxydiphenylether (diclosan) and 1,2-benzisothiazol-3(2H)one (BIT). More particularly, the antimicrobial agent is 2-phenoxyethanol. In an alternative more particular embodiment, the antimicrobial agent is phenoxyisopropanol.

In compounds (I), M⁺ is a cation equivalent. Preferably, M⁺ is an alkali metal cation, such as Li⁺, Na⁺, K⁺ or Cs⁺, and earth alkaline metal cation equivalent, such as (Mg²⁺)_{1/2} or (Ca²⁺)_{1/2}, or an ammonium cation, in particular an ammonium cation of the formula [NR^{a}R^{b}R^{c}R^{d}]⁺, where R^{a}, R^{b}, R^{c} and R^{d}, independently of each other, are selected from the group consisting of hydrogen, C₁-C₄-alkyl and C₁-C₄-alkoxy. More preferably, M⁺ is an alkali metal cation or an ammonium cation of the formula [NR^{a}R^{b}R^{c}R^{d}]⁺, where R^{a}, R^{b}, R^{c} and R^{d} are as defined above.

In a preferred embodiment, in the carboxamide (I), R¹ is hydrogen or C₁-C₈-alkyl; R² is C₆-C₁₈-alkyl or C₆-C₁₈-alkenyl; and R³ is —CH═CH—COOH or —CH═CH—C(O)O⁻M⁺; where M⁺ is a cation equivalent, preferably an alkali metal cation, such as Li⁺, Na⁺, K⁺ or Cs⁺, and earth alkaline metal cation equivalent, such as (Mg²⁺)_{1/R} or (Ca²⁺)_{1/2}, or an ammonium cation, in particular an ammonium cation of the formula [NR^{a}R^{b}R^{c}R^{d}]⁺, where R^{a}, R^{b}, R^{c} and R^{d}, independently of each other, are selected from the group consisting of hydrogen, C₁-C₄-alkyl and C₁-C₄-alkoxy; and where more preferably, M⁺ is an alkali metal cation or an ammonium cation of the formula [NR^{a}R^{b}R^{c}R^{d}]⁺, where R^{a}, R^{b}, R^{c} and R^{d} are as defined above. The group —CH═CH—C(O)O⁻M⁺ is often formed automatically from —CH═CH—COOH if the pH of the composition is basic.

More preferably, R¹ is hydrogen or C₁-C₄-alkyl; R² is C₆-C₁₂-alkyl; and R³ is —CH═CH—COOH or —CH═CH—C(O)O⁻M⁺, where M⁺ is an alkali metal cation or an ammonium cation of the formula [NR^{a}R^{b}R^{c}R^{d}]⁺, where R^{a}, R^{b}, R^{c} and R^{d}, independently of each other, are selected from the group consisting of hydrogen, C₁-C₄-alkyl and C₁-C₄-alkoxy.

In particular, R¹ is hydrogen; R² is C₆-C₁₂-alkyl; and R³ is —CH═CH—COOH or —CH═CH—C(O)O⁻M⁺, where M⁺ is an alkali metal cation or an ammonium cation of the formula [NR^{a}R^{b}R^{c}R^{d}]⁺, where R^{a}, R^{b}, R^{c} and R^{d}, independently of each other, are selected from the group consisting of hydrogen, C₁-C₄-alkyl and C₁-C₄-alkoxy.

In an alternatively preferred embodiment, in the carboxamide (I), R¹ and R² are C₁-C₄-alkyl; and R³ is C₅-C₁₃-alkyl. In particular, R¹ and R² are C₁-C₂-alkyl; and R³ is C₇-C₁₁-alkyl.

In another alternatively preferred embodiment, in the carboxamide (I), R¹ and R² are C₄-C₈-alkyl; and R³ is C₁-C₃-alkyl.

In another alternatively preferred embodiment, in the carboxamide (I), R¹ and R² are C₁-C₄-alkyl; and R³ is C₇-C₁₁-alkenyl. More preferably, R¹ and R² are C₁-C₂-alkyl; and R³ is C₇-C₁₁-alkenyl.

In yet another alternatively preferred embodiment, in the carboxamide (I), R¹ and R², together with the nitrogen atom to which they are bound, form a 6-membered saturated heterocyclic ring which contains a further heteroatom selected from O and N as ring member; and R³ is C₁-C₁₃-alkyl, in particular C₅-C₁₃-alkyl. Examples for such compounds (I) are piperidine rings carrying in 1-position (i.e. on the nitrogen ring atom) a C₁-C₁₃-alkyl substituent, preferably a C₅-C₁₃-alkyl substituent; piperazinyl rings carrying in 1-position (i.e. on one of the nitrogen ring atoms) a C₁-C₁₃-alkyl substituent, preferably a C₅-C₁₃-alkyl substituent; and morpholinyl rings carrying in 4-position (i.e. on the nitrogen ring atom) a C₁-C₁₃-alkyl substituent, preferably a C₅-C₁₃-alkyl substituent.

In particular, R¹ and R² form together a bridging group —CH₂—CH₂—O—CH₂—CH₂—; and R³ is C₅-C₁₃-alkyl, in particular C₇-C₁₁-alkyl. This results in compound (I) being a morpholinyl ring carrying in 4-position (i.e. on the nitrogen ring atom) a C₅-C₁₃-alkyl substituent, preferably a C₇-C₁₁-alkyl substituent.

In yet another alternatively preferred embodiment, in the carboxamide (I), R¹ and R³, together with the atoms to which they are bound, form a 5-, 6-, or 7-membered saturated heterocyclic ring which may contain a further heteroatom or heteroatom group selected from O, N, S, S(O) or S(O)₂ as ring member, where the heterocyclic ring may carry one or more substituents R⁴; and R² is selected from the group consisting of hydrogen and C₁-C₄-alkyl. Examples for such compounds are pyrrolidin-2-ones, imidazolin-2-ones, piperidin-2-ones, piperazin-2-ones, morpholin-3-one and ε-caprolactams which are unsubstituted or carry on the nitrogen ring atom adjacent to the carbonyl group a C₁-C₄-alkyl substituent Preferably, the ring formed together by R¹ and R³ together with the atoms to which they are bound does not contain a further heteroatom or heteroatom group; the mandatory nitrogen ring atom thus being the only non-carbon ring member. In this case, R¹ and R³ together form a (linear) C₃-C₅-alkylene bridging group. Thus, in a more preferred embodiment, R¹ and R³ together form a (linear) C₃-C₅-alkylene bridging group, and R² is hydrogen or C₁-C₄-alkyl. In particular, R¹ and R³ form together a bridging group —(CH₂)₃—; and R² is hydrogen or C₁-C₄-alkyl; in particular hydrogen; compound (I) thus being pyrrolidin-2-one which is unsubstituted or carries on the nitrogen ring atom a C₁-C₄-alkyl substituent, and which is in particular unsubstituted.

In particular, the carboxamide compound of the formula (I) is selected from the group consisting of:
n-decanoyl-N,N-dimethylamide (i.e. a compound of the formula (I), wherein R¹ and R² are methyl and R³ is n-nonyl);
n-octanoyl-N,N-dimethylamide (i.e. a compound of the formula (I), wherein R¹ and R² are methyl and R³ is n-heptyl);
a mixture of n-decanoyl-N,N-dimethylamide and n-octanoyl-N,N-dimethylamide;
n-decanoylmorpholine (i.e. a compound of the formula (I), wherein R¹ and R² form together a bridging group —CH₂—CH₂—O—CH₂—CH₂—and R³ is n-nonyl);
n-octanoylmorpholine (i.e. a compound of the formula (I), wherein R¹ and R² form together a bridging group —CH₂—CH₂—O—CH₂—CH₂—and R³ is n-heptyl);
a mixture of n-decanoylmorpholine and n-octanoylmorpholine; and
N,N-dimethyl 9-decenamide (i.e. a compound of the formula (I), wherein R¹ and R² are methyl and R³ is non-8-en-1-yl [—(CH₂)₇—CH═CH₂]).

The antimicrobial agent and the carboxamide compound of the formula (I) are preferably present in a weight ratio of from 200:1 to 1:500, more preferably from 100:1 to 1:200, in particular from 15:1 to 1:15, and specifically from 10:1 to 1:10. In case that the antimicrobial agent is 2-phenoxyethanol, phenoxyisopropanol, formic acid or a salt thereof, benzoic acid or a salt thereof, sorbic acid or a salt thereof, lactic acid or a salt thereof or N-(3-aminopropyl)-N-dodecylpropane-1,3-diamine (Diamine), the antimicrobial agent and the carboxamide compound of the formula (I) are preferably present in a weight ratio of from 200:1 to 1:500, more preferably from 100:1 to 1:100, in particular from 15:1 to 1:10, and specifically from 10:1 to 1:5.

In a preferred embodiment, the antimicrobial agent is selected from the group consisting of 2-phenoxyethanol, 4,4′-dichloro 2′-hydroxydiphenylether and 1,2-benzisothiazol-3(2H)one (BIT); in the carboxamide compound of the formula (I):
R¹ is hydrogen; R² is C₆-C₁₂-alkyl; and R³ is —CH═CH—COOH or —CH═CH—C(O)O⁻M⁺, where M⁺ is an alkali metal cation or an ammonium cation of the formula [NR^{a}R^{b}R^{c}R^{d}]⁺, where R^{a}, R^{b}, R^{c} and R^{d}, independently of each other, are selected from the group consisting of hydrogen, C₁-C₄-alkyl and C₁-C₄-alkoxy; or
R¹ and R² are C₁-C₂-alkyl; and R³ is C₇-C₁₁-alkyl; or
R¹ and R² are C₁-C₂-alkyl; and R³ is C₇-C₁₁-alkenyl; or
R¹ and R² form together a bridging group —CH₂—CH₂—O—CH₂—CH₂—; and R³ is C₅-C₁₃-alkyl, in particular C₇-C₁₁-alkyl
and the antimicrobial agent and the carboxamide compound of the formula (I) are present in an overall weight ratio of from 15:1 to 1:15;
where in case that the antimicrobial agent is 2-phenoxyethanol and in compounds (I) R¹ and R² are C₁-C₂-alkyl and R³ is C₇-C₁₁-alkyl, 2-phenoxyethanol and compounds (I) are present in an overall weight ratio of from 15:1 to 1:1, preferably from 10:1 to 1:1.

More preferably, the antimicrobial agent and the carboxamide compound of the formula (I) are present in an overall weight ratio of from 15:1 to 1:1, preferably from 10:1 to 1:1, if the antimicrobial agent is 2-phenoxyethanol; and the antimicrobial agent and the carboxamide compound of the formula (I) are present in an overall weight ratio of from 1:1 to 1:15, preferably from 1:1 to 1:10, if the antimicrobial agent is 4,4′-dichloro 2′-hydroxydiphenylether and 1,2-benzisothiazol-3(2H)one (BIT).

In a preferred embodiment, the composition further comprises at least one organic solvent The organic solvent is preferably selected from the group consisting of C₁-C₈-alkanols, C₂-C₈-alkanediols, C₁-C₈-alkylmonoethers of C₂-C₈-alkanediols, polyetherpolyols, C₁-C₈-alkylmonoethers of polyetherpolyols, 5-, 6- or 7-membered lactones which may be substituted by one or more C₁-C₁₂-alkyl groups; 5-, 6- or 7-membered cyclic carbonates which may be substituted by one or more C₁-C₁₂-alkyl groups; aliphatic esters, carboxamides different from component (b), aliphatic, alicyclic or heterocyclic amine-N-oxides and mixtures of the afore-mentioned solvents.

It has to be noticed that organic solvents in this context are not restricted to “typical” solvents, i.e. to organic compounds with solvating properties which are liquid at 25° C., but encompass compounds with solvating properties having a higher melting point of at most 50° C., and also compounds which exert their solvating properties only when mixed with water, such as the above-mentioned aliphatic, alicyclic or heterocyclic amine-N-oxides, which would more correctly be termed solubilizers.

C₁-C₈-alkanols are compounds R—OH, where R is linear or branched C₁-C₈-alkyl. Examples are methanol, ethanol, n-propanol, isopropanol, n-butanol, sec-butanol, isobutanol, tert-butanol, 1-pentanol, 1-hexanol, 1-heptanol, 1-octanol, 2-ethylhexanol and (other) structural isomers of the four last-mentioned 1-alkanols.

C₂-C₈-alkanediols are compounds HO-A-OH, where A is linear or branched C₂-C₈-alkanediyl (or C₂-C₈-alkylene), where the two OH groups are not geminally bound (i.e. are not bound to the same carbon atom). Examples are ethylene glycol (1,2-ethanediol), propylene glycol (1,2-propanediol), 1,3-propanediol, 1,2-butanediol, 1,4-butanediol, 1,2-pentanediol, 1,5-pentanediol, 1,2-hexanediol, 1,6-hexanediol, 1,2-heptanediol, 1,2-octanediol and the like.

C₁-C₈-Alkylmonoethers of C₂-C₈-alkanediols are compounds RO-A-OH, where A is as defined for the alkanediols above and R is C₁-C₈-alkyl. Examples are ethylene glycol monomethyl ether, ethylene glycol monoethyl ether, ethylene glycol mono-n-propyl ether, ethylene glycol monoisopropyl ether, ethylene glycol mono-n-butyl ether (butyl glycol), ethylene glycol mono-sec-butyl ether, ethylene glycol mono-isobutyl ether, ethylene glycol mono-tert-butyl ether, ethylene glycol monopentyl ether, ethylene glycol monohexyl ether, ethylene glycol monoheptyl ether, ethylene glycol monooctyl ether, propylene glycol monomethyl ether, propylene glycol monoethyl ether, propylene glycol mono-n-propyl ether, propylene glycol monoisopropyl ether, propylene glycol mono-n-butyl ether, propylene glycol mono-sec-butyl ether, propylene glycol mono-isobutyl ether, propylene glycol mono-tert-butyl ether, propylene glycol monopentyl ether, propylene glycol monohexyl ether, propylene glycol monoheptyl ether, propylene glycol monooctyl ether, 1,3-propanediol monomethyl ether, 1,3-propanediol monoethyl ether, 1,3-propanediol mono-n-propyl ether, 1,3-propanediol monoisopropyl ether, 1,3-propanediol mono-n-butyl ether, 1,3-propanediol mono-sec-butyl ether, 1,3-propanediol mono-isobutyl ether, 1,3-propanediol mono-tert-butyl ether, 1,3-propanediol monopentyl ether, 1,3-propanediol monohexyl ether, 1,3-propanediol monoheptyl ether, 1,3-propanediol monooctyl ether and the like.

Polyetherpolyols are formally the etherification products of alkanediols and thus compounds HO-A-[O-A]ₙ—OH, where each A is independently an alkylene group, generally a C₂-C₃-alkylene group, such as 1,2-ethylene, 1,2-propylene or 1,3-propylene, and n is from 1 to 100. Examples are polyethylene glycol, generally with a molecular weight of from 106 to ca. 4500, and polypropyleneglycol, generally with a molecular weight of from 134 to ca. 6000.

C₁-C₈-Alkylmonoethers of polyetherpolyols are compounds RO-A-[O-A]ₙ—OH, where A and n are as defined for the polyetherpolyols above and R is C₁-C₈-alkyl. Examples are polyethylene glycol monomethyl ether, polyethylene glycol monoethyl ether, polyethylene glycol mono-n-propyl ether, polyethylene glycol mono-n-butyl ether, and the like.

Examples for 5-, 6- or 7-membered lactones which may be substituted by one or more C₁-C₁₂-alkyl groups are γ-butyrolactone, γ-valerolactone, γ-octalactone, γ-nonalactone, δ-valerolactone, δ-decanolactone, δ-dodecanolactone and ε-caprolactone which may carry one or more C₁-C₁₂-alkyl substituents.

Examples for 5-, 6- or 7-membered cyclic carbonates which may be substituted by one or more C₁-C₁₂-alkyl groups are ethylene carbonate, propylene carbonate and butylene carbonate which may carry one or more C₁-C₁₂-alkyl substituents.

Examples for suitable aliphatic esters are ethyl acetate, propyl acetate, butyl acetate, methylpropionate and ethyl propionate.

Examples for suitable carboxamides different from component (b) are N,N-dimethytformamide, N,N-diethytformamide and N,N-dimethylacetamide.

Examples for suitable aliphatic, alicyclic or heterocyclic amine-N-oxides are N,N-dimethyl-N-ethylamine N-oxide, N,N,N-triethylamine N-oxide, N,N-dimethyl-N-cyclohexylamine N-oxide, N,N-dimethyl-N-ethanolamine N-oxide (DMEAO) and N-methylmorpholine N-oxide.

More preferably, the solvent is selected from the group consisting of C₁-C₈-alkylmonoethers of C₂-C₈-alkanediols (among which preference is given to C₁-C₄-alkylmonoethers of a C₂-C₃-alkanediol, such as the C₁-C₄-alkylmonoethers of ethylene glycol or propylene glycol, specific examples being ethylene glycol mono-n-propyl ether, ethylene glycol mono-n-butyl ether (also termed butylglyol), propylene glycol mono-n-propyl ether, propylene glycol mono-n-butyl ether and mixtures thereof, and 5-, 6- or 7-membered lactones which may carry one or more C₁-C₁₂-alkyl groups; in particular from 5-, 6- or 7-membered lactones which may carry one or more C₁-C₁₂-alkyl groups; specifically from γ-butyrolactone, γ-valerolactone, γ-octalactone, γ-nonalactone, δ-valerolactone, δ-decanolactone, δ-dodecanolactone and ε-caprolactone; and very specifically from γ-butyrolactone, γ-valerolactone, γ-octalactone, γ-nonalactone, ε-caprolactone and mixtures thereof.

In another preferred embodiment the solvent is a C₂-C₈-alkanediol, more preferably a C₂-C₄-alkanediol, in particular a C₂-C₃-alkanediol, such as ethylene glycol, 1,2-propanediol and 1,3-propanediol, and specifically 1,2-propanediol (propylene glycol).

In another preferred embodiment the solvent is a C₁-C₈-alkanol, more preferably a C₁-C₄-alkanol, and in particular a C₂-C₃-alkanol (i.e. ethanol, n-propanol, isopropanol or a mixture thereof), specifically n-propanol.

In another preferred embodiment, the composition comprises water.

In another preferred embodiment, the composition comprises both water and an organic solvent.

The optimum relative and absolute amounts of components (a) and (b), the presence, nature and amounts of the optionally present component (c) and the presence, nature and amounts of the optionally present solvents and water depend on the nature of the composition.

The composition of the invention can be a concentrate comprising the antimicrobial (a), the carboxamide compound (I) of component (b) and optionally a carrier, such as a diluent, e.g. an organic solvent and/or water; or can be an intermediate composition, i.e. a composition which is not yet the ready-to-use composition for the end user, but already comprises a part of the other components (i.e. components different from of the antimicrobial (a), the carboxamide compound (I) and the optional carrier) of the final ready-to-use composition; or can be a ready-to-use-composition.

Antimicrobials find use in a vast field of application. In principle, any water-containing system or material devoid of intrinsic protection (intrinsic protection can for example be present in systems which contain a sufficiently high amount of alcohol and/or surfactant to hinder microbial infestation, etc.) is prone to microbial attack/infestation.

Examples for such systems, materials or products needing antimicrobial protection and/or exerting themselves an antimicrobial action are homecare compositions (such as laundry compositions, e.g. detergents or fabric softeners; dishwashing compositions; cleaning compositions etc.), compositions for cleaning or disinfecting on an industrial scale (in contrast to home care carried out on a distinctly smaller scale), personal care compositions (including cosmetics), process water, water in fish or shrimp ponds, water in drinking troughs, metal working fluids; water based raw materials, polymer solutions, polymer dispersions, polymer emulsions, inorganic slurries, organic slurries, surfactant compositions; compositions for treating animal hide; compositions for treating leather; compositions for treating textiles during the manufacturing process thereof; compositions for treating lumber; compositions for treating paper or the precursor material during papermaking processes; crop protection compositions; pharmaceutical compositions; paints, glues, adhesives, sealants, dyes, pigments and dispersions thereof, inks, wet wipes (for personal care, for homecare etc.) and the like.

The composition of the invention is thus preferably selected from the group consisting of antimicrobial concentrates, homecare compositions, compositions for cleaning or disinfecting on an industrial scale, personal care compositions, process water, water in fish or shrimp ponds, water in drinking troughs, metal working fluids; water based raw materials, polymer solutions, polymer dispersions, polymer emulsions, inorganic slurries, organic slurries, surfactant compositions; compositions for treating animal hide; compositions for treating leather; compositions for treating textiles during the manufacturing process thereof; compositions for treating lumber; compositions for treating paper or the precursor material during papermaking processes; crop protection compositions; pharmaceutical compositions; paints, glues, adhesives, sealants, dyes, pigments and dispersions thereof, inks, and wet wipes.

Homecare compositions and compositions for cleaning or disinfecting on an industrial scale (also called industrial and institutional cleaning or I&I cleaning) overlap largely, only that I&I compositions are adapted to the use on a larger scale and are thus often more aggressive (e.g. by being more concentrated and/or by having a distinctly higher or lower pH than the respective homecare composition) and/or are less “pleasant”, e.g. in the sense of odor or aspect or touch. Moreover, they are suitable for clean-in-place (CIP), which is a method of automated cleaning the interior surfaces of pipes, vessels, equipments, filters and associated fittings and the like without major disassembly.

Examples for homecare and I&I compositions are dishwashing compositions (in liquid or gel form), laundry compositions (in liquid or gel form; for example laundry detergents, fabric softeners, rinsing compositions, bleacher compositions, stain remover compositions and the like), surface cleaning compositions (also termed hard surface cleaners; for example glass, floor, counter, bath(room), toilet bowl, sink, kitchen, appliance and furniture cleaning compositions; all-purpose cleaners; sanitary cleaners), non-cosmetic deodorants (e.g. air and/or surface deodorants), disinfectants (for example spray air disinfectants, and spray, liquid and paste/gel surface disinfectants), surface protecting and/or polishing compositions, rug shampoos, descaling agents, and compositions for wet wipes (e.g. for cleaning the floor, furniture, bath room surfaces etc.).

Personal care compositions are used for cleaning, washing, disinfecting, nurturing, grooming, protecting or embellishing the human body (and thus also include cosmetics). Examples are creams, lotions, ointments, other o/w or w/o emulsions, liquid or gel-like soaps, shampoos, make-up and other decorative cosmetics, and compositions for wet wipes (e.g. for cleaning the nappy area). More specific examples are skin-washing and cleansing preparations in the form of soaps, syndets, washing gels, soapless detergents or washing pastes, bath preparations, e.g. foam baths, milks, oils, shower preparations; skin-care preparations, e.g. skin emulsions, multi-emulsions, powders, sprays or skin oils; cosmetic preparations, e.g. facial make-up in the form of day creams or powder creams, face powder (loose or pressed), rouge or cream make-up, eye-care preparations, e.g. eyeshadow preparations, mascara, eyeliner, eye creams or eye-fix creams; lip-care preparations, e.g. lipsticks, lip gloss, lip contour pencils, nail-care preparations, such as nail varnish, nail varnish removers, nail hardeners or cuticle removers; foot-care preparations, e.g. foot baths, foot powders, foot creams or foot balsams, special deodorants and antiperspirants or callus-removing preparations; light-protective preparations, such as sun milks, lotions, creams or oils, sunblocks or tropicals, pre-tanning preparations or after-sun preparations; skin-tanning preparations, e.g. self-tanning creams; depigmenting preparations, e.g. preparations for bleaching the skin or skin-lightening preparations; insect-repellents, e.g. insect-repellent oils, lotions, sprays or sticks; deodorants, such as deodorant sprays, deodorant aerosols, pump-action sprays, deodorant gels, sticks or roll-ons, also water-free deodorant aerosols or sticks; antiperspirants, e.g. antiperspirant sticks, creams or roll-ons; preparations for cleansing and caring for blemished skin, e.g. synthetic detergents (solid or liquid), peeling or scrub preparations or peeling masks; hair-removal preparations in chemical form (depilation), e.g. liquid hair-removing preparations, cream- or paste-form hair-removing preparations, hair-removing preparations in gel form or aerosol foams; shaving preparations, e.g. shaving soap, foaming shaving creams, non-foaming shaving creams, foams and gels, pre-shave preparations for dry shaving, aftershaves or aftershave lotions; fragrance preparations, e.g. fragrances (eau de Cologne, eau de toilette, eau de parfum, parfum de toilette, perfume), perfume oils or perfume creams; cosmetic hair-treatment preparations, e.g. hair-washing preparations in the form of shampoos and conditioners, hair-care preparations, e.g. pre-treatment preparations, hair tonics, styling creams, styling gels, pomades, hair rinses, treatment packs, intensive hair treatments, hair-structuring preparations, e.g. hair-waving preparations for permanent waves (hot wave, mild wave, cold wave), hair-straightening preparations, liquid hairsetting preparations, hair foams, hairsprays, bleaching preparations, e.g. hydrogen peroxide solutions, lightening shampoos, bleaching creams, bleaching powders, bleaching pastes or oils, temporary, semi-permanent or permanent hair colorants, preparations containing self-oxidising dyes, or natural hair colorants, such as henna or camomile; antidandruff preparations in the form of shampoos, conditioners, hair tonics, styling creams or gels or treatments packs; oral care preparations such as (tooth) pastes, gels, mouth washes and sprays; disinfectants for mouth or skin.

Process water is for example process water used in food, feed, pharmaceutical or cosmetic industry (cooling and process water), or process water used in paper production, wood treatment, cooling water towers, air washers, air conditioners, printing fluids or oil production.

Crop protection compositions, which are often also termed plant protection compositions, are compositions which are effective against various harmful microorganisms, harmful invertebrate pests or undesired plants relevant for agriculture, e.g. harmful fungi, harmful invertebrate pests, such as harmful insects, arachnids, nematodes or molluscs, and weeds, which cause damage to agricultural plants, plant propagation materials, such as seeds, or harvested crops. Examples for crop protection compositions are fungicidal, insecticidal, acaricidal, nematicidal, moluscicidal or herbicidal compositions. The term encompasses also plant growth regulating compositions. Plant growth regulators are plant protection products used to influence plant growth and are used, for example, for increasing the stability of cereals by shortening the stalk length, thus reducing or preventing lodging, for improving the rooting of cuttings, reducing plant height in horticulture, preventing the germination of potatoes and the like. The term encompasses moreover compositions used in material protection for combating various harmful microorganisms and invertebrate pests, such as compositions for the treatment of lumber or the surroundings of lumber material against termites or compositions for the treatment of mosquito nets against harmful insects, such as Anopheles mosquitoes, and the like.

### Antimicrobial Concentrate

In a preferred embodiment, the composition is an antimicrobial concentrate. Preferably, the antimicrobial concentrate comprises:
(a) 0.01 to 99.9% by weight, relative to the total weight of the composition, of at least one antimicrobial agent as defined above;
(b) 0.1 to 99.99% by weight, relative to the total weight of the composition, of a carboxamide compound of the formula (I) or a mixture of different carboxamide compounds of the formula (I) as defined above;
(c) 0 to 20% by weight, relative to the total weight of the composition, of at least one further additive;
(d) 0 to 99.8% by weight, relative to the total weight of the composition, of at least one organic solvent [different from component (b) (and of course also from said antimicrobial agent)], preferably as defined above; and
(e) 0 to 99.8% by weight, relative to the total weight of the composition, of water.

The term “concentrate” is used in this context also for compositions in which components (a) and (b) do not constitute the major part (and thus do not form a concentrate in the proper sense). Nevertheless, it signals that components different from (a), (b) and the optional diluents (d) and (e), if at all present, do not predominate. Moreover, the term signals that the composition can consist of components (a) and (b) only. Preferably however, at least a diluent (d) or (e) or mixtures thereof are present to assure an easier handling.

In case that the antimicrobial agent is 2-phenoxyethanol, phenoxyisopropanol, formic acid or a salt thereof, benzoic acid or a salt thereof, sorbic acid or a salt thereof, lactic acid or a salt thereof or N-(3-aminopropyl)-N-dodecylpropane-1,3-diamine (Diamine), this is preferably contained in an amount of 0.1 to 99.9% by weight, relative to the total weight of the composition.

Suitable and preferred components (a) and (b) and suitable and preferred weight ratios thereof are those mentioned above.

Further additives (c) are for example agents which stabilize the concentrate, such as emulsifiers and/or hydrotropic agents, activity enhancers different from component (b) and pH modifiers.

Any emulsifiers usual in such systems can be used. A few non-limiting examples are carboxylic acids and their salts, alkyl phosphates or phosphoric acid esters, ethoxylated and/or propoxylated fatty acids, ethoxylated and/or propoxylated polyethyleneglycols, ethoxylated and/or propoxylated fatty alcohols, fatty acid monoglycerides, fatty acid saccharose esters, fatty acid sorbitol esters, fatty acid sorbitan esters, fatty acid glucose esters, ethoxylated and/or propoxylated derivatives of the listed fatty acid polyol esters, fatty sulfates and sulfonates, ethoxylated amines, ethoxylated amides, polysiloxane/polyalkyl/polyether copolymers and derivatives, poly(oxyethylene)poly(oxypropylene)-blockpolymers, zwitterionic surfactants that carry at least one quaternary ammonium group and at least one carboxylate and/or sulfonate group in the molecule.

Hydrotropic agents are compounds which solubilize hydrophobic compounds in aqueous solution by means other than micellar solubilization. Similar to surfactants, hydrotropes often (but not necessarily) consist of a hydrophilic part and a hydrophobic part, but in contrast to surfactants the hydrophobic part is generally too small to cause spontaneous self-aggregation. Examples are aromatic sulfonic acid salts, such as the alkali metal, earth alkaline metal or ammonium salts of p-toluenesulfonic acid (e.g. sodium, potassium, calcium or ammonium p-tosylate), of xylene sulfonic acids (e.g. the sodium, potassium, calcium or ammonium salts of o-, m- or p-xylene sulfonates) or of cumene sulfonic acids, generally of p-cumene sulfonic acid (e.g. the sodium, potassium, calcium or ammonium salts of p-cumenesulfonate); adenosine triphosphate (ATP); and urea.

Examples for activity enhancers different from component (b) are ethylhexylglycerine (3-(2-ethylhexyloxy)propan-1,2-diol) and polyethyleneimines (PEI). Further details are given below in context with homecare compositions.

### pH Modifiers are Acids, Bases and Also Buffers.

The acids can be inorganic or organic. Suitable inorganic acids are for example sulfuric acid, hydrochloric acid and phosphoric acid, where sulfuric acid is generally preferred. Suitable organic acids are for example aliphatic, saturated non-substituted C₁-C₆-mono-, di- and tri-carboxylic acids such as formic acid, acetic acid, propanoic acid, oxalic acid, succinic acid and glutaric acid; aliphatic, saturated C₁-C₆-mono-, di- and tri-carboxylic acids carrying one or more OH groups, such as lactic acid, tartric acid and citric acid; aliphatic, unsaturated C₁-C₆-mono-, di- and tri-carboxylic acids such as sorbic acid; aromatic carboxylic acids, such as benzoic acid, salicylic acid and mandelic acid, and sulfonic acids, such as methanesulfonic acid or toluenesulfonic acid.

Suitable bases are in particular inorganic bases, such as the carbonates mentioned below in context with the sequestrant, e.g. sodium or potassium carbonate; further alkali metal and earth alkaline meal hydroxides, such as NaOH or KOH.

Suitable buffering agents are the typical systems, such as hydrogenphosphate/dihydrogenphosphate buffer, carbonate/hydrogencarbonate buffer, acetic acid/acetate buffer or Tris buffer. Moreover, most of the above acids which are weak and the anion of which is not a strong salt also have buffering capacity.

Suitable organic solvents (d) are those mentioned above. Preferred organic solvents are thus C₁-C₈-alkanols, C₂-C₈-alkanediols, C₁-C₈-alkylmonoethers of C₂-C₈-alkanediols, polyetherpolyols, C₁-C₈-alkylmonoethers of polyetherpolyols, 5-, 6- or 7-membered lactones which may be substituted by one or more C₁-C₁₂-alkyl groups; 5-, 6- or 7-membered cyclic carbonates which may be substituted by one or more C₁-C₁₂-alkyl groups; aliphatic esters, carboxamides different from component (b), aliphatic or alicyclic amine-N-oxides and mixtures of the afore-mentioned solvents. Examples for these solvent groups are mentioned above. More preferably, the solvent (d) is selected from C₁-C₈-alkylmonoethers of C₂-C₈-alkanediols (among which preference is given to C₁-C₄-alkylmonoethers of a C₂-C₃-alkanediol, such as the C₁-C₄-alkylmonoethers of ethylene glycol or propylene glycol, specific examples being ethylene glycol mono-n-butyl ether (also termed butylglyol) and propylene glycol mono-n-butyl ether; and 5-, 6- or 7-membered lactones which may carry one or more C₁-C₁₂-alkyl groups; and in particular from 5-, 6- or 7-membered lactones which may carry one or more C₁-C₁₂alkyl groups; specifically from γ-butyrolactone, γ-valerolactone, γ-octalactone, γ-nonalactone, δ-valerolactone, δ-decanolactone, δ-dodecanolactone and ε-caprolactone; and very specifically from γ-butyrolactone, γ-valerolactone, γ-octalactone, γ-nonalactone and ε-caprolactone.

In another more preferred embodiment, the solvent (d) is a C₂-C₈-alkanediol, even more preferably a C₂-C₄-alkanediol, in particular a C₂-C₃-alkanediol, such as ethylene glycol, 1,2-propanediol and 1,3-propanediol, and specifically 1,2-propanediol (propylene glycol).

In another more preferred embodiment, the solvent (d) is a C₁-C₈-alkanol, even more preferably a C₁-C₄-alkanol, and in particular a C₂-C₃-alkanol, such as ethanol, n-propanol or isopropanol; specifically n-propanol.

In a particular embodiment, the antimicrobial concentrate comprises:
(a) 1 to 99.9% by weight, relative to the total weight of the composition, of at least one antimicrobial agent as defined above;
(b) 0.1 to 99% by weight, relative to the total weight of the composition, of a carboxamide compound of the formula (I) or a mixture of different carboxamide compounds of the formula (I) as defined above;
(c) 0 to 15% by weight, relative to the total weight of the composition, of at least one further additive;
(d) 0 to 98.9% by weight, relative to the total weight of the composition, of at least one organic solvent [different from component (b) (and of course also from said antimicrobial agent)], preferably as defined above; and
(e) 0 to 98.9% by weight, relative to the total weight of the composition, of water;

In another particular embodiment, the antimicrobial concentrate comprises:
(a) 5 to 90% by weight, relative to the total weight of the composition, of at least one antimicrobial agent as defined above;
(b) 10 to 95% by weight, relative to the total weight of the composition, of a carboxamide compound of the formula (I) or a mixture of different carboxamide compounds of the formula (I) as defined above;
(c) 0 to 10% by weight, relative to the total weight of the composition, of at least one further additive;
(d) 0 to 85% by weight, relative to the total weight of the composition, of at least one organic solvent [different from component (b) (and of course also from said antimicrobial agent)], preferably as defined above; and
(e) 0 to 85% by weight, relative to the total weight of the composition, of water.

### Homecare and I&I Compositions

Examples for homecare and I&I compositions are listed above. Among these, preference is given to dishwashing compositions, laundry compositions, surface cleaning compositions, and rug shampoos.

Thus, in another preferred embodiment, the composition of the invention is selected from the group consisting of dishwashing compositions, laundry compositions, surface cleaning compositions, and rug shampoos. Such compositions preferably comprise:
(a) 0.001 to 7% by weight, relative to the total weight of the composition, of at least one antimicrobial agent as defined above;
(b) 0.001 to 7% by weight, relative to the total weight of the composition, of a carboxamide compound of the formula (I) or a mixture of different carboxamide compounds of the formula (I) as defined above;
(c) 0.1 to 40% by weight, relative to the total weight of the composition, of at least one surfactant [different from component (b)];
(d) 0 to 15% by weight, relative to the total weight of the composition, of at least one organic solvent [different from component (b) (and of course also from said antimicrobial agent)], preferably as defined above;
(e) 0 to 6 by weight, relative to the total weight of the composition, of at least one enzyme;
(f) 0 to 20% by weight, relative to the total weight of the composition, of at least one sequestrant;
(g) 0 to 8% by weight, relative to the total weight of the composition, of at least one defoamer and/or foam stabilizer;
(h) 0 to 50% by weight, relative to the total weight of the composition, of at least one further additive; and
(i) 10 to 94.998% by weight, relative to the total weight of the composition, of water;
where components (a) to (i) add to 100% by weight.

Suitable and preferred components (a) and (b) and suitable and preferred weight ratios thereof are those mentioned above.

Surfactants (or surface-active compounds) of component (c) can be anionic, cationic, non-ionic or amphoteric (zwitterionic).

Anionic surfactants are, for example, of the sulfate, sulfonate or carboxylate type or mixed forms thereof. Examples are alkylbenzenesulfonates, alkyl sulfates, alkyl ether sulfates, olefin sulfonates, fatty acid salts, alkyl and alkenyl ether carboxylates or to an alpha-sulfonic fatty acid salt or an ester thereof.

More specific examples are alkylbenzenesulfonates having from 10 to 20 carbon atoms in the alkyl radical (e.g. sodium dodecylbenzene sulfonate), alkyl sulfates having from 8 to 18 carbon atoms in the alkyl radical (e.g. sodium lauryl sulfate), alkyl ether sulfates having from 8 to 18 carbon atoms in the alkyl radical (e.g. sodium laureth sulfate; SLES), and fatty acid salts derived from oils or fats, e.g. from palm oil or tallow and having from 8 to 18 carbon atoms in the alkyl moiety (thus containing, inter alia, sodium oleate, linolate, palmitate, myristate, stearate etc.). The counter-cation is preferably an alkali metal cation, especially sodium or potassium, specifically sodium. Preferred carboxylates are alkali metal sarcosinates of formula R—CON(R′)CH₂COO⁻M⁺ wherein R′ is C₉-C₁₇-alkyl or C₉-C₁₇-alkenyl, R′ is C₁-C₄-alkyl and M⁺ is an alkali metal cation, especially Na⁺.

Cationic surfactants are, for example, ammonium salts such as C₈-C₁₆-dialkyldimethylammonium halides, dialkoxydimethylammonium halides or imidazolinium salts with a long-chain alkyl radical.

Non-ionic surfactants are, for example, a primary or secondary alcohol ethoxylate, especially a C₆-C₂₀ aliphatic alcohol ethoxylated with an average of from 1 to 20 mol of ethylene oxide per alcohol group. Preference is given to primary and secondary C₁₀-C₁₆ aliphatic alcohols ethoxylated with an average of from 1 to 10 mol of ethylene oxide per alcohol group. Non-ethoxylated non-ionic surfactants, for example alkylpolyglycosides, glycerol monoethers and polyhydroxyamides (glucamide), may likewise be used.

Amphoteric surfactants are, for example, derivatives of secondary or tertiary amines, for example C₆-C₁₈-alkyl betaines (e.g. cocoamidopropyl betaine; disodium cocoamphodiacetate (DSCADA)) or C₆-C₁₅-alkyl sulfobetaines, or amine oxides such as alkyldimethylamine oxides.

Suitable organic solvents (d) are those mentioned above. Preferred organic solvents are thus C₁-C₈-alkanols, C₂-C₈-alkanediols, C₁-C₈-alkylmonoethers of C₂-C₈-alkanediols, polyetherpolyols, C₁-C₈-alkylmonoethers of polyetherpolyols, 5-, 6- or 7-membered lactones which may be substituted by one or more C₁-C₁₂-alkyl groups; 5-, 6- or 7-membered cyclic carbonates which may be substituted by one or more C₁-C₁₂-alkyl groups; aliphatic esters, carboxamides different from component (b), aliphatic or alicyclic amine-N-oxides and mixtures of the afore-mentioned solvents. Examples for these solvent groups are mentioned above. More preferably, the solvent is selected from C₁-C₈-alkylmonoethers of C₂-C₈-alkanediols (among which preference is given to C₁-C₄-alkylmonoethers of a C₂-C₃-alkanediol, such as the C₁-C₄-alkylmonoethers of ethylene glycol or propylene glycol, specific examples being ethylene glycol mono-n-butyl ether (also termed butylglyol) and propylene glycol mono-n-butyl ether; and 5-, 6- or 7-membered lactones which may carry one or more C₁-C₁₂-alkyl groups; and in particular from 5-, 6- or 7-membered lactones which may carry one or more C₁-C₁₂-alkyl groups; specifically from γ-butyrolactone, γ-valerolactone, γ-octalactone, γ-nonalactone, δ-valerolactone, δ-decanolactone, δ-dodecanolactone and ε-caprolactone; and very specifically from γ-butyrolactone, γ-valerolactone, γ-octalactone, γ-nonalactone and ε-caprolactone.

In another more preferred embodiment, the solvent (d) is a C₂-C₈-alkanediol, even more preferably a C₂-C₄-alkanediol and in particular a C₂-C₃-alkanediol, such as ethylene glycol, 1,2-propanediol and 1,3-propanediol, and specifically 1,2-propanediol (propylene glycol).

In another more preferred embodiment, the solvent (d) is a C₁-C₈-alkanol, even more preferably a C₁-C₄-alkanol, and in particular a C₂-C₃-alkanol, such as ethanol, n-propanol or isopropanol; specifically n-propanol.

Examples for enzymes of component (e) are those typically used in laundry, dishwashing or cleaning compositions.

Enzyme herein means catalytically active proteins which are characterized by an amino acid sequence. Variants of an enzyme may be described by a certain sequence identity of an amino acid sequence of the variant when compared to a respective starting sequence. For calculation of sequence identities, in a first step a pairwise global sequence alignment has to be produced, meaning that two sequences have to be aligned over their complete length typically by using the algorithm of Needleman and Wunsch (J. Mol. Biol. (1979) 48, p. 443-453). Preferably, the program “NEEDLE” (The European Molecular Biology Open Software Suite (EMBOSS)) is used for the purposes of the current invention, with using the programs default parameter (gap open=10.0, gap extend=0.5 and matrix=EBLOSUM62). In a second step, % identity is calculated: %-identity=(identical residues/length of the alignment region which is showing the respective sequence of this invention over its complete length)*100.

The enzymes are preferably selected from hydrolases, such as proteases, esterases, glucosidases, lipases, DNAses, amylases, cellulases, mannanases, other glycosylhydrolases and mixtures of the aforementioned enzymes. All these hydrolases contribute to dissolution and removal of soil from protein-, grease- or starch-containing stains/residues. For bleaching, it is also possible to use oxidoreductases. Particularly suitable are active enzymatic ingredients obtained from bacterial strains or fungi, such as Bacillus subtilis, Bacillus licheniformis, Streptomyceus griseus and Humicola insolens.

Preferred hydrolases are selected from the group of enzymes acting on ester bonds (esterases) (E.C. 3.1), glycosylases (E.C. 3.2), and peptidases (E.C. 3.4). Enzymes acting on ester bonds (E.C. 3.1), are for example lipases and DNAses. Glycosylases (E.C. 3.2) are for example amylases, cellulases, and mannanases. Peptidases are for example proteases.

Suitable hydrolases are, for example, α-glucosidases (EC number 3.2.1.20), proteases (e.g. Ovozyme® (from Novozymes); EC number 3.2.1.20), amylases [e.g. Purastar® (from Genencor), Termamyl® (from Novozymes), Stainzyme® (from Novozymes), Duramyl® (from Novozymes)], mannanases [e.g. Purabrite® (from Genencor), Mannastar® (from Genencor), Mannaway® (from Novozymes)] and cellulases [e.g. Carezyme® (from Novozymes), Celluzyme® (from Novozymes), endolase, Puradax® (from Genencor)]. The suitable amylases include especially α-amylases (EC number 3.2.1.1), iso-amylases, pullulanases and pectinases. The cellulases used are preferably cellobiohydrolases, endoglucanases and β-glucosidases, which are also referred to as cellobiases, or mixtures thereof. Since different cellulase types differ by their CMCase and Avicelase activities, it is possible to establish the desired activities by means of controlled mixtures of the cellulases.

Suitable lipases are for example Lipex and Lipolase. Examples of lipolytically active enzymes are the known cutinases.

Peroxidases or oxidases have also been found to be suitable in some cases.

In one aspect, the enzymes comprise at least one protease (EC 3.4). In a preferred embodiment, at least one protease is selected from serine proteases (EC 3.4.21), more preferably from subtilisins (EC 3.4.21.62). At least one subtilisin may have SEQ ID NO:22 as described in EP 1921147 (which may be called BLAP WT herein), or is a variant thereof which is at least 80% identical SEQ ID NO:22 as described in EP 1921147 and has proteolytic activity. In one embodiment, a subtilisin is at least 80% identical to SEQ ID NO:22 as described in EP 1921147 and is characterized by having amino acid glutamic acid (E), or aspartic acid (D), or asparagine (N), or glutamine (Q), or alanine (A), or glycine (G), or serine (S) at position 101 (according to BPN′ numbering), preferably R101E.

In one embodiment, at least one subtilisin is at least 80% identical to SEQ ID NO:22 as described in EP 1921147 having the mutations (according to BPN′ numbering) S3T+V4I+V205I. In one embodiment, at least one subtilisin is at least 80% identical to SEQ ID NO:22 as described in EP 1921147 having the mutations (according to BPN′ numbering) S3T+V4I+R101E+V205I. In one embodiment, at least one subtilisin is at least 80% identical to SEQ ID NO:22 as described in EP 1921147 having the mutation (according to BPN′ numbering) S3T+V4I+V199M+V205I+L217D. In one embodiment, at least one subtilisin has an amino acid sequence being at least 80% identical with SEQ ID NO:22 as described in EP 1921147 having the mutations S3T+V4I+S9R+A15T+V68A+D99S+R101S+A103S+1104V+N218D (according to the BPN′ numbering). at least one subtilisin has an amino acid sequence at least 80% identical to SEQ ID NO:22 as described in EP 1921147 and having the mutation R101E together with one or more substitutions selected from the group consisting of S156D, L262E, Q137H, S3T, R45E,D,Q, P55N, T58W,Y,L, Q59D,M,N,T, G61 D,R, S87E, G97S, A98D,E,R, S106A,W, N117E, H120V,D,K,N, S125M, P129D, E136Q, S144W, S161T, S163A,G, Y171 L, A172S, N185Q, V199M, Y209W, M222Q, N238H, V244T, N261T,D and L262N,Q,D (as described in WO 2016/096711 and according to the BPN′ numbering).

In one aspect, the enzymes comprise at least one amylase, preferably at least one alpha-amylase (EC 3.2.1.1). Preferably, the enzymes comprise at least one alpha-amylase selected from hybrid amylases. In one embodiment, the enzymes comprise at least one hybrid amylase at least 95% identical to SEQ ID NO: 23 of WO 2014/183920.

In one embodiment, the enzymes comprise at least one hybrid amylase 95% identical to SEQ ID NO:30 of WO 2014/183921.

In one aspect, detergent formulations comprise at least one lipase, preferably at least one triacylglycerol lipase (EC 3.1.1.3).

Preferably, the enzymes comprise at least one at least one Thermomyceas lanuginosus triacylglycerol lipase. In one embodiment, said lipase at least 80% identical to amino acids 1-269 of SEQ ID NO:2 of U.S. Pat. No. 5,869,438. In one embodiment, said lipase comprises at least the amino acid substitutions T231R and N233R. In one embodiment, the enzymes comprise at least one lipase comprising T231R and N233R and one or more of the following amino acid exchanges when compared to amino acids 1-269 of SEQ ID NO:2 of U.S. Pat. No. 5,869,438: Q4V, V60S, A150G, L227G, P256K.

In one embodiment, the enzymes comprise at least one lipase at least 95% identical to the full length polypeptide sequence of amino acids 1-269 of SEQ ID NO:1 of WO 2015/01009, preferably comprising at least the amino acid substitutions N11K/A18K/G23K1K24A/V77I/D130A/V154I/V187T1T189Q or N11K/A18K/G23K1K24A/L75R/V77I/D130A/V154I/V187T/T189Q.

In one aspect, the enzymes comprise at least one cellulase, preferably at least one beta-1,4-glucanase (EC 3.2.1.4), also called endoglucanase herein. In one embodiment, the enzymes comprise at least one Humicola insolens DSM 1800 endoglucanase at least 80% identical to the amino acid sequence disclosed in FIG. 14A-E of WO 91/17244, preferably to the sequence according to amino acids 20-434. Preferably said endoglucanase having one or more substitutions at positions selected from 182, 223, and 231, most preferably selected from P182S, A223V, and A231V. In one embodiment, the enzymes comprise at least one endoglucanase at least 80% identical to a polypeptide according to SEQ ID NO: 2 of WO 95/02675. In one embodiment, the enzymes comprise at least one Bacillus sp. endoglucanase which is at least 80% identical to the amino acid sequence of position 1 to position 773 of SEQ ID NO: 2 of WO 2004/053039. In one embodiment, the enzymes comprise at least one Thielavia terrestris endoglucanase which is at least 80% identical to the amino acid sequence of position 1 to position 299 of SEQ ID NO:4 of WO 2004/053039.

In one aspect, the enzymes comprise at least one mannanase, preferably at least one beta-mannanase (EC 3.2.1.78). In one embodiment, the enzymes comprise at least one beta-mannanase selected from GH5 family mannanase. In one embodiment, the enzymes comprise at least one beta-mannanase at least 90% identical to SEQ ID NO:12 of WO 2018/184767. In one embodiment, the enzymes comprise at least one beta-mannanase at least 90% identical to SEQ ID NO:16 of WO 2018184767. In one embodiment, the enzymes comprise at least one beta-mannanase at least 90% identical to SEQ ID NO:20 of WO 2018/184767. Preferably, the enzymes comprise at least one mannanase 95% identical to a polypeptide sequence of SEQ ID NO:20 of WO 2018184767 having at least one substitution selected from A101V, E405G, and Y459F. In one embodiment, the enzymes comprise at least one beta-mannanase originating from Trichoderma organisms, such as those disclosed in WO 93/24622. Preferably, at least one beta-mannanase is 80% identical to SEQ ID NO:1 of WO 2008/009673. More preferably, the beta-mannanase according to SEQ ID NO:1 of WO 2008/009673 comprises at least one substitution selected from S3R, S66P, N113Y, V181H, L207F, A215T and F274L.

In one aspect, detergent formulations comprise at least one DNAse. In one embodiment, the enzymes comprise at least one DNAse at least 80% identical to SEQ ID NO: 1-24 and SEQ ID NO: 27-28 of WO 2019/081724 and WO 2019/081721. Preferably, the enzymes comprise at least one DNAse comprising one or both motifs selected from SEQ ID NO:25 and SEQ ID NO:26 of WO 2019/081724. In one embodiment, the enzymes comprise at least one DNAse comprising one or more motifs selected from SEQ ID NO:73, SEQ ID NO:74 and SEQ ID NO:75 of WO 2017/060493.

In case the composition is a dishwashing composition, this comprises preferably at least one protease and/or amylase. More preferably, it comprises an enzyme mixture.

Preference is given, for example, to enzyme mixtures which comprise or consist of the following enzymes:
protease and amylase,
protease and lipase (or lipolytically active enzymes),
protease and cellulase,
protease and mannanase,
amylase, cellulase and lipase (or lipolytically active enzymes),
protease, amylase and lipase (or lipolytically active enzymes),
protease, lipase (or lipolytically active enzymes) and cellulase,
protease, lipase (or lipolytically active enzymes) and mannanase,
protease, amylase, lipase (or lipolytically active enzymes) and mannanase.

Liquid automated dishwashing formulations usually comprise at least one subtilisin protease as disclosed herein in amounts of about 0.10% to 0.25% by weight, more preferably about 0.12% to 0.21% by weight, all relative to the total weight of the detergent formulation.

Liquid automated dishwashing formulations usually comprise at least one alpha-amylase as disclosed herein in amounts of about 0.002% to 0.015% by weight, more preferably 0.004 to 0.01% by weight, all relative to the total weight of the detergent formulation.

Liquid manual dishwashing formulations usually comprise at least one subtilisin protease as disclosed herein in amounts of about 0.005% to 0.15% by weight, more preferably about 0.01% to 0.1% by weight, all relative to the total weight of the detergent formulation.

Liquid manual dishwashing formulations usually comprise at least one alpha-amylase as disclosed herein in amounts of about 0.001% to 0.015% by weight, more preferably 0.002% to 0.015% by weight, all relative to the total weight of the detergent formulation.

Liquid manual dishwashing formulations usually comprise at least one triacylglycerol lipase as disclosed herein in amounts of about 0.001% to 0.005% by weight, more preferably 0.001% to 0.002% by weight, all relative to the total weight of the detergent formulation.

Liquid manual dishwashing formulations usually comprise at least one endoglucanase as disclosed herein in amounts of about 0.001% to 0.01% by weight, more preferably 0.002% to 0.009% by weight, all relative to the total weight of the detergent formulation.

Liquid manual dishwashing formulations usually comprise at least one beta-mannanase as disclosed herein in amounts of about 0.0005% to 0.005% by weight, more preferably 0.0005% to 0.002% by weight, all relative to the total weight of the detergent formulation.

In case of surface cleaning compositions, similar preferences apply.

In case the composition is a laundry composition, this comprises preferably at least one of amylases, lipases, proteases and cellulases. More preferably, it comprises an enzyme mixture. A few exemplary mixtures are:
protease and amylase,
protease and cellulase,
cellulase and amylase,
amylase, cellulase and lipase (or lipolytically active enzymes),
protease, amylase and lipase (or lipolytically active enzymes),
protease, lipase (or lipolytically active enzymes) and cellulase,
protease, lipase (or lipolytically active enzymes) and mannanase,
protease, amylase, lipase (or lipolytically active enzymes) and mannanase.

Liquid laundry formulations usually comprise at least one subtilisin protease as disclosed herein in amounts of about 0.005% to 0.15% by weight, more preferably about 0.01% to 0.1% by weight, all relative to the total weight of the detergent formulation.

Liquid laundry formulations usually comprise at least one alpha-amylase as disclosed herein in amounts of about 0.001% to 0.015% by weight, more preferably 0.002% to 0.015% by weight, all relative to the total weight of the detergent formulation.

Liquid laundry formulations usually comprise at least one triacylglycerol lipase as disclosed herein in amounts of about 0.001% to 0.005% by weight, more preferably 0.001% to 0.002% by weight, all relative to the total weight of the detergent formulation.

Liquid laundry formulations usually comprise at least one endoglucanase as disclosed herein in amounts of about 0.001% to 0.01% by weight, more preferably 0.002% to 0.009% by weight, all relative to the total weight of the detergent formulation.

Liquid laundry formulations usually comprise at least one beta-mannanase as disclosed herein in amounts of about 0.0005% to 0.005% by weight, more preferably 0.0005% to 0.002% by weight, all relative to the total weight of the detergent formulation.

The enzymes may be adsorbed onto carriers in order to protect them from premature decomposition.

If the composition comprises one or more enzymes, it may also comprise enzyme stabilizers (for more details see component (h)).

Enzymes or enzyme packages suitable for such compositions are commercially available. Examples are the Lavergy® brands from BASF.

Sequestrants (f), also termed builders, structural substances, framework substances, complexing agents, chelators, chelating agents or softeners, bind alkaline earth metals and other water-soluble metal salts without precipitating. They help to break up soil, disperse soil components, help to detach soil and in some cases themselves have a washing effect Many of the sequenstrants listed below are multi-functional, meaning that the substances have additional functions, such as a dispersing activity or anti-greying properties.

Suitable sequestrants may be either organic or inorganic in nature. Examples are aluminosilicates, carbonates, phosphates and polyphosphates, polycarboxylic acids, polycarboxylates, hydroxycarboxylic acids, phosphonic acids, e.g. hydroxyalkylphosphonic acids, phosphonates, aminopolycarboxylic acids and salts thereof, and polymeric compounds containing carboxylic acid groups and salts thereof.

Suitable inorganic sequestrants are, for example, crystalline or amorphous aluminosilicates with ion-exchanging properties, such as zeolites. Crystalline silicates suitable as sequestrants are, for example, disilicates or sheet silicates, e.g. 5-Na₂Si₂O₅ or B—Na₂Si₂O₅ (SKS 6 or SKS 7). Suitable inorganic sequestrant substances based on carbonate are carbonates and hydrogencarbonates. These can be used in the form of their alkali metal, alkaline earth metal or ammonium salts. Customary phosphates used as inorganic sequestrants are alkali metal orthophosphates and/or polyphosphates, for example pentasodium triphosphate.

Suitable organic sequestrants are, for example, C₄-C₃₀-di-, -tri- and -tetracarboxylic acids, for example succinic acid, propanetricarboxylic acid, butanetetracarboxylic acid, cyclopentanetetracarboxylic acid, and alkyl- and alkenylsuccinic acids with C₂-C₂₀-alkyl or -alkenyl radicals. Suitable organic sequestrants are also hydroxycarboxylic acids and polyhydroxycarboxylic acids (sugar acids). These include C₄-C₂₀-hydroxycarboxylic acids, for example malic acid, tartaric acid, glutonic acid, mucic acid, lactic acid, glutaric acid, citric acid, tartronic acid, glucoheptonic acid, lactobionic acid, and sucrose mono-, -di- and -tricarboxylic acid. Among these, preference is given to citric acid and salts thereof. Suitable organic sequestrants are also phosphonic acids, for example hydroxyalkylphosphonic acids or aminophosphonic acids, and the salts thereof. These include, for example, phosphonobutanetricarboxylic acid (2-phosphinobutane-1,2,4-tri-carboxylic acid; PBTC), aminotris-methylenephosphonic acid (N[CH₂PO(OH)₂]3), aminotris(methylenephosphonate), sodium salt (ATMP; N[CH₂PO(ONa)₂]₃), ethylenediaminetetra(methylenephosphonic acid) (EDTMPA), hexamethylenediamine(tetramethylenephosphonic acid), hexamethylenediamine(tetramethylenephosphonate), potassium salt (C₁₀H₍₂₈₋ₓ₎N₂KₓO₁₂P₄(x=6)), bis(hexamethylene)triamine(pentamethylene-phosphonic acid) ((HO₂)POCH₂N[(CH₂)₂N[CH₂PO(OH)₂]₂]₂), diethylenetriamine-penta(methylenephosphonic acid) (DTPMP; (HO)₂POCH₂N[CH₂CH₂N[CH₂PO(OH)₂]₂]₂), diethylenetriaminepenta(methylenephosphonate), sodium salt (C₉H₍₂₈₋ₓ₎N₃NaₓO₁₅P₅ (x=7)); tetramethylene-triamine-pentaphosphonic acid, hydroxyethylamine diphosphonic acid, 2-hydroxyethyliminobis(methylenephosphonic acid) (HOCH₂CH₂N[CH₂PO(OH)₂]₂), morpholinomethanediphosphonic acid, 1-hydroxy-C₁—to C₁₀-alkyl-1,1-diphosphonic acids such as 1-hydroxyethane-1,1-diphosphonic acid (HEDP; CH₂C(OH)[PO(OH)₂]₂). Suitable organic sequestrants are moreover polyasparatic acids. Polyaspartic acid include salts of polyaspartic acids. Salt forming cations may be monovalent or multivalent, examples being sodium, potassium, magnesium, calcium, ammonium, and the ammonium salt of mono-, di- and triethanolamine. Such polymers may be co-polymers, in particular of (a) L- or D-aspartic acid (preferably L-aspartic acid), (b) a carboxylic acid and (c) a diamone or an amino alcohol. Such co-polymers generally comprise 70-95 mol % of (a), 5-30 mol % of (b) and 2-20 mol % of (c). The molar ratio of the carboxyl-containing compound (b) to the diamine or amino alcohol (c) is preferably between 5:1 and 1:1.5 or between 3:1 and 1:1.2, and more preferably between 3:1 and 1:1 or 2:1 and 1:1. Suitable organic sequestrants are additionally aminopolycarboxylic acids, such as nitrilotriacetic acid (NTA), nitrilomonoacetic dipropionic acid, nitrilotripropionic acid, β-alaninediacetic acid (β-ADA), ethylenediaminetetraacetic acid (EDTA), diethylenetriaminepentaacetic acid, 1,3-propylenediaminetetraacetic acid, 1,2-propylenediaminetetraacetic acid, N(alkyl)ethylenediaminetriacetic acid, N-(hydroxyalkyl)ethylenediaminetriacetic acid, ethylenediaminetriacetic acid, cyclohexylene-1,2-diaminetetraacetic acid, iminodisuccinic acid, ethylenediaminedisuccinic acid, serinediacetic acid, isoserinediacetic acid, L-asparaginediacetic acid, L-glutaminediacetic acid, methylglycinediacetic acid (MGDA), and the salts of the aforementioned aminopolycarboxylic acids. Suitable organic sequestrants are additionally polymeric compounds containing carboxylic acid groups, such as acrylic acid homopolymers. The term “acrylic acid homopolymer” also comprises polymers in which some or all of the carboxylic acid groups are present in neutralized form. Suitable polymeric compounds containing carboxylic acid groups are also oligomaleic acids. Suitable polymeric compounds containing carboxylic acid groups are also terpolymers of unsaturated C₄-C₈-dicarboxylic acids. Suitable unsaturated C₄-C₈-dicarboxylic acids in this context are, for example, maleic acid (or maleic anhydride), fumaric acid, itaconic acid, aconitic acid, mesaconic acid, methylenemalonic acid and citraconic acid. Suitable polymeric compounds containing carboxylic acid groups are also homopolymers of the monoethylenically unsaturated C₃-C₈-monocarboxylic acids, for example acrylic acid, methacrylic acid, crotonic acid, 2-ethylacrylic acid, 2-phenylacrylic acid, cinnamic acid, vinylacetic acid and sorbic acid, copolymers of dicarboxylic acids, for example of maleic acid and acrylic acid; terpolymers of maleic acid, acrylic acid and a vinyl ester of a C₁-C₃-carboxylic acid; and copolymers of maleic acid with C₂-C₈-olefins.

Defoamer and/or foam stabilizer (g) are for example soaps, paraffins and silicone oils.

Further additives (h) are for example hydrotropic agents, acids, bases, buffering agents, enzyme stabilizers, bleaching agents, corrosion inhibitors, dyes, fragrances, thickeners, activity enhancers different from component (b) and inorganic salts.

Hydrotropic agents are compounds which solubilizes hydrophobic compounds in aqueous solution by means other than micellar solubilization. Similar to surfactants, hydrotropes often (but not necessarily) consist of a hydrophilic part and a hydrophobic part, but in contrast to surfactants the hydrophobic part is generally too small to cause spontaneous self-aggregation. Examples are aromatic sulfonic acid salts, such as the alkali metal, earth alkaline metal or ammonium salts of p-toluenesulfonic acid (e.g. sodium, potassium, calcium or ammonium p-tosylate), of xylene sulfonic acids (e.g. the sodium, potassium, calcium or ammonium salts of o-, m- or p-xylene sulfonates) or of cumene sulfonic acids, generally of p-cumene sulfonic acid (e.g. the sodium, potassium, calcium or ammonium salts of p-cumenesulfonate); adenosine triphosphate (ATP); and urea.

The acids can be inorganic or organic. Suitable inorganic acids are for example sulfuric acid, hydrochloric acid and phosphoric acid, where sulfuric acid is generally preferred.

Suitable organic acids are for example aliphatic, saturated non-substituted C₁-C₆-mono-, di- and tri-carboxylic acids such as formic acid, acetic acid, propanoic acid, oxalic acid, succinic acid and glutaric acid; aliphatic, saturated C₁-C₆-mono-, di- and tri-carboxylic acids carrying one or more OH groups, such as lactic acid, tartric acid and citric acid; aliphatic, unsaturated C₁-C₆-mono-, di- and tri-carboxylic acids such as sorbic acid; aromatic carboxylic acids, such as benzoic acid, salicylic acid and mandelic acid; and sulfonic acids, such as methanesulfonic acid or toluenesulfonic acid. The organic acids mainly serve for adapting the pH of the composition, but some of them, e.g. the di- and tricarboxylic acids, can also act as sequestrants.

Suitable bases are in particular inorganic bases, such as the carbonates mentioned in context with the sequestrant, e.g. sodium or potassium carbonate; further alkali metal and earth alkaline meal hydroxides, such as NaOH or KOH.

Suitable buffering agents are the typical systems, such as hydrogenphosphate/dihydrogenphosphate buffer, carbonate/hydrogencarbonate buffer, acetic acid/acetate buffer or Tris buffer. Moreover, most of the above acids which are weak and the anion of which is not a strong salt also have buffering capacity.

If the composition comprises one or more enzymes, it may also comprise enzyme stabilizers, for example calcium propionate, sodium formate, boric acid or salts thereof, boronic acids and salts thereof, polyols, peptide aldehydes, and/or antioxidants.

Suitable boronic acids are for examples aromatic and heteroaromatic boronic acids, such as benzene boronic acid (BBA; also termed phenylboronic acid (PBA)), 4-formylphenylboronic acid (4-FPBA), 2-FPBA, 3-FPBA, 4-carboxyphenylboronic acid (4-CPBA), 4-(hydroxymethyl)-phenylboronic acid (4-HMPBA), p-tolylboronic acid (p-TBA), (2-acetamidophenyl)-boronic acid, 2-bromophenylboronic acid, 3-bromophenylboronic acid, 4-bromophenylboronic acid, 2-chlorophenylboronic acid, 3-chlorophenylboronic acid, 4-chlorophenylboronic acid, 2,4-dichlorophenylboronic acid, 3,5-dichlorophenylboronic acid, 4-fluorophenylboronic acid, 3-chloro-4-fluorophenylboronic acid, 1,3,5-trimethylphenylboronic acid, 3,5-bis-(trifluoromethyl)-phenylboronic acid, 4-methoxyphenylboronic acid, 4-(methylthio)-phenylboronic acid, 3-aminophenylboronic acid, 4-(trimethylsilyl)-phenylboronic acid, 4,4-biphenyl-diboronic acid, 1-naphthylboronic acid, 2-naphthylboronic acid, 6-hydroxy-2-naphthaleneboronic acid, 9-anthraceneboronic acid, 2-furanylboronic acid, 3-furanylboronic acid, 2-thienylboronic acid, 3-thienylboronic acid, 5-chlorothiopheneboronic acid, 3-bromothiopheneboronic acid, 5-bromothiopheneboronic acid, 5-methyl-2-thienylboronic acid, 4-methylthiopheneboronic acid, dimethylthiopheneboronic acid, 3-methoxy-2-thiopheneboronic acid, 2-benzofuranylboronic acid, 4-dibenzofuranboronic acid, 1-benzothiophene-2-boronic acid, dibenzothiophene boronic acid, 1-thianthrenylboronic acid and 2-thianthrenylboronic acid. Further examples are p-methyl-phenylethylboronic acid, diphenyl boronic acid anhydride and octyl boronic acid. Suitable are also mixtures of two or more different boronic acids. Suitable salts of the above-mentioned boronic acids are for example the alkali metal salts, such as the sodium or potassium salts, the earth alkaline metal salts, such as the magnesium and calcium salts, and ammonium salts.

Suitable polyols are for example polyols containing from 2 to 6 hydroxyl groups, such as ethylene glycol, propylene glycol, 1,2-propanediol, 1,2-butanediol, 1,2-pentanediol, hexyleneglycol, glycerol, sorbitol, mannitol, erythriol, glucose, fructose, and lactose.

Peptide aldehydes are oligopeptides with reduced C-terminus (i.e. in which the C(O)OH group is reduced to an aldehyde [CH(O)] group) Suitable peptide aldehydes are for example di-, tri- or tetrapeptide aldehydes and aldehyde analogues (either of the form B¹—BO—R wherein, R is H, CH₃, CX₃, CHX₂, or CH₂X (where X=halogen), BO is a single amino acid residue including such with an optionally substituted aliphatic or aromatic side chain; and B¹ stands for one or more (e.g. 1, 2 or 3) amino acid(s), optionally comprising an N-terminal protection group, or is a protease inhibitor of the protein type such as RASI, BASI, WASI (bifunctional alpha-amylase/subtilisin inhibitors of rice, barley and wheat) or Cl₂ or SSI.

A suitable bleaching agent is hydrogen peroxide.

Moreover, as mentioned above, some enzymes have bleaching properties.

Dyes can be added to obtain a specific aesthetic appearance, but also be used as shading dyes for reducing or avoiding (auto-)oxidation of components of the composition, especially of unsaturated organic compounds, triggered by UV or visible light (e.g. if the container in which the composition is kept allows transmission of UV or visible light) and/or transition metal ion catalysis (if present). If used as shading dyes, these impart generally a violet or blue color. Shading dyes are particularly useful in laundry compositions, such as laundry detergents or textile softening compositions, where they can help avoiding yellowing of the textiles.

Examples for shading dyes are direct dyes (also known as substantive dyes; water soluble dyes with an affinity for fibres and which are taken up directly; generally azo dyes), e.g. violet 7, direct violet 9, direct violet 11, direct violet 26, direct violet 31, direct violet 35, direct violet 40, direct violet 41, direct violet 51, and direct violet 99; moreover direct violet 66; acid dyes, such as azine dyes, e.g. acid blue 98, acid violet 50, and acid blue 59, more preferably acid violet 50 and acid blue 98; or non-azine dyes, e.g. acid violet 17, acid black 1 and acid blue 29; hydrophobic dyes (dyes which do not contain any charged water solubilising group; generally selected from the groups of disperse and solvent dyes, in particular blue and violet anthraquinone and mono-azo dyes, e.g. solvent violet 13, disperse violet 27 disperse violet 26, disperse violet 28, disperse violet 63 and disperse violet 77; basic dyes (organic dyes which carry a net positive charge and deposit onto cotton), e.g. triarylmethane basic dyes, methane basic dye, anthraquinone basic dyes, basic blue 16, basic blue 65, basic blue 66, basic blue 67, basic blue 71, basic blue 159, basic violet 19, basic violet 35, basic violet 38, basic violet 48; basic blue 3, basic blue 75, basic blue 95, basic blue 122, basic blue 124, basic blue 141; reactive dyes (dyes which contain an organic group capable of reacting with cellulose and linking the dye to cellulose with a covalent bond, and deposit onto cotton), e.g. reactive blue 19, reactive blue 163, reactive blue 182 and reactive blue, reactive blue 96; and dye conjugates (formed by binding direct, acid or basic dyes to polymers or particles via physical forces).

Fragrances can be of natural or synthetic origin; their nature is in general not critical. Just by way of example, natural aromatic substances are, for instance, extracts from blossom (lilies, lavender, roses, jasmine, neroli, ylang-ylang), from stems and leaves (geranium, patchouli, petitgrain), from fruit (aniseed, coriander, carraway, juniper), from fruit peel (bergamot, lemons, oranges), from roots (mace, angelica, celery, cardamom, costus, iris, calmus), from wood (pinewood, sandalwood, guaiacum wood, cedarwood, rosewood), from herbs and grasses (tarragon, lemon grass, sage, thyme), from needles and twigs (spruce, pine, Scots pine, mountain pine), from resins and balsams (galbanum, elemi, benzoin, myrrh, olibanum, opoponax). Animal raw materials also come into consideration, for example civet and castoreum. Also just by way of example, synthetic aromatic substances are, for instance, products of the ester, ether, aidehyde, ketone, alcohol or hydrocarbon type. Aromatic substance compounds of the ester type are, for example, benzyl acetate, phenoxyethyl isobutyrate, p-tert-butylcyclohexyl acetate, linalyl acetate, dimethylbenzylcarbinyl acetate, phenylethyl acetate, linalyl benzoate, benzyl formate, ethylmethylphenyl glycinate, allylcyclohexyl propionate, styrallyl propionate and ben¬zyl salicylate. The ethers include, for example, benzyl ethyl ether; the aldehydes include, for example, the linear alkanals having from 8 to 18 hydrocarbon atoms, citral, citronellal, citronellyl oxyacetaldehyde, cyclamen aldehyde, hydroxycitronellal, lilial and bourgeonal; the ketones include, for example, the ionones, isomethylionone and methyl cedryl ketone; the alcohols include, for example, anethol, citronellol, eugenol, isoeugenol, geraniol, linalool, phenyl ethyl alcohol and terpinol; and the hydrocarbons include mainly the terpenes and balsams. It is preferable, however, to use mixtures of various aromatic substances that together produce an attractive scent. Ethereal oils of relatively low volatility, which are chiefly used as aroma components, are also suitable as perfume oils, e.g. sage oil, chamomile oil, clove oil, melissa oil, oil of cinnamon leaves, lime blossom oil, juniper berry oil, vetiver oil, olibanum oil, galbanum oil, labolanum oil and lavandin oil. Preference is given to the use of bergamot oil, dihydromyrcenol, lilial, lyral, citronellol, phenyl ethyl alcohol, hexyl cinnamaldehyde, geraniol, benzyl acetone, cyclamen aldehyde, linalool, boisambrene forte, ambroxan, indole, hedione, sandelice, lemon oil, tangerine oil, orange oil, allyl amyl glycolate, cyclovertal, lavandin oil, muscatel sage oil, damascone, bourbon geranium oil, cyclohexyl salicylate, vertofix coeur, iso-E-Super, Fixolide NP, evernyl, iraldein gamma, phenylacetic acid, geranyl acetate, benzyl acetate, rose oxide, romillat, irotyl and floramat alone or in admixture with one another.

Further examples are alpha-hexylcinnamaldehyde, 2-phenoxyethyl isobutyrate (Phenirati), dihydromyrcenol (2,6-dimethyl-7-octen-2-ol), methyl dihydrojasmonate (preferably having a cis-isomer content of more than 60 wt. %) (Hedione⁹, Hedione HC⁹), 4,6,6,7,8,8-hexamethyl-1,3,4,6,7,8-hexahydrocyclopenta[g]benzopyran (Galaxolide³), tetrahydrolinalool (3,7-dimethyloctan-3-ol), ethyl linalool, benzyl salicylate, 2-methyl-3-(4-tertbutylphenyl)propanal (Lilial²), cinnamyl alcohol, 4,7-methano-3a,4,5,6,7,7a-hexahydro-5-indenyl acetate and/or 4,7-methano-3a,4,5,6,7,7a hexahydro-6-indenyl acetate (Herbaflorat¹), citronellol, citronellyl acetate, tetrahydrogeraniol, vanillin, linalyl acetate, styralyl acetate (1-phenylethyl acetate), octahydro-2,3,8,8-tetramethyl-2-acetonaphthone and/or 2-acetyl-1,2,3,4,6,7,8-octahydro-2,3,8,8-tetramethylnaphthalene (Iso E Super³), hexyl salicylate, 4-tert-butylcyclohexyl acetate (Oryclone¹), 2-tert-butylcyclohexyl acetate (Agrumex HC¹), alpha-ionone (4-(2,2,6-trimethyl-2-cyclohexen-1-yl)-3-buten-2-one), nalpha-methylionone, alpha-isomethylionone, coumarin, terpinyl acetate, 2-phenylethyl alcohol, 4-(4-hydroxy-4-methylpentyl)-3-cyclohexenecarboxaldehyde (Lyral³), alphaamylcinnamaldehyde, thylene brassylate, (E)- and/or (Z)-3-methylcyclopentadec-5-enone (Muscenone⁹), 15-pentadec-11-enolide and/or 15-pentadec-12-enolide (Globalide¹), 15-cyclopentadecanolide (Macrolide¹), 1-(5,6,7,8-tetrahydro-3,5,5,6,8,8-hexamethyl-2-naphthalenyl)ethanone (Tonalide¹⁰), 2-isobutyl-4-methyltetrahydro-2H-pyran-4-ol (Florol9), 2-ethyl-4-(2,2,3-trimethyl-3-cyclopenten-1-yl)-2-buten-1-ol (Sandolene¹), cis-3-hexenyl acetate, trans-3-hexenyl acetate, trans-2-cis-6-nonadienol, 2,4-dimethyl-3-cyclohexenecarboxaldehyde (Vertocitral¹), 2,4,4,7-tetramethyl-oct-6-en-3-one (Claritone¹), 2,6-dimethyl-5-hepten-1-al (Melonal²), bomeol, 3-(3-isopropylphenyl)butanal (Florhydral2), 2-methyl-3-(3,4-methylenedioxyphenyl)propanal (Helional³), 3-(4-ethylphenyl)-2,2-dimethylpropanal (Florazon¹), 7-methyl-2H-1,5-benzodioxepin-3(4H)one (Calonel9515), 3,3,5-trimethylcyclohexyl acetate (preferably with a content of cis-isomers of 70 wt. %) or more and 2,5,5-trimethyl-1,2,3,4,4a,5,6,7-octahydronaphthalen-2-ol (Ambrinol S¹).

If trade names are specified above, these refer to the following sources:
¹ Trade name of Symrise GmbH, Germany;
² Trade name of Givaudan AG, Switzerland;
³ Trade name of International Flavors & Fragrances Inc., USA;
⁵ Trade name of Danisco Seillans S.A., France;
⁹ Trade name of Firmenich S.A., Switzerland;
¹⁰ Trade name of PFW Aroma Chemicals B.V., The Netherlands.

The fragrances may optionally be incorporated in encapsulated form.

The thickeners serve to impart the desired viscosity to the composition of the invention.

Any known thickener (rheology modifier) is suitable in principle, provided that it does not exert any adverse effect on the efficacy of the composition. Suitable thickeners may either be of natural origin or of synthetic nature.

Thickeners of natural origin are mostly derived from polysaccharides. Examples are xanthan, gellan gum, carob flour, guar flour or gum, carrageenan, agar, tragacanth, gum arabic, alginates, modified starches such as hydroxyethyl starch, starch phosphate esters or starch acetates, dextrins, pectins and cellulose derivatives, such as carboxymethylcellulose, hydroxyethylcellulose, hydrophobically modified hydroxyethyl cellulose, hydroxypropylcellulose, hydroxypropylmethylcellulose, methylcellulose and the like. Further examples are bacterial cellulose, meaning any type of cellulose produced via fermentation of a bacteria of the genus Acetobacter such as CELLULON® (CPKelco U.S.) and including materials referred to as microfibrillated cellulose or reticulated bacterial cellulose; and non-bacterial cellulose, e.g. cellulosic fibers extracted from vegetables, fruits or wood, e.g. Avicel® from FMC, Citri-Fi from Fiberstar or Beta-fib from Cosun.

Thickeners of natural origin are also inorganic thickeners, such as polysilicic acids and clay minerals, for example sheet silicates, and also the silicates mentioned for the builders. More specific examples are listed in the following table. Most are derived from smectite clays and silica derivatives.

Examples of synthetic thickeners are polyacrylic and polymethacrylic compounds, such as (partly) crosslinked homopolymers of acrylic acid, for example homopolymers of acrylic acid which have been crosslinked with an allyl ether of sucrose or pentaerythritol, or with propylene (carbomers), for example the Carbopol® brands from BF Goodrich (e.g. Carbopol® 676, 940, 941, 934 and the like) or the Polygel® brands from 3V Sigma (e.g. Polygel® DA), copolymers of ethylenically unsaturated mono- or dicarboxylic acids, for example terpolymers of acrylic acid, methacrylic acid or maleic acid with methyl acrylate or ethyl acrylate and a (meth)acrylate which derives from long-chain ethoxylated alcohols, for example the Acusol® brands from Rohm & Haas (e.g. Acusol® 820 or 1206A), copolymers of two or more monomers which are selected from acrylic acid, methacrylic acid and the C₁-C₄-alkyl esters thereof, for example co-polymers of methacrylic acid, butyl acrylate and methyl methacrylate or of butyl acrylate and methyl methacrylate, for example the Aculyn® and Acusol® brands from Rohm & Haas (e.g. Aculyn®22, 28 or 33 and Acusol® 810, 823 and 830), or crosslinked high molecular weight acrylic acid copolymers, for example copolymers of C₁₀-C₃₀-alkyl acrylates with one or more comonomers selected from acrylic acid, methacrylic acid and the C₁-C₄-alkyl esters thereof, said copolymers having been crosslinked with an allyl ether of sucrose or pentaerythritol (e.g. Carbopol® ETD 2623, Carbopol®1382 or Carbopol® AQUA 30 from Rohm & Haas).

Suitable thickeners are moreover phospholipids, such as alkylated phosphatidyl choline, phosphobetaines or alkyl phosphate quaternary compounds.

Examples of synthetic thickeners are also reaction products of maleic acid polymers with ethoxylated long-chain alcohols, for example the Surfonic L series from Texaco Chemical Co. or Gantrez AN-119 from ISP; polyethylene glycols, polyamides, polyimines and polycarboxylic acids.

Examples of synthetic thickeners are moreover dibenzylidene polyol acetal derivatives (DBPA derivative). These may comprise a dibenzylidene sorbitol acetal derivative (DBS). Said DBS derivative may be selected from the group consisting of: 1,3:2,4-dibenzylidene sorbitol; 1,3:2,4-di(p-methylbenzylidene) sorbitol; 1,3:2,4-di(p-chlorobenzylidene) sorbitol; 1,3:2,4-di(2,4-dimethyldibenzylidene) sorbitol; 1,3:2,4-di (p-ethyl-benzylidene) sorbitol; 1,3:2,4-di(3,4-dimethyldibenzylidene) sorbitol; and mixtures thereof.

Suitable thickeners are moreover di-amido gellants, e.g. selected from those having a molecular weight from about 150 g/mol to about 1,500 g/mol, or even from about 500 g/mol to about 900 g/mol. Such di-amido gellants may comprise at least two nitrogen atoms, wherein at least two of said nitrogen atoms form amido functional substitution groups. The amido groups may be different or identical. Examples are compounds of the formula R^{a}—C(═O)NH-L-C(═O)R^{h}, where R^{a} and R^{a} are amino functional endgroups or amido functional end groups, and L is a linking moiety of molecular weight from 14 to 500 g/mol. R^{a} and R^{b} may comprise a pH-tunable group, wherein the pH-tunable amido-gellant may have a pKa of from about 1 to about 30, or even from about 2 to about 10. The pH tunable group may comprise a pyridine. L may comprise a carbon chain comprising between 2 and 20 carbon atoms. L may comprise a pH-tunable group. The pH-tunable group may be a secondary amine.

Examples of synthetic thickeners are also non-polymeric crystalline, hydroxyl functional structurants. Said compound may comprise a crystallizable glyceride which can be pre-emulsified to aid dispersion into the final liquid detergent formulation. The crystallizable glycerides may comprise hydrogenated castor oil or “HCO” or derivatives thereof, provided that it is capable of crystallizing in the liquid formulation.

Also suitable are mixtures of the abovementioned thickeners.

Suitable activity enhancers different from component (b) are in particular PEI.

PEI are polymers of ethylenediamine and can be characterized by repeating groups of the empirical formula —[CH₂—CH₂—NH]ₙ— wherein n ranges from approximately from 10 to 100,000, e.g. from 10 to 15000. PEI can be linear or branched (branched forms are not correctly reflected in the above formula; nevertheless the formula should also symbolize branched forms), where branching can result in dendrimers, star-like polymers, hyperbranched polymers and other branched forms. Branched polyethylenimines can be characterized by their degree of branching (DB). DB may be determined, for example, by ¹³C-NMR spectrometry and is defined as follows:

$$DB = D + T / D + T + L$$

wherein D stands for the fraction of tertiary amino groups, L (linear) stands for the fraction of secondary amino groups, and T (terminal) stands for the fraction of primary amino groups. Preferably, DB ranges from 0.1 to 0.95, more preferably from 0.25 to 0.90, in particular from 0.30 to 0.80, and specifically from 0.5-0.8.

Preferably, the PEIs used in the present compositions have weight average molecular weight M_{w} of from 500 to 1,000,000 g/mol, more preferably from 600 to 75,000 g/mol, and in particular from 800 to 25000 g/mol, as determined by gel permeation chromatography (GPC with PEG or PMMA standard; specifically with multi angle light scattering (MALS) detector of the intermediate respective polyalkylenimine, with 1.5% by weight aqueous formic acid as eluent and cross-linked poly-hydroxyethyl methacrylate as stationary phase).

In a specific embodiment, the PEIs used in the present compositions are grafted with ethylene oxide (EO) and/or propylene oxide (PO). Typically, the PEI is grafted with 5 to 100 mol of alkylene oxide per mol of PEI.

If present, the PEI is typically contained in the homecare or I&I composition in an amount of from 0.001 to 10% by weight, preferably from 0.001 to 1% by weight, relative to the total weight of the composition.

Suitable PEIs are commercially available, e.g. under the Lupasol® and Sokolan® HP brands from BASF.

Suitable inorganic salts are for example sodium chloride and calcium chloride.

In a particular embodiment, the composition of the invention is a dishwashing composition. Dishwashing compositions preferably comprise:
(a) 0.001 to 7% by weight, relative to the total weight of the composition, of at least one antimicrobial agent as defined above;
(b) 0.001 to 7% by weight, relative to the total weight of the composition, of a carboxamide compound of the formula (I) or a mixture of different carboxamide compounds of the formula (I) as defined above;
(c) 0.1 to 40% by weight, relative to the total weight of the composition, of at least one surfactant [different from component (b)];
(d) 0 to 15% by weight, relative to the total weight of the composition, of at least one organic solvent, preferably as defined above;
(e) 0 to 6% by weight, relative to the total weight of the composition, of at least one enzyme;
(f) 0 to 20% by weight, relative to the total weight of the composition, of at least one sequestrant;
(g) 0 to 8% by weight, relative to the total weight of the composition, of at least one defoamer and/or foam stabilizer;
(h) 0 to 50% by weight, relative to the total weight of the composition, of at least one further additive; and
(i) 10 to 99.898% by weight, relative to the total weight of the composition, of water;
   where components (a) to (i) add to 100% by weight.

Such dishwashing compositions are in liquid or gel form and are suitable both for machine washing as well as for manual dishwashing. As a matter of course, manual dishwashing compositions have to be adapted so as not to present any hazard for the user.

For instance, the amount of optionally present acids and/or bases is such that the resulting pH does not harm the user's skin.

Suitable and preferred components (a) to (h) are those listed above.

Dishwashing compositions may further comprise as component (h) anti-greying polymers and scale inhibitor or scale dispersing agents.

More particularly, the composition of the invention is a dishwashing composition comprising:
(a) 0.001 to 5% by weight, relative to the total weight of the composition, of at least one antimicrobial agent as defined above;
(b) 0.01 to 7% by weight, relative to the total weight of the composition, of a carboxamide compound of the formula (I) or a mixture of different carboxamide compounds of the formula (I) as defined above;
(c) 5 to 25% by weight, relative to the total weight of the composition, of one or more surfactants [different from component (b)];
(d) 0 to 5% by weight, relative to the total weight of the composition, of at least one organic solvent, preferably as defined above;
(e) 0 to 6% by weight, relative to the total weight of the composition, of at least one enzyme;
(f) 0 to 20% by weight, relative to the total weight of the composition, of at least one sequestrant;
(g) 0 to 8% by weight, relative to the total weight of the composition, of at least one defoamer and/or foam stabilizer;
(h) 0 to 50% by weight, relative to the total weight of the composition, of at least one further additive; and
(i) 10 to 94.989% by weight, relative to the total weight of the composition, of water;
   where components (a) to (i) add to 100% by weight.

In a specific embodiment, the antimicrobial agent (a) is 2-phenoxyethanol, and this is contained in an amount of from 0.1 to 5% by weight, e.g. 0.1 to 2% by weight, relative to the total weight of the composition; and the carboxamide compound (b) is contained in an amount of from 0.1 to 7% by weight.

In another particular embodiment, the composition of the invention is a laundry composition. Laundry compositions preferably comprise:
(a) 0.001 to 7% by weight, relative to the total weight of the composition, of at least one antimicrobial agent as defined above;
(b) 0.001 to 7% by weight, relative to the total weight of the composition, of a carboxamide compound of the formula (I) or a mixture of different carboxamide compounds of the formula (I) as defined above;
(c) 0.1 to 40% by weight, relative to the total weight of the composition, of at least one surfactant [different from component (b)];
(d) 0 to 15% by weight, relative to the total weight of the composition, of at least one organic solvent, preferably as defined above;
(e) 0 to 6% by weight, relative to the total weight of the composition, of at least one enzyme;
(f) 0 to 20% by weight, relative to the total weight of the composition, of at least one sequestrant;
(g) 0 to 8% by weight, relative to the total weight of the composition, of at least one defoamer and/or foam stabilizer;
(h) 0 to 50% by weight, relative to the total weight of the composition, of at least one further additive; and
(i) 10 to 99.898% by weight, relative to the total weight of the composition, of water;
   where components (a) to (i) add to 100% by weight.

Such laundry compositions are in liquid or gel form and are suitable both for machine washing as well as for manual laundry washing. As a matter of course, manual laundry compositions have to be adapted so as not to present any hazard for the user. For instance, the amount of optionally present acids and/or bases is such that the resulting pH does not harm the user's skin.

Suitable and preferred components (a) to (h) are those listed above.

Examples for laundry compositions are laundry detergents, fabric softeners, rinsing compositions, bleacher compositions, and stain remover compositions.

Laundry detergents may further comprise as component (h) dye transfer inhibitors, anti-greying polymers, soil release polymers, anti-redeposition agents, anti-shrinking agents, anti-wrinkle agents, ironing aids, skin benefit agents, antistatic agents, processing aids, such as electrolyts, pearlisers, opacifiers, sunscreens, and/or antioxidants.

The terms anti-greying and anti-redeposition agents are often used interchangeably.

Suitable examples for such agents are the aforementioned PEIs in grafted (alkoxylated) or ungrafted form, other alkyleneimine polymers, such as polypropyleneimine (PPI), also in grafted or ungrafted form, further ethoxylated hexamethylene diamine polymers which are quaternized and—optionally but preferably—sulfated, and graft polymer GP comprising as a graft base a polyether and as grafted side chains copolymers comprising at least one comonomer (CM) as described below.

The ethoxylated hexamethylene diamine polymers preferably contain in average 10 to 50, more preferably 15 to 40 and even more preferably 20 to 30 EO (ethoxylate) groups per NH group, resulting in an average molecular weight M_{w} in the range from 2,000 to 10,000 g/mol, more preferably 3,000-8,000, most preferably 4,000-6,000. In a preferred embodiment the ethoxylated hexamethylene diamine is quaternized and also sulfated, preferably bearing 2 cationic ammonium groups and 2 anionic sulfate groups.

In the graft polymer GP, the side chains comprise at least one comonomer (CM) selected from

CH₂═CH—O—C(O)—R^{a} (CM-Ia)

CH₂═CH—CH₂—O—C(O)—R^{a} (CM-Ib)

CH₂═CZ—CO—OR^{b} (CM-Ic)
wherein R^{a} is selected from C₁-C₂₁-alkyl, for example methyl, n-propyl, n-pentyl, n-heptyl, n-nonyl, iso-nonyl, n-undecyl, n-tridecyl, n-pentadecyl, n-heptadecyl, or n-nonadecyl, R^{b} is selected from C₂-C₂₀-alkyl, preferably with an even number of carbon atoms, for example ethyl, n- and iso propyl, n-hexyl, isohexyl, sec-hexyl, n-heptyl, n-octyl, 2-ethylhexyl, n-nonyl, n-decyl or isodecyl, n-C₁₂H₂₅, n-C₁₄H₂₉, n-C₁₆H₃₃ or n-C₁₈H₃₇, and Z is selected from hydrogen and methyl, hydrogen bring preferred.

In the graft polymer GP, the polyethers bear at least 5 ether groups per mole and—if at all—only hydroxyl groups, for example one, two or three hydroxyl groups per molecule. Such hydroxyl groups may be primary or secondary hydroxyl groups, primary hydroxyl groups being preferred. The polyethers are preferably polyethylene glycols, for example with an average molecular weight Mₙ in the range of from 500 to 25,000 g/mol, preferably 1,000 to 15,000 g/mole and even more preferably 1,500 to 10,000 g/mol, e.g. 1,500 to 4,000 g/mol or 4,000 to 6,000 g/mol or 5,000 to 8,000 g/mol. Alternatively, the polyethers are preferably polypropylene glycols, for example with an average molecular weight Mₙ in the range of from 500 to 20,000 g/mol, preferably 2,000 to 10,000 g/mol and even more preferably 4,000 to 9,000 g/mol Alternatively, the polyethers are copolymers of ethylene glycol and propylene glycol units, for example random co-polymers and preferably block copolymers, for example di-block copolymers and tri-block copolymers. Preferably, copolymers of ethylene glycol and propylene glycol are block copolymers. The polyethylene glycols, polypropylene glycols and EO-PO block co-polymers can be non-capped or end-capped with C₁-C₂₀-alkyl or C₃-C₃₀-2-hydroxyalkyl.

Other examples for anti-greying agents are carboxymethyl cellulose (CMC), ether sulfonic acid salts of starch, ether sulfonic acid salts of cellulose, acidic sulfuric acid ester salts of cellulose, acidic sulfuric acid ester salts of starch, methyl cellulose, ethyl cellulose, hydroxyethyl cellulose, hydroxypropyl cellulose methyl hydroxyethyl cellulose, methyl carboxymethyl cellulose, ethyl hydroxyethyl cellulose and mixtures thereof.

Further examples for anti-greying agents are polyalkylene oxide polymers (ethylene oxide, propylene oxide and/or butylene oxide polymers) grafted with methyl acrylate, ethyl acrylate, methyl methacrylate and/or ethyl methacrylate.

In fabric softeners, at least a part of the detergent (c) described above is replaced by a softening agent.

Suitable softening agents are quaternary ammonium salts, especially quats or ester quats. Quats are compounds [NR¹R²R³R⁴]⁺X⁻, wherein R¹, R², R³ and R⁴ are alkyl groups, where at least one, generally two is/are long-chained alkyl and the others are generally methyl or ethyl, and X—is a counter anion, such as chloride. Examples are DSDMAC (distearyl dimethyl ammonium chloride, also termed DODMAC (dioctadecyl dimethyl ammonium chloride)), TDMAC (ditallow di-methyl ammonium chloride), DHTDMAC (di(hydrogenated tallow alkyl) dimethyl ammonium chloride) and DDAC-C10 (didecyldimethylammonium chloride. Esterquats are derived from alkanolamines in which at least one alkanol group is esterified with a fatty acid. Typically, esterquats are derived from methyl-triethanol-ammonium salts, where 1, 2 or 3 of the OH groups are esterified with a fatty acid, and from dimethyl-diethanol-ammonium salts, where 1 or 2 OH groups are esterified with a fatty acid. Preference is given to esterquats.

More particularly, the composition of the invention is a laundry composition comprising:
(a) 0.001 to 5% by weight, relative to the total weight of the composition, of at least one antimicrobial agent as defined above;
(b) 0.01 to 7% by weight, relative to the total weight of the composition, of a carboxamide compound of the formula (I) or a mixture of different carboxamide compounds of the formula (I) as defined above;
(c) 4 to 30% by weight, relative to the total weight of the composition, of at least one surfactant [different from component (b)];
(d) 0 to 5% by weight, relative to the total weight of the composition, of at least one organic solvent, preferably as defined above;
(e) 0 to 6% by weight, relative to the total weight of the composition, of at least one enzyme;
(f) 0 to 20% by weight, relative to the total weight of the composition, of at least one sequestrant;
(g) 0 to 8% by weight, relative to the total weight of the composition, of at least one defoamer and/or foam stabilizer;
(h) 0 to 50% by weight, relative to the total weight of the composition, of at least one further additive; and
(i) 10 to 95.989% by weight, relative to the total weight of the composition, of water;
   where components (a) to (i) add to 100% by weight.

In a specific embodiment, the antimicrobial agent (a) is 2-phenoxyethanol, and this is contained in an amount of from 0.1 to 5% by weight, e.g. 0.1 to 2% by weight, relative to the total weight of the composition; and the carboxamide compound (b) is contained in an amount of from 0.1 to 7% by weight.

In a particular embodiment, the composition of the invention is a surface cleaning composition. Surface cleaning compositions preferably comprise:
(a) 0.001 to 7% by weight, relative to the total weight of the composition, of at least one antimicrobial agent as defined above;
(b) 0.001 to 7% by weight, relative to the total weight of the composition, of a carboxamide compound of the formula (I) or a mixture of different carboxamide compounds of the formula (I) as defined above;
(c) 0.1 to 40% by weight, relative to the total weight of the composition, of at least one surfactant [different from component (b)];
(d) 0 to 15% by weight, relative to the total weight of the composition, of at least one organic solvent, preferably as defined above;
(e) 0 to 6% by weight, relative to the total weight of the composition, of at least one enzyme;
(f) 0 to 20% by weight, relative to the total weight of the composition, of at least one sequestrant;
(g) 0 to 8% by weight, relative to the total weight of the composition, of at least one defoamer and/or foam stabilizer;
(h) 0 to 50% by weight, relative to the total weight of the composition, of at least one further additive; and
(i) 10 to 99.898% by weight, relative to the total weight of the composition, of water;
   where components (a) to (i) add to 100% by weight.

Such surface cleaning compositions are in liquid or gel form and are suitable for manual use. As a matter of course, surface cleaning compositions for household use have to be adapted so as not to present any hazard for the user. For instance, the amount of optionally present acids and/or bases is such that the resulting pH does not harm the user's skin.

Suitable and preferred components (a) to (h) are those listed above.

Surface cleaning compositions may further comprise as component (h) anti-greying polymers and scale inhibitor or scale dispersing agents.

More particularly, the composition of the invention is a surface cleaning composition.

Surface cleaning compositions preferably comprise:
(a) 0.001 to 5% by weight, relative to the total weight of the composition, of at least one antimicrobial agent as defined above;
(b) 0.001 to 5% by weight, relative to the total weight of the composition, of a carboxamide compound of the formula (I) or a mixture of different carboxamide compounds of the formula (I) as defined above;
(c) 0.1 to 30% by weight, relative to the total weight of the composition, of at least one surfactant [different from component (b)];
(d) 0 to 8% by weight, relative to the total weight of the composition, of at least one organic solvent, preferably as defined above;
(e) 0 to 3% by weight, relative to the total weight of the composition, of at least one enzyme;
(f) 0 to 10% by weight, relative to the total weight of the composition, of at least one sequestrant;
(g) 0 to 4% by weight, relative to the total weight of the composition, of at least one defoamer and/or foam stabilizer;
(h) 0 to 25% by weight, relative to the total weight of the composition, of at least one further additive; and
(i) 10 to 99.898% by weight, relative to the total weight of the composition, of water;
   where components (a) to (i) add to 100% by weight.

Even more particularly, the composition of the invention is a surface cleaning composition comprising:
(a) 0.001 to 5% by weight, relative to the total weight of the composition, of at least one antimicrobial agent as defined above;
(b) 0.01 to 5% by weight, relative to the total weight of the composition, of a carboxamide compound of the formula (I) or a mixture of different carboxamide compounds of the formula (I) as defined above;
(c) 0.1 to 25% by weight, relative to the total weight of the composition, of at least one surfactant [different from component (b)];
(d) 0 to 5% by weight, relative to the total weight of the composition, of at least one organic solvent, preferably as defined above;
(e) 0 to 3% by weight, relative to the total weight of the composition, of at least one enzyme;
(f) 0 to 10% by weight, relative to the total weight of the composition, of at least one sequestrant;
(g) 0 to 4% by weight, relative to the total weight of the composition, of at least one defoamer and/or foam stabilizer;
(h) 0 to 25% by weight, relative to the total weight of the composition, of at least one further additive; and
(i) 10 to 99.739% by weight, relative to the total weight of the composition, of water;
   where components (a) to (i) add to 100% by weight.

In a specific embodiment, the antimicrobial agent (a) is 2-phenoxyethanol, and this is contained in an amount of from 0.1 to 5% by weight, e.g. 0.1 to 2% by weight, relative to the total weight of the composition; and the carboxamide compound (b) is contained in an amount of from 0.1 to 7% by weight.

In a particular embodiment, the homecare or I&I composition is a refill concentrate.

Refill concentrates contain all ingredients of the final ready-to-use product, but for water which is either essentially absent (“essentially” taking account of the fact that some of the ingredients may contain some residual water) or contained in amounts far below those of the final ready-to-use product. The end user has just to fill the refill concentrate into a suitable container and add the indicated amount of water.

Such refill concentrates preferably comprise:
(a) 0.01 to 10% by weight, relative to the total weight of the composition, of at least one antimicrobial agent as defined above;
(b) 0.01 to 10% by weight, relative to the total weight of the composition, of a carboxamide compound of the formula (I) or a mixture of different carboxamide compounds of the formula (I) as defined above;
(c) 1 to 60% by weight, relative to the total weight of the composition, of at least one surfactant [different from component (b)];
(d) 0 to 30% by weight, relative to the total weight of the composition, of at least one organic solvent [different from component (b) (and of course also from said antimicrobial agent)];
(e) 0 to 10% by weight, relative to the total weight of the composition, of at least one enzyme;
(f) 0 to 10% by weight, relative to the total weight of the composition, of at least one sequestrant;
(g) 0 to 10% by weight, relative to the total weight of the composition, of at least one defoamer and/or foam stabilizer;
(h) 0 to 50% by weight, relative to the total weight of the composition, of at least one further additive; and
(i) 0 to 20% by weight, relative to the total weight of the composition, of water;
   where components (a) to (i) add to 100% by weight.

### Crop Protection Compositions

The combination of the antimicrobial agent and the compound (I) in crop protection compositions generally serves for preserving said composition. Crop protection compositions needing preservation generally contain water.

Examples for such compositions are e. g. solutions, emulsions, suspensions, pastes, capsules, and mixtures thereof. Examples for composition types are suspensions (e.g. SC, OD, FS), emulsifiable concentrates (e.g. EC), emul¬sions (e.g. EW, EO, ES, ME), capsules (e.g. CS, ZC), pastes, as well as gel formulations for the treatment of plant propagation materials such as seeds (e.g. GF). These and further compositions types are defined in the “Catalogue of pesticide formulation types and international coding system”, Technical Monograph No. 2, 6th Ed. May 2008, CropLife International. The compositions are prepared in a known manner, such as described by Mollet and Grubemann, Formulation technology, Wiley VCH, Weinheim, 2001; or Knowles, New developments in crop protection product formulation, Agrow Reports DS243, T&F Informa, London, 2005.

Suitable auxiliaries are solvents, liquid carriers, surfactants, dispersants, emulsifiers, wetters, adjuvants, solubilizers, penetration enhancers, protective colloids, adhesion agents, thickeners, humectants, repellents, attractants, feeding stimulants, compatibilizers, anti-freezing agents, anti-foaming agents, colorants, tackifiers and binders.

Suitable solvents and liquid carriers are water and organic solvents, such as mineral oil fractions of medium to high boiling point, e.g. kerosene, diesel oil; oils of vegetable or animal origin; aliphatic, cyclic and aromatic hydrocarbons, e. g. toluene, paraffin, tetrahydronaphthalene, alkylated naphthalenes; alcohols, e.g. ethanol, propanol, butanol, benzylalcohol, cyclo, hexanol; glycols; DMSO; ketones, e.g. cyclo, hexanone; esters, e.g. lactates, carbonates, fatty acid esters, gamma-butyrolactone; fatty acids; phosphonates; amines; amides different from compounds (I), e.g. fatty acid di¬methylamides different from compounds (I); and mixtures thereof.

Suitable surfactants are surface-active compounds, such as anionic, cationic, nonionic and amphoteric surfactants, block polymers, polyelectrolytes, and mixtures there¬of.

Such surfactants can be used as emulsifier, dispersant, solubilizer, wetter, penetration enhancer, protective colloid, or adjuvant. Examples of surfactants are listed in McCutcheon's, Vol. 1: Emulsifiers & Detergents, McCutcheon's Directories, Glen Rock, USA, 2008 (International Ed. or North American Ed.).

Suitable anionic surfactants are alkali, alkaline earth or ammonium salts of sulf¬onates, sulfates, phosphates, carboxylates, and mixtures thereof. Examples of sulf¬onates are alkylarylsulfonates, diphenylsulfonates, alpha-olefin sulfonates, lignine sulfonates, sulfonates of fatty acids and oils, sulfonates of ethoxylated alkylphenols, sulfonates of alkoxylated arylphenols, sulfonates of condensed naphthalenes, sulf¬onates of dodecyl- and tridecylbenzenes, sulfonates of naphthalenes and alkyl¬naphtha¬lenes, sulfosuccinates or sulfosuccinamates. Examples of sulfates are sulfates of fatty acids and oils, of ethoxylated alkylphenols, of alcohols, of ethoxylated alcohols, or of fatty acid esters. Examples of phosphates are phosphate esters. Examples of carboxy¬lates are alkyl carboxylates, and carboxylated alcohol or alkylphenol ethoxylates.

Suitable nonionic surfactants are alkoxylates, N-substituted fatty acid amides different from the present compounds (I), amine oxides, esters, sugar-based surfactants, polymeric surfactants, and mixtures thereof. Examples of alkoxylates are compounds such as alcohols, alkylphenols, amines, amides, arylphenols, fatty acids or fatty acid esters which have been alkoxylated with 1 to 50 equivalents. Ethylene oxide and/or propylene oxide may be employed for the alkoxylation, preferably ethylene oxide. Examples of N-substituted fatty acid amides different from compounds (I) are fatty acid glucamides or fatty acid alkanolamides. Examples of esters are fatty acid esters, glycerol esters or monoglycerides. Examples of sugar-based surfactants are sorbitans, ethoxylated sorbitans, sucrose and glucose esters or alkylpolyglucosides. Examples of polymeric surfactants are home- or copolymers of vinylpyrrolidone, vinylalcohols, or vinylacetate. Suitable cationic surfactants are quaternary surfactants, for example quaternary am¬monium compounds with one or two hydrophobic groups, or salts of long-chain primary amines. Suitable amphoteric surfactants are alkylbetains and imidazolines. Suitable block polymers are block polymers of the A-B or A-B-A type comprising blocks of poly¬ethylene oxide and polypropylene oxide, or of the A-B-C type comprising alkanol, poly¬ethylene oxide and polypropylene oxide. Suitable polyelectrolytes are polyacids or polybases. Examples of polyacids are alkali salts of polyacrylic acid or poly-acid comb polymers. Examples of polybases are polyvinylamines or polyethyleneamines.

Suitable adjuvants are compounds which have a neglectable or even no pesticidal activity themselves, and which improve the biological performance of the polymeric, ionic compound comprising imidazolium groups on the target. Examples are surfactants, mineral or vegetable oils, and other auxilaries. Further examples are listed by Knowles, Adjuvants and additives, Agrow Reports DS256, T&F Informa UK, 2006, chapter 5. Suitable thickeners are polysaccharides (e.g. xanthan gum, carboxymethylcellu¬lose), anorganic clays (organically modified or unmodified), polycarboxylates, and silicates. Suitable bactericides are bronopol and isothiazolinone derivatives such as alkyliso¬thiazolinones and benzisothiazolinones.

Suitable anti-freezing agents are ethylene glycol, propylene glycol, urea and glycerin. Suitable anti-foaming agents are silicones, long chain alcohols, and salts of fatty acids. Suitable colorants (e.g. in red, blue, or green) are pigments of low water solubility and water-soluble dyes. Examples are inorganic colorants (e.g. iron oxide, titan oxide, iron hexacyanoferrate) and organic colorants (e.g. alizarin-, azo- and phthalocyanine colorants). Suitable tackifiers or binders are polyvinylpyrrolidons, polyvinylacetates, polyvinyl alcohols, polyacrylates, biological or synthetic waxes, and cellulose ethers.

The crop protection compositions contain of course at least one active agent suitable for combating harmful microorganisms, invertebrate pests or weeds, e.g. at least one fungicide, insecticide, acaricide, nematicide, moluscicide and/or herbicide; or for regulating the growth of plants.

Examples of fungicidally active substances comprise:
acylalanines, such as benalaxyl, metalaxyl, ofurace or oxadixyl;
amine derivatives, such as aldimorph, dodine, dodemorph, fenpropimorph, fenpropidin, guazatine, iminoctadine, spiroxamine or tridemorph;
anilinopyrimidines, such as pyrimethanil, mepanipyrim or cyprodinil;
antibiotics, such as cycloheximide, griseofulvin, kasugamycin, natamycin, polyoxin and streptomycin;
azoles, such as bitertanol, bromoconazole, cyproconazole, difenoconazole, diniconazole, epoxiconazole, fenbuconazole, fluquinconazole, flusilazole, flutriafol, hexaconazole, imazalil, ipconazole, metconazole, myclobutanil, penconazole, propiconazole, prochloraz, prothioconazole, tebuconazole, tetraconazole, triadimefon, triadimenol, triflumizole or triticonazole;
2-methoxybenzophenones, such as those disclosed in EP-A 897 904 by the general formula (I), e.g. metrafenone;
dicarboximides, such as iprodione, myclozolin, procymidone or vinclozolin;
dithiocarbamates, such as ferbam, nabam, maneb, mancozeb, metam, metiram, propineb, polycarbamate, thiram, ziram or zineb;
heterocyclic compounds, such as anilazine, benomyl, boscalid, carbendazim, carboxin, oxycarboxin, cyazofamid, dazomet, dithianon, famoxadone, fenamidone, fenarimol, fuberidazole, flutolanil, furametpyr, isoprothiolane, mepronil, nuarimol, picobenzamid, probenazole, proquinazid, pyrifenox, pyroquilon, quinoxyfen, silthiofam, thiabendazole, thifluzamide, thiophanate-methyl, tiadinil, tricyclazole or triforine;
nitrophenyl derivatives, such as binapacryl, dinocap, dinobuton or nitrothal-isopropyl;
phenylpyrroles, such as fenpiclonil or fludioxonil;
unclassified fungicides, such as acibenzolar-S-methyl, benthiavalicarb, carpropamid, chlorothalonil, cyflufenamid, cymoxanil, diclomezine, diclocymet, diethofencarb, edifenphos, ethaboxam, fenhexamid, fentin acetate, fenoxanil, ferimzone, fluazinam, fosetyl, fosetyl-aluminum, iprovalicarb, hexachlorobenzene, metrafenone, pencycuron, propamocarb, phthalide, toiclofos-methyl, quintozene or zoxamide;
strobilurins, such as those disclosed in WO 03/075663 by the general formula (I), for example azoxystrobin, dimoxystrobin, fluoxastrobin, kresoxim-methyl, metominostrobin, orysastrobin, picoxystrobin, pyraclostrobin and trifloxystrobin;
sulfenic acid derivatives, such as captafol, captan, dichlofluanid, folpet or tolytfluanid;
cinnamamides and analogous compounds, such as dimethomorph, flumetover or flumorph;
6-aryl-[1,2,4]triazolo[1,5-a]pyrimidines, such as those disclosed, e.g., in WO 98/46608, WO 99/41255 or WO 03/004465, in each case by the general formula (I);
amide fungicides, such as cyflufenamid and (Z)—N-[α-(cyclopropylmethoxyimino)-2,3-difluoro-6-(difluoromethoxy)benzyl]-2-phenylacetamide.

Examples of herbicides comprise:
1,3,4-thiadiazoles, such as buthidazole and cyprazole;
amides, such as allidochlor, benzoylprop-ethyl, bromobutide, chlorthiamid, dimepiperate, dimethenamid, diphenamid, etobenzanid, flamprop-methyl, fosamine, isoxaben, metazachlor, monalide, naptalam, pronamide or propanil;
aminophosphoric acids, such as bilanafos, buminafos, glufosinate-ammonium, glyphosate or sulfosate;
aminotriazoles, such as amitrole, or anilides, such as anilofos or mefenacet;
aryloxyalkanoic acid, such as 2,4-D, 2,4-DB, clomeprop, dichlorprop, dichlorprop-P, fenoprop, fluroxypyr, MCPA, MCPB, mecoprop, mecoprop-P, napropamide, naproanilide or triclopyr;
benzoic acids, such as chloramben or dicamba;
benzothiadiazinones, such as bentazon;
bleachers, such as clomazone, diflufenican, fluorochloridone, flupoxam, fluridone, pyrazolate or sulcotrione;
carbamates, such as carbetamide, clorbufam, chlorpropham, desmedipham, phenmedipham or vernolate;
quinolinecarboxylic acids, such as quinclorac or quinmerac;
dichloropropionic acids, such as dalapon;
dihydrobenzofurans, such as ethofumesate;
dhydrofuran-3-ones, such as flurtamone;
dinitroanilines, such as benefin, butralin, dinitramine, ethalfluralin, fluchloralin, isopropalin, nitralin, oryzalin, pendimethalin, prodiamine, profluralin, trifluralin;
dinitrophenols, such as bromofenoxim, dinoseb, dinoseb acetate, dinoterb, DNOC or minoterb acetate;
diphenyl ethers, such as acifluorfen-sodium, aclonifen, bifenox, chlomitrofen, difenoxuron, ethoxyfen, fluorodifen, fluoroglycofen-ethyl, fomesafen, furyloxyfen, lactofen, nitrofen, nitrofluorfen or oxyfluorfen;
dipyridyls, such as cyperquat, difenzoquat metilsulfate, diquat or paraquat dichloride;
imidazoles, such as isocarbamid;
imidazolinones, such as imazamethapyr, imazapyr, imazaquin, imazethabenzmethyl, imazethapyr, imazapic or imazamox;
oxadiazoles, such as methazole, oxadiargyl or oxadiazone;
oxiranes, such as tridiphane;
phenols, such as bromoxynil or ioxynil;
phenoxyphenoxypropionic acid esters, such as clodinafop, cyhalofop-butyl, diclofop-methyl, fenoxaprop-ethyl, fenoxaprop-P-ethyl, fenthiaprop-ethyl, fluazifop-butyl, fluazifop-P-butyl, haloxyfop-ethoxyethyl, haloxyfop-methyl, haloxyfop-P-methyl, isoxapyrifop, propaquizafop, quizalofop-ethyl, quizalofop-P-ethyl or quizalofop-P-tefuryl;
phenylacetic acids, such as chlorfenac;
phenylpropionic acids, such as chlorphenprop-methyl;
ppi-active substances (ppi=preplant incorporated), such as benzofenap, flumiclorac-pentyl, fiumioxazin, flumipropyn, flupropacil, pyrazoxyfen, sulfentrazone or thidiazimin;
pyrazoles, such as nipyraclofen;
pyridazines, such as chloridazon, maleic hydrazide, norflurazon or pyridate;
pyridinecarboxylic acids, such as clopyralid, dithiopyr, picloram or thiazopyr;
pyrimidyl ethers, such as pyrithiobac acid, pyrithiobac-sodium, KIH-2023 or KIH-6127;
sulfonamides, such as flumetsulam or metosulam;
triazolecarboxamides, such as triazofenamide;
uracils, such as bromacil, lenacil or terbacil;
furthermore benazolin, benfuresate, bensulide, benzofluor, bentazon, butamifos, cafenstrole, chlorthal-dimethyl, cinmethylin, dichlobenil, endothall, fluorbentranil, mefluidide, perfluidone, piperophos, topramezone and prohexadione-calcium;
sulfonylureas, such as amidosulfuron, azimsulfuron, bensulfuron-methyl, chlorimuron-ethyl, chlorsulfuron, cinosulfuron, cyclosulfamuron, ethametsulfuronmethyl, flazasulfuron, halosulfuron-methyl, imazosulfuron, metsulfuron-methyl, nicosulfuron, primisulfuron, prosulfuron, pyrazosulfuron-ethyl, rimsulfuron, sulfometuron-methyl, thifensulfuron-methyl, triasulfuron, tribenuron-methyl, triflusulfuron-methyl or tritosulfuron;
plant protection active substances of the cyclohexenone type, such as alloxydim, clethodim, cloproxydim, cycloxydim, sethoxydim and tralkoxydim. Very particularly preferred herbicidal active substances of the cyclohexenone type are: tepraloxydim (cf. AGROW, No. 243, 11.3.95, page 21, caloxydim) and 2-(1-[2-{4-chlorphenoxy}-propyloxyimino]butyl)-3-hydroxy-5-(2H-tetrahydrothiopyran-3-yl)-2-cyclohexen-1-one, and of the sulfonylurea type is: N-(((4-methoxy-6-[trifluoromethyl]-1,3,5-triazin-2-yl)amino)carbonyl)-2-(trifluoromethyl)benzenesulfonamide.

Examples of insecticides comprise:
organophosphates, such as acephate, azinphos-methyl, chlorpyrifos, chlorfenvinphos, diazinon, dichlorvos, dimethylvinphos, dioxabenzofos, dicrotophos, dimethoate, disulfoton, ethion, EPN, fenitrothion, fenthion, isoxathion, malathion, methamidophos, methidathion, methyl parathion, mevinphos, monocrotophos, oxydemeton-methyl, paraoxon, parathion, phenthoate, phosalone, phosmet, phosphamidon, phorate, phoxim, pirimiphos-methyl, profenofos, prothiofos, pirimiphosethyl, pyraclofos, pyridaphenthion, sulprophos, triazophos, trichlorfon, tetrachlorvinphos or vamidothion;
carbamates, such as alanycarb, benfuracarb, bendiocarb, carbaryl, carbofuran, carbosulfan, fenoxycarb, furathiocarb, indoxacarb, methiocarb, methomyl, oxamyl, pirimicarb, propoxur, thiodicarb or triazamate;
pyrethroids, such as bifenthrin, cyfluthrin, cycloprothrin, cypermethrin, deltamethrin, esfenvalerate, etofenprox, fenpropathrin, fenvalerate, cyhalothrin, lambda-cyhalothrin, permethrin, silafluofen, tau-fluvalinate, tefluthrin, tralomethrin, alpha-cypermethrin or zeta-cypermethrin;
arthropodal growth regulators: a) chitin synthesis inhibitors, e.g. benzoylureas, such as chlorfluazuron, diflubenzuron, flucycloxuron, flufenoxuron, hexaflumuron, lufenuron, novaluron, teflubenzuron, triflumuron, buprofezin, diofenolan, hexythiazox, etoxazole or clofentezine; b) ecdysone antagonists, such as halofenozide, methoxyfenozide or tebufenozide; c) juvenile hormone mimics, such as pyriproxyfen, methoprene or fenoxycarb; d) lipid biosynthesis inhibitors such as spirodiclofen;
neonicotinoids, such as flonicamid, clothianidin, dinotefuran, imidacloprid, thiamethoxam, nitenpyram, nithiazine, acetamiprid or thiacloprid;
additional unclassified insecticides, such as abamectin, acequinocyl, acetamiprid, amitraz, azadirachtin, bensultap, bifenazate, cartap, chlorfenapyr, chlordimeform, cyromazine, diafenthiuron, dinotefuran, diofenolan, emamectin, endosulfan, ethiprole, fenazaquin, fipronil, formetanate, formetanate hydrochloride, gamma-HCH, hydramethylnon, imidacloprid, indoxacarb, isoprocarb, metolcarb, pyridaben, pymetrozine, spinosad, tebufenpyrad, thiamethoxam, thiocyclam, XMC and xylylcarb;
N-phenylsemicarbazones, such as those disclosed in EP-A 462 456 by the general formula (I), especially compounds of the general formula (A)

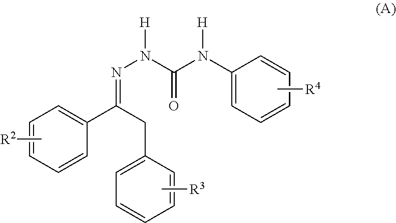

in which R² and R³ represent, independently of one another, hydrogen, halogen, CN, C₁-C₄ alkyl, C₁-C₄ alkoxy, C₁-C₄ haloalkyl or C₁-C₄ haloalkoxy and R⁴ represents C₁-C₄ alkoxy, C₁-C₄ haloalkyl or C₁-C₄ haloalkoxy, e.g. compound IV, in which R² represents 3-CF₃, R³ represents 4-CN and R⁴ represents 4-OCF₃.

Examples for plant growth regulators comprise chlormequat chloride, mepiquat chloride, prohexadione-calcium, trinexapac ethyl or the group of the gibberellins. These include, e.g. the gibberellin GA₁, GA₃, GA₄, GA₆ and GA₇, and the like, and the corresponding exo-16,17-dihydrogibberellins, and also the derivatives thereof, e.g. the esters with C₁-C₄ carboxylic acids.

Water-soluble concentrates (SL, LS) comprise for example:
(a) 0.01 to 3% by weight, relative to the total weight of the composition, of at least one antimicrobial agent as defined above;
(b) 0.01 to 5% by weight, relative to the total weight of the composition, of a carboxamide compound of the formula (I) or a mixture of different carboxamide compounds of the formula (I) as defined above;
(c) 5 to 60% by weight, relative to the total weight of the composition, of the active substances;
(d) 5 to 15% by weight, relative to the total weight of the composition, of at least one wetting agent (e.g. alcohol alkoxylates);
(e) 3 to 15% by weight, relative to the total weight of the composition, of at least one antifreezing agent;
(f) water or a mixture of water and a water-soluble solvent (e.g. an alcohol) ad 100% by weight.

Emulsions (EW, EO, ES) comprise for example:
(a) 0.01 to 3% by weight, relative to the total weight of the composition, of at least one antimicrobial agent as defined above;
(b) 0.01 to 5% by weight, relative to the total weight of the composition, of a carboxamide compound of the formula (I) or a mixture of different carboxamide compounds of the formula (I) as defined above;
(c) 5 to 40% by weight, relative to the total weight of the composition, of the active substance;
(d) 1 to 10% by weight, relative to the total weight of the composition, of one or more emulsifiers (e.g. calcium dodecylbenzenesulfonate and castor oil ethoxylate);
(e) 3 to 15% by weight, relative to the total weight of the composition, of at least one antifreezing agent;
(f) 20 to 40% by weight, relative to the total weight of the composition, of at least one water-insoluble organic solvent (e.g. aromatic hydrocarbon);
(g) water ad 100% by weight.

Suspensions (SC, OD, FS) comprise for example:
(a) 0.01 to 3% by weight, relative to the total weight of the composition, of at least one antimicrobial agent as defined above;
(b) 0.01 to 5% by weight, relative to the total weight of the composition, of a carboxamide compound of the formula (I) or a mixture of different carboxamide compounds of the formula (I) as defined above;
(c) 5 to 60% by weight, relative to the total weight of the composition, of the active substance;
(d) 2 to 10% by weight, relative to the total weight of the composition, of dispersants and/or wetting agents (e.g. sodium lignosulfonate and alcohol ethoxylate);
(e) 0.1 to 2% by weight, relative to the total weight of the composition, of at least one thickener (e.g. xanthan gum);
(f) 3 to 15% by weight, relative to the total weight of the composition, of at least one antifreezing agent;
(g) water ad 100% by weight.

For FS type composition up to 40 wt % binder (e.g. polyvinylalcohol) is contained.

Gels (GW, GF) comprise for example:
(a) 0.01 to 3% by weight, relative to the total weight of the composition, of at least one antimicrobial agent as defined above;
(b) 0.01 to 5% by weight, relative to the total weight of the composition, of a carboxamide compound of the formula (I) or a mixture of different carboxamide compounds of the formula (I) as defined above;
(c) 5 to 50% by weight, relative to the total weight of the composition, of the active substance;
(d) 3 to 10% by weight, relative to the total weight of the composition, of one or more dispersants (e.g. sodium lignosulfonate);
(e) 1 to 5% by weight, relative to the total weight of the composition, of at least one thickener (e.g. carboxy¬methylcellulose);
(f) 3 to 15% by weight, relative to the total weight of the composition, of at least one antifreezing agent;
(g) water ad 100% by weight.

Microemulsions (ME) comprise for example:
(a) 0.01 to 3% by weight, relative to the total weight of the composition, of at least one antimicrobial agent as defined above;
(b) 0.01 to 5% by weight, relative to the total weight of the composition, of a carboxamide compound of the formula (I) or a mixture of different carboxamide compounds of the formula (I) as defined above;
(c) 5 to 50% by weight, relative to the total weight of the composition, of the active substance;
(d) 5 to 30% by weight, relative to the total weight of the composition, of an organic solvent blend (e.g. fatty acid dimethylamide different from compounds (I) and cyclohexanone);
(e) 10 to 25% by weight, relative to the total weight of the composition, of surfactant blend (e.g. alcohol ethoxylate and arylphenol ethoxylate);
(f) 3 to 15% by weight, relative to the total weight of the composition, of at least one antifreezing agent;
(g) water ad 100% by weight.

The above crop protection compositions may optionally comprise further auxiliaries, such as 0.1-1 wt % other bactericides, 0.1-1 wt % anti-foaming agents, and 0.1-1 wt % colorants.

### Pharmaceutical Compositions

Suitable pharmaceutical compositions may exist in a wide variety of forms, for example in the form of liquid preparations as a W/O, O/W, O/W/O, W/O/W or PIT emulsion and all kinds of microemulsions; in the form of a non-emulsified, water-based liquid, in the form of a gel, in the form of an oil, a cream, milk or lotion, in the form of a spray (spray with propellant gas or pump-action spray) or an aerosol, in the form of a foam, in the form of a paste, in the form of a wet wipe (such as for cleaning the nappy area).

The pharmaceutical compositions may be, for example, creams, gels, lotions, alcoholic and aqueous/alcoholic solutions, emulsions, wax/fat compositions, or ointments.

### Personal Care Compositions

Preserving personal care products from microbial degradation is imperative and simultaneously challenging, since most topical cosmetics and dermatological products contain significant amounts of water, thus providing a very hospitable environment for microbial growth. Many other ingredients in personal care products can also be a good source of nutrients to microbes. Moreover, shelf-life and pot life of personal care products are rather long as compared to, for example, food products. Generally, personal care products are neither sterilized and nor packed in hermetic conditions, and thus the presence of preservatives can hardly be dispensed with. On the other hand, the public regards preservatives in personal care products as problematic. The consumers expect the preservatives to be not only effective, but extremely mild during the whole shelf and pot life. Public opinion makes it very difficult to use formaldehyde donors, halogenated organic molecules and recently also parabens in personal care products. It is at least expected that the amounts of these preservatives is reduced to a minimum. Antimicrobials which are not or at least less hazardous, like 2-phenoxyethanol, are often not very effective and need to be used in rather high concentrations to achieve an acceptable antimicrobial effect. In personal care applications, high concentrations are however not acceptable. The present combination of antimicrobials (a) and carboxamides of formula (I) allows to reduce the amount of antimicrobial substantially, without compromising the desired antimicrobial effect.

This notwithstanding, in personal care compositions, the antimicrobial is preferably 2-phenoxyethanol.

Personal care compositions can be such for hygienic or cosmetic use. Examples for suitable personal care compositions are given above.

Suitable personal care compositions may exist in a wide variety of forms, for example in the form of liquid preparations as a W/O, O/W, O/W/O, W/O/W or PIT emulsion and all kinds of microemulsions; in the form of a non-emulsified, water-based liquid, in the form of a gel, in the form of an oil, a cream, milk or lotion, in the form of a spray (spray with propellant gas or pump-action spray) or an aerosol, in the form of a foam, in the form of a paste, in the form of a wet wipe (such as for cleaning the nappy area).

The personal care compositions may be, for example, creams, gels, lotions, alcoholic and aqueous/alcoholic solutions, emulsions, wax/fat compositions, or ointments.

Ingredients typically present in such personal care compositions and their amounts vary according to the specific formulation. Examples for such ingredients are solvents, surfactants, emulsifiers, rheology modifiers (generally thickeners), conditioners, emollients, skin caring ingredients, lubricants, fillers, antioxidants, dermatologically active ingredients, fragrances and water.

For instance, in form of water- and oil-containing emulsions (e.g. W/O, O/W, O/W/O and W/OW emulsions or microemulsions) the preparations generally contain at least one oil component, at least one emulsifier, water and optionally at least one further cosmetically acceptable adjuvants; for example, from 0.1 to 30% by weight, preferably from 0.1 to 15% by weight and especially from 0.5 to 10% by weight, based on the total weight of the composition, from 1 to 60% by weight, especially from 5 to 50% by weight and preferably from 10 to 35% by weight, based on the total weight of the composition, of at least one oil component, from 0 to 30% by weight, especially from 1 to 30% by weight und preferably from 4 to 20% by weight, based on the total weight of the composition, of at least one emulsifier, from 10 to 90% by weight, especially from 30 to 90% by weight, based on the total weight of the composition, of water, and from 0 to 88.9% by weight, especially from 1 to 50% by weight, of further cosmetically acceptable adjuvants.

Preparation intended mainly for cleaning, such as soaps, shower gels and shampoos, contain at least one or more surfactants, often of the anionic type, optionally in combination with such of the zwitterionic type; and water. Furthermore, they generally contain at least one of following components: emulsifier, sequestrant, fragrance, pH modifier (generally an organic acid and/or an inorganic base), inorganic salt (mostly NaCl), dye,

Of special importance are cosmetic preparations for the hair, especially with the purpose of antidandruff treatment, especially hair-washing preparations in the form of shampoos, hair conditioners, hair-care preparations, e.g. pre-treatment preparations, hair tonics, styling creams, styling gels, pomades, hair rinses, treatment packs, intensive hair treatments, hair-straightening preparations, liquid hair-setting preparations, hair foams and hairsprays. Of special interest are hair-washing preparations in the form of shampoos. Of special interest are moreover shower gels.

Shampoos as well as shower gels generally contain water and at least one anionic surfactant.

Suitable anionic surfactants are principally all those described above in context with homecare and I&I compositions which are cosmetically acceptable. In shampoos and in shower gels, it is useful to use surfactants which are good foam-formers.

Examples of suitable anionic surfactants in this context are alkyl sulfates, alkyl ether sulphates, alkaryl sulfonates, alkanoyl isethionates, alkyl succinates, alkyl sulfosuccinates, alkyl ether sulfosuccinates, N-alkyl sarcosinates, alkyl phosphates, alkyl ether phosphates, and alkyl ether carboxylic acids and salts thereof, especially sodium, magnesium, ammonium and mono-, di- and triethanolamine salts. The alkyl and acyl groups generally contain from 8 to 18, preferably from 10 to 16 carbon atoms and may be unsaturated. The alkyl ether sulfates, alkyl ether sulfosuccinates, alkyl ether phosphates and alkyl ether carboxylic acids and salts thereof may contain from 1 to 20 ethylene oxide or propylene oxide units per molecule. Typical surfactants for use in shampoo compositions include sodium oleyl succinate, ammonium lauryl sulfosuccinate, sodium lauryl sulfate, sodium lauryl ether sulfate (sodium laureth sulfate), sodium lauryl ether sulfosuccinate, ammonium lauryl sulfate, ammonium lauryl ether sulfate, sodium dodecylbenzene sulfonate, triethanolamine dodecylbenzene sulfonate, sodium cocoyl isethionate, sodium lauryl isethionate, lauryl ether carboxylic acid and sodium N-lauryl sarcosinate. Mixtures of any of the foregoing anionic surfactants are also suitable. The overall amount of anionic surfactant in the shampoo compositions of the invention generally ranges from 0.5 to 45% by weight, e.g. from 1.5 to 35% by weight, based on the total weight of the composition.

The shampoo or shower gel composition can moreover include non-ionic, amphoteric and/or cationic co-surfactants, which help impart aesthetic, haptic, combing, physical or cleansing properties to the composition.

Suitable non-ionic surfactants are those listed above, e.g. ethoxylated fatty alcohols, mono- or di-alkyl alkanolamides, such as coco mono- or di-ethanolamide and coco monoisopropanolamide; or alkyl polyglycosides (APGs) such as Oramix NS10 ex Seppic; Plantaren 1200 and Plantaren 2000 ex Henkel. The overall amount of non-ionic surfactant in the shampoo or shower gel compositions of the invention generally ranges from 0.5 to 8% by weight, preferably from 2 to 5% by weight, based on the total weight of the composition.

Suitable amphoteric or zwitterionic surfactants are those listed above, e.g. alkyl amine oxides, alkyl betaines, alkyl amidopropyl betaines, alkyl sulfobetaines (sultaines), alkyl glycinates, alkyl carboxyglycinates, alkyl amphoacetates, alkyl amphopropionates, alkylamphoglycinates, alkyl amidopropyl hydroxysultaines, acyl taurates and acyl glutamates, wherein the alkyl and acyl groups have from 8 to 19 carbon atoms. Specific examples are lauryl amine oxide, cocodimethyl sulfopropyl betaine, lauryl betaine, cocamidopropyl betaine and sodium cocoamphoacetate. Mixtures of the foregoing amphoteric or zwitterionic surfactants are also suitable. The overall amount of amphoteric or zwitterionic surfactant in the shampoo or shower gel compositions of the invention generally ranges from 0.5 to 8% by weight, preferably from 1 to 4% by weight, based on the total weight of the composition.

Suitable cationic polymers are those listed above. Examples are copolymers of vinyl monomers having cationic amine or quaternary ammonium functionalities with water soluble spacer monomers such as (meth)acrylamide, alkyl and dialkyl (meth)acrylamides, alkyl (meth)acrylate, vinyl caprolactone and vinyl pyrrolidine. The alkyl and dialkyl substituted monomers preferably have C₁-C₇-alkyl groups, more preferably C₁-C₃-alkyl groups. Other suitable spacers include vinyl esters, vinyl alcohol, maleic anhydride, propylene glycol and ethylene glycol. The cationic amines can be primary, secondary or tertiary amines, depending upon the particular species and the pH of the composition. In general secondary and tertiary amines, especially tertiary, are preferred. Other examples are cationic polysaccharide polymers, such as cationic cellulose derivatives, cationic starch derivatives, and cationic guar gum derivatives. The overall amount of cationic surfactant in the shampoo or shower gel compositions of the invention generally ranges from 0.05 to 1% by weight, more preferably from 0.08 to 0.5% by weight, based on the total weight of the composition.

The total amount of surfactant (including any co-surfactant and/or any emulsifier) in a shampoo or shower gel composition is generally from 1 to 50% by weight, preferably from 2 to 40% by weight, more preferably from 10 to 25% by weight, based on the total weight of the composition.

Other components which may be present in the shampoo or shower gel are for example suspending agents, such as polyacrylic acids, cross-linked polymers of acrylic acid, copolymers of acrylic acid with a hydrophobic monomer, copolymers of carboxylic acid-containing monomers and acrylic esters, cross-linked copolymers of acrylic acid and acrylate esters, heteropolysaccharide gums and crystalline long chain acyl derivatives, the latter being preferably selected from ethylene glycol stearate, alkanolamides of fatty acids having from 16 to 22 carbon atoms and mixtures thereof; fragrances, dyes and pigments, pH adjusting agents, pearlescers or opacifiers, viscosity modifiers, and salts, such as NaCl; in shampoos moreover natural hair nutrients or dermatologically active ingredients, such as botanicals, fruit extracts, caffeine, panthenol, sugar derivatives, amino acids, such as hydrolized keratine or glycine, vegetable or hydrogenated vegetable oils.

In ready-to-use compositions in which the antimicrobial agent (in combination with the carboxamide compound of the formula (I)) is to exert a preservative effect, the antimicrobial agent and the carboxamide compound of the formula (I) are of course contained in a preservative effective amount denotes. This is an amount that is sufficient to reduce the cell population of an unwanted microorganism under a predetermined threshold value to obtain shelf-stability over a certain period of time.

Thus, a “preservative-effective amount” can be e.g. defined as an amount sufficient to reduce the cell population by, for example, at least one, preferably at least two, in particular at least three log orders of the at least one of following microorganisms: Alcaligeneses faecalis, Aspergillus niger, Burkholderia cepacia, Candida albicans, Escherichia col, Pseudomonas aeruginosa, Pseudomonas putida and Staphylococcus aureus, and in particular at least one of following microorganisms: Alcaligeneses faecalis, Burkholderia cepacia, Escherichia coli, Pseudomonas aeruginosa, Pseudomonas putida and Staphylococcus aureus.

Alternatively or additionally, a “preservative-effective amount” can be e.g. defined as an amount sufficient to reduce the cell population by, for example, at least one, preferably at least two, in particular at least three log orders of the at least one of following microorganisms: Aspergillus brasiliensis, Rhodotorula mucilaginosa and Yarrowia lipolytica.

The composition of the invention has a pH of preferably from 2 to 11, more preferably from 4 to 10, and in particular from 4 to 9.

In the following, some exemplary formulations of the invention are listed to illustrate typical compositions.

(I) All Purpose Cleaner 1

| | INCI Name/ | 1 | 2 | 3 | 4 | 5 | 6 | 7 | 8 | 9 | 10 |
|---|---|---|---|---|---|---|---|---|---|---|---|
| Trade name | Chemical name | % w/w | % w/w | % w/w | % w/w | % w/w | % w/w | % w/w | % w/w | % w/w | % w/w |
| Antimicrobial | | 0.001 | 0.01 | 0.1 | 1 | 2 | 0.001 | 0.01 | 0.1 | 1 | 2 |
| agent | | | | | | | | | | | |
| Compound of | | 1 | 1 | 1 | 1 | 1 | 1 | 1 | 1 | 1 | 1 |
| formula (I) | | | | | | | | | | | |
| Solvent | | — | — | — | — | — | 3 | 3 | 3 | 3 | 3 |
| Plurafac LF 400 | Alkoxylated | 10.00 | 10.00 | 10.00 | 10.00 | 10.00 | 10.00 | 10.00 | 10.00 | 10.00 | 10.00 |
| (BASF( | Alcohol | | | | | | | | | | |
| Hostapur SAS 60 | Sodium C14-17 | 14.00 | 14.00 | 14.00 | 14.00 | 14.00 | 14.00 | 14.00 | 14.00 | 14.00 | 14.00 |
| (Clariant) | Alkyl Sec | | | | | | | | | | |
| | Sulfonate | | | | | | | | | | |
| Texapon ® LS 35 | Lauryl-myristyl | 5.00 | 5.00 | 5.00 | 5.00 | 5.00 | 5.00 | 5.00 | 5.00 | 5.00 | 5.00 |
| (BASF) | sulfate Na-salt | | | | | | | | | | |
| Citric Acid | Citric Acid | ad pH | ad pH | ad pH | ad pH | ad pH | ad pH | ad pH | ad pH | Jad pH | ad pH |
| (Merck) | | 6.5 | 6.5 | 6.5 | 6.5 | 16.5 | 6.5 | 6.5 | 6.5 | 6.5 | 6.5 |
| IRAGON ® Blue | Acid Blue | 0.01 | 0.01 | 0.01 | 0.01 | 0.01 | 0.01 | 0.01 | 0.01 | 0.01 | 0.01 |
| ABL 9 sol. 1% | | | | | | | | | | | |
| (BASF) | | | | | | | | | | | |
| Cibafast ® H | Sodium | 0.05 | 0.05 | 0.05 | 0.05 | 0.05 | 0.05 | 0.05 | 10.05 | 10.05 | 0.05 |
| Liquid (BASF) | Benzotriazolyl | | | | | | | | | | |
| | Butylphenol | | | | | | | | | | |
| | Sulfonate (and) | | | | | | | | | | |
| | Buteth-3 (and) | | | | | | | | | | |
| | Tributyl Citrate | | | | | | | | | | |
| Water and | Aqua | qs to | qs to | qs to | qs to | qs to | qs to | qs to | qs to | qs to | qs to |
| Perfume | | 100 | 100 | 100 | 100 | 100 | 100 | 100 | 100 | 100 | 100 |

(II) All Purpose Cleaner 2

| | INCI Name/ | 1 | 2 | 3 | 4 | 5 | 6 | 7 | 8 | 9 | 10 |
|---|---|---|---|---|---|---|---|---|---|---|---|
| Trade name | Chemical name | % w/w | % w/w | % w/W | % w/w | % w/w | % w/w | % w/w | % w/w | % w/w | % w/w |
| Antimicrobial | | 0.001 | 0.01 | 0.1 | 1 | 2 | 0.001 | 0.01 | 0.1 | 1 | 2 |
| agent | | | | | | | | | | | |
| Compound of | | 1 | 1 | 1 | 1 | 1 | 1 | 1 | 1 | 1 | 1 |
| formula (I) | | | | | | | | | | | |
| Solvent | | — | — | — | — | — | 3 | 3 | 3 | 3 | 3 |
| Plurafac PE 6800 | Alkoxylated | 2.5 | 2.5 | 2.5 | 2.5 | 2.5 | 2.5 | 2.5 | 2.5 | 2.5 | 2.5 |
| (BASF) | Alcohol | | | | | | | | | | |
| Plurafac LF 901 | Alkoxylated | 5.0 | 5.0 | 5.0 | 5.0 | 5.0 | 5.0 | 5.0 | 5.0 | 5.0 | 5.0 |
| (BASF) | Alcohol | | | | | | | | | | |
| Citric Acid | Citric Acid | ad pH | ad pH | ad pH | ad pH | ad pH | ad pH | ad pH | ad pH | ad pH | ad pH |
| (Merck) | | 6.5 | 6.5 | 6.5 | 6.5 | 6.5 | 6.5 | 6.5 | 6.5 | 6.5 | 6.5 |
| IRAGON ® Blue | Acid Blue | 0.01 | 0.01 | 0.01 | 0.01 | 0.01 | 0.01 | 0.01 | 0.01 | 0.01 | 0.01 |
| ABL 9 sol. 1% | | | | | | | | | | | |
| (BASF) | | | | | | | | | | | |
| Cibafast ® H | Sodium | 0.05 | 0.05 | 0.05 | 0.05 | 0.05 | 0.05 | 0.05 | 0.05 | 0.05 | 0.05 |
| Liquid (BASF) | Benzotriazolyl | | | | | | | | | | |
| | Butylphenol | | | | | | | | | | |
| | Sulfonate (and) | | | | | | | | | | |
| | Buteth-3 (and) | | | | | | | | | | |
| | Tributyl Citrate | | | | | | | | | | |
| Water and | Aqua | qs to | qs to | qs to | qs to | qs to | qs to | qs to | qs to | qs to | qs to |
| Perfume | | 100 | 100 | 100 | 100 | 100 | 100 | 100 | 100 | 100 | 100 |

(III) All Purpose Cleaner 3

| | INCI Name/ | 1 | 2 | 3 | 4 | 5 | 6 | 7 | 8 | 9 | 10 |
|---|---|---|---|---|---|---|---|---|---|---|---|
| Trade name | Chemical name | % w/w | % w/w | % w/w | % w/w | % w/w | % w/w | % w/w | % w/w | % w/w | % w/w |
| Antimicrobial | | 0.001 | 0.01 | 0.1 | 1 | 2 | 0.001 | 0.01 | 0.1 | 1 | 2 |
| agent | | | | | | | | | | | |
| Compound of | | 1 | 1 | 1 | 1 | 1 | 1 | 1 | 1 | 1 | 1 |
| formula (I) | | | | | | | | | | | |
| Solvent | | — | — | — | — | — | 3 | 3 | 3 | 3 | 3 |
| Texapon ® LS 35 | Lauryl-myristyl | 10.00 | 10.00 | 10.00 | 10.00 | 10.00 | 10.00 | 10.00 | 10.00 | 10.00 | 10.00 |
| (BASF) | sulfate Na-salt | | | | | | | | | | |
| Glucopon ® 215 | Alkyl | 3.00 | 3.00 | 3.00 | 3.00 | 3.00 | 3.00 | 3.00 | 3.00 | 3.00 | 3.00 |
| CS UP (BASF) | Polyglycoside | | | | | | | | | | |
| Perfume | | qs | qs | qs | qs | qs | qs | qs | qs | qs | qs |
| Citric Acid | Citric Acid | ad pH | ad pH | ad pH | Jad pH | ad pH | ad pH | ad pH | ad pH | ad pH | ad pH |
| (Merck) | | 3.0 | 3.0 | 3.0 | 3.0 | 3.0 | 3.0 | 3.0 | 3.0 | 3.0 | 3.0 |
| Water | Aqua | qs to | qs to | qs to | qs to | qs to | qs to | qs to | qs to | qs to | qs to |
| | | 100 | 100 | 100 | 100 | 100 | 100 | 100 | 100 | 100 | 100 |

(IV) All Purpose Cleaner 4

| | INCI Name/ | 1 | 2 | 3 | 4 | 5 | 6 | 7 | 8 | 9 | 10 |
|---|---|---|---|---|---|---|---|---|---|---|---|
| Trade name | Chemical name | % w/w | % w/w | % w/w | % w/w | % w/w | % w/w | % w/w | % w/w | % w/w | % w/w |
| Antimicrobial | | 0.001 | 0.01 | 0.1 | 1 | 2 | 0.001 | 0.01 | 0.1 | 1 | 2 |
| agent | | | | | | | | | | | |
| Compound of | | 1 | 1 | 1 | 1 | 1 | 1 | 1 | 1 | 1 | 1 |
| formula (I) | | | | | | | | | | | |
| Solvent | — | — | — | — | — | — | 3 | 3 | 3 | 3 | 3 |
| Plurafac LF 400 | Alkoxylated | 2.00 | 2.00 | 2.00 | 2.00 | 2.00 | 2.00 | 2.00 | 2.00 | 2.00 | 2.00 |
| (BASF) | Alcohol | | | | | | | | | | |
| Sodium Cumene | Sodium | 5.00 | 5.00 | 5.00 | 5.00 | 5.00 | 5.00 | 5.00 | 5.00 | 5.00 | 5.00 |
| Sulfonate | Cumene | | | | | | | | | | |
| (Hickson Manro) | Sulfonate | | | | | | | | | | |
| Marlon PS 65 | Sodium C13-17 | 10.0 | 10.0 | 10.0 | 10.0 | 10.0 | 10.0 | 10.0 | 10.0 | 10.0 | 10.0 |
| (Sasol) | Alkane | | | | | | | | | | |
| | Sulfonate | | | | | | | | | | |
| Perfume | | qs | qs | qs | qs | qs | qs | qs | qs | qs | qs |
| Trisodium Citrate | Trisodium | 5.00 | 5.00 | 5.00 | 5.00 | 5.00 | 5.00 | 5.00 | 5.00 | 5.00 | 5.00 |
| Dihydrate | Citrate | | | | | | | | | | |
| (Fluka) | Dihydrate | | | | | | | | | | |
| Water | Aqua | qs to | qs to | qs to | qs to | qs to | qs to | qs to | qs to | qs to | qs to |
| | | 100 | 100 | 100 | 100 | 100 | 100 | 100 | 100 | 100 | 100 |

(V) All Purpose cleaner 5

| | INCI Name/ | 1 | 2 | 3 | 4 | 5 | 6 | 7 | 8 | 9 | 10 |
|---|---|---|---|---|---|---|---|---|---|---|---|
| Trade name | Chemical name | % w/w | % w/w | % w/w | % w/w | % w/w | % w/w | % w/w | % w/w | % w/w | % w/w |
| Antimicrobial | | 0.001 | 0.01 | 0.1 | 1 | 2 | 0.001 | 0.01 | 10.1 | 1 | 2 |
| agent | | | | | | | | | | | |
| Compound of | | 1 | 1 | 1 | 1 | 1 | 1 | 1 | 1 | 1 | 1 |
| formula (I) | | | | | | | | | | | |
| Solvent | — | — | — | — | — | — | 3 | 3 | 3 | 3 | 3 |
| Glucopon ® 215 | Alkyl | 3.00 | 3.00 | 3.00 | 3.00 | 3.00 | 3.00 | 3.00 | 3.00 | 3.00 | 3.00 |
| CS UP | Polyglycoside | | | | | | | | | | |
| (BASF) | | | | | | | | | | | |
| Texapon ® LS 35 | Lauryl-myristyl | 10.00 | 10.00 | 10.00 | 10.00 | 10.00 | 10.00 | 10.00 | 10.00 | 10.00 | 10.00 |
| (BASF) | sulfate Na-salt | | | | | | | | | | |
| Perfume | | qs | qs | qs | qs | qs | qs | qs | qs | qs | qs |
| Trisodium Citrate | Trisodium | 5.00 | 5.00 | 5.00 | 5.00 | 5.00 | 5.00 | 5.00 | 5.00 | 5.00 | 5.00 |
| Dihydrate | Citrate | | | | | | | | | | |
| (Fluka) | Dihydrate | | | | | | | | | | |
| Water | Aqua | qs to | qs to | qs to | qs to | qs to | qs to | qs to | qs to | qs to | qs to |
| | | 100 | 100 | 100 | 100 | 100 | 100 | 100 | 100 | 100 | 100 |

(VI) All Purpose Cleaner 6

| | INCI Name/ | 1 | 2 | 3 | 4 | 5 | 6 | 7 | 8 | 9 | 10 |
|---|---|---|---|---|---|---|---|---|---|---|---|
| Trade name | Chemical name | % w/w | % w/w | % w/w | % w/w | % w/w | % w/w | % w/w | % w/w | % w/w | % w/w |
| Antimicrobial | | 0.001 | 0.01 | 0.1 | 1 | 2 | 0.001 | 0.01 | 0.1 | 1 | 2 |
| agent | | | | | | | | | | | |
| Compound of | | 1 | 1 | 1 | 1 | 1 | 1 | 1 | 1 | 1 | 1 |
| formula (I) | | | | | | | | | | | |
| Solvent | | — | — | — | — | — | 3 | 3 | 3 | 3 | 3 |
| Texapon ® LS 35 | Lauryl-myristyl | 10.00 | 10.00 | 10.00 | 10.00 | 10.00 | 10.00 | 10.00 | 10.00 | 10.00 | 10.00 |
| (BASF) | sulfate Na-salt | | | | | | | | | | |
| Glucopon ® 215 | Alkyl | 3.00 | 3.00 | 3.00 | 3.00 | 3.00 | 3.00 | 3.00 | 3.00 | 3.00 | 3.00 |
| CS UP | Polyglycoside | | | | | | | | | | |
| (BASF) | | | | | | | | | | | |
| Sodium Cumene | Sodium | 5.00 | 5.00 | 5.00 | 5.00 | 5.00 | 5.00 | 5.00 | 5.00 | 5.00 | 5.00 |
| Sulfonate | Cumene | | | | | | | | | | |
| (Hickson Manro) | Sulfonate | | | | | | | | | | |
| Perfume | | qs | qs | qs | qs | qs | qs | qs | qs | qs | qs |
| Citric Acid | Citric Acid | ad pH | ad pH | ad pH | ad pH | ad pH | ad pH | ad pH | ad pH | ad pH | ad pH |
| (Merck) | | 3 | 3 | 3 | 3 | 3 | 3 | 3 | 3 | 3 | 3 |
| Water | Aqua | qs to | qs to | qs to | qs to | qs to | qs to | qs to | qs to | qs to | qs to |
| | | 100 | 100 | 100 | 100 | 100 | 100 | 100 | 100 | 100 | 100 |

(VII) Hard Surface Cleaner 1

| | INCI Name/ | 1 | 2 | 3 | 4 | 5 | 6 | 7 | 8 | 9 | 10 |
|---|---|---|---|---|---|---|---|---|---|---|---|
| Trade name | Chemical name | % w/w | % w/w | % w/w | % w/w | % w/w | % w/w | % w/w | % w/w | % w/w | % w/w |
| Antimicrobial | | 0.001 | 0.01 | 0.1 | 1 | 2 | 0.001 | 0.01 | 0.1 | 1 | 2 |
| agent | | | | | | | | | | | |
| Compound of | | 1 | 1 | 1 | 1 | 1 | 1 | 1 | 1 | 1 | 1 |
| formula (I) | | | | | | | | | | | |
| Solvent | | — | — | — | — | — | 3 | 3 | 3 | 3 | 3 |
| Texapon ® K12 | Sodium Lauryl | 1.00 | 1.00 | 1.00 | 1.00 | 1.00 | 1.00 | 1.00 | 1.00 | 1.00 | 1.00 |
| (BASF) | Sulfate | | | | | | | | | | |
| Citric Acid | Citric Acid | 3.00 | 3.00 | 3.00 | 3.00 | 3.00 | 3.00 | 3.00 | 3.00 | 3.00 | 3.00 |
| (Merck) | | | | | | | | | | | |
| Perfume | | qs | qs | qs | qs | qs | qs | qs | qs | qs | qs |
| Sodium Hydroxide | Water (and) | ad pH | ad pH | ad pH | ad pH | ad pH | ad pH | ad pH | ad pH | ad pH | ad pH |
| (10% solution) | Sodium | 5.0 | 5.0 | 5.0 | 5.0 | 5.0 | 5.0 | 5.0 | 5.0 | 5.0 | 5.0 |
| (Fluka) | Hydroxide | | | | | | | | | | |
| Water | Aqua | qs to | qs to | qs to | qs to | qs to | qs to | qs to | qs to | qs to | qs to |
| | | 100 | 100 | 100 | 100 | 100 | 100 | 100 | 100 | 100 | 100 |

(VIII) Hard Surface Cleaner 2

| | INCI Name/ | 1 | 2 | 3 | 4 | 5 | 6 | 7 | 8 | 9 | 10 |
|---|---|---|---|---|---|---|---|---|---|---|---|
| Trade name | Chemical name | % w/w | % w/w | % w/w | % w/w | % w/w | % w/w | % w/w | % w/w | % w/w | % w/w |
| Antimicrobial | | 0.001 | 0.01 | 0.1 | 1 | 2 | 0.001 | 0.01 | 0.1 | 1 | 2 |
| agent | | | | | | | | | | | |
| Compound of | | 1 | 1 | 1 | 1 | 1 | 1 | 1 | 1 | 1 | 1 |
| formula (I) | | | | | | | | | | | |
| Solvent | | — | — | — | — | — | 3 | 3 | 3 | 3 | 3 |
| Lutensol AO 5 | Nonionic | 2 | 2 | 2 | 2 | 2 | 2 | 2 | 2 | 2 | 2 |
| (BASF) | surfactant 5EO | | | | | | | | | | |
| Citric Acid | Citric Acid | 1 | 1 | 1 | 1 | 1 | 1 | 1 | 1 | 1 | 1 |
| (Merck) | | | | | | | | | | | |
| Sodium hydrogene | NaHCO3 | 0.5 | 0.5 | 0.5 | 0.5 | 0.5 | 0.5 | 0.5 | 0.5 | 0.5 | 0.5 |
| carbonate | | | | | | | | | | | |
| (Fluka) | | | | | | | | | | | |
| Sodium Hydroxide | Water (and) | ad pH | ad pH | ad pH | ad pH | ad pH | ad pH | ad pH | ad pH | ad pH | ad pH |
| (10% solution) | Sodium | 5.0 | 5.0 | 5.0 | 5.0 | 5.0 | 5.0 | 5.0 | 5.0 | 5.0 | 5.0 |
| (Fluka) | Hydroxide | | | | | | | | | | |
| Water | | Add to | Add to | Add to | Add to | Add to | Add to | Add to | Add to | Add to | Add to |
| | | 100 | 100 | 100 | 100 | 100 | 100 | 100 | 100 | 100 | 100 |

(IX) Surface cleaner spray 1

| | INCI Name/ | 1 | 2 | 3 | 4 | 5 | 6 | 7 | 8 | 9 | 10 |
|---|---|---|---|---|---|---|---|---|---|---|---|
| Trade name | Chemical name | % w/w | % w/w | % w/w | % w/w | % w/w | % w/w | % w/w | % w/w | % w/w | % w/w |
| Antimicrobial | | 0.001 | 0.01 | 0.1 | 1 | 2 | 0.001 | 0.01 | 0.1 | 1 | 2 |
| agent | | | | | | | | | | | |
| Compound of | | 1 | 1 | 1 | 1 | 1 | 1 | 1 | 1 | 1 | 1 |
| formula (I) | | | | | | | | | | | |
| Solvent | | — | — | — | — | — | 3 | 3 | 3 | 3 | 3 |
| Glucopon ® 215 | Alkyl | 3.50 | 3.50 | 3.50 | 3.50 | 3.50 | 3.50 | 3.50 | 3.50 | 3.50 | 3.50 |
| CS UP | Polyglycoside | | | | | | | | | | |
| (BASF) | | | | | | | | | | | |
| Dehydol ® 04 Deo | Capryleth-4 | 1.70 | 1.70 | 1.70 | 1.70 | 1.70 | 1.70 | 1.70 | 1.70 | 1.70 | 1.70 |
| (BASF) | | | | | | | | | | | |
| Perfume | | qs | qs | qs | qs | qs | qs | qs | qs | qs | qs |
| Citric Acid | Citric Acid | 9.00 | 9.00 | 9.00 | 9.00 | 9.00 | 9.00 | 9.00 | 9.00 | 9.00 | 9.00 |
| (Merck) | | | | | | | | | | | |
| Water | Aqua | qs to | qs to | qs to | qs to | qs to | qs to | qs to | qs to | qs to | qs to |
| | | 100 | 100 | 100 | 100 | 100 | 100 | 100 | 100 | 100 | 100 |

(X) Surface cleaner spray 2

| | INCI Name/ | 1 | 2 | 3 | 4 | 5 | 6 | 7 | 8 | 9 | 10 |
|---|---|---|---|---|---|---|---|---|---|---|---|
| Trade name | Chemical name | % w/w | % w/w | % w/w | % w/w | % w/w | % w/w | % w/w | % w/w | % w/w | % w/w |
| Antimicrobial | | 0.001 | 0.01 | 0.1 | 1 | 2 | 0.001 | 10.01 | 0.1 | 1 | 2 |
| agent | | | | | | | | | | | |
| Compound of | | 1 | 1 | 1 | 1 | 1 | 1 | 1 | 1 | 1 | 1 |
| formula (I) | | | | | | | | | | | |
| Solvent | | — | — | — | — | — | 3 | 3 | 3 | 3 | 3 |
| Glucopon ® 215 | Alkyl | 3.50 | 3.50 | 3.50 | 3.50 | 3.50 | 3.50 | 3.50 | 3.50 | 3.50 | 3.50 |
| CS UP | Polyglycoside | | | | | | | | | | |
| (BASF) | | | | | | | | | | | |
| Dehydol ® 04 Deo | Capryleth-4 | 1.70 | 1.70 | 1.70 | 1.70 | 1.70 | 1.70 | 1.70 | 1.70 | 1.70 | 1.70 |
| (BASF) | | | | | | | | | | | |
| Texapon ® K12 | Sodium Lauryl | 2 | 2 | 2 | 2 | 2 | 2 | 2 | 2 | 2 | 2 |
| (BASF) | Sulfate | | | | | | | | | | |
| Citric Acid | Citric Acid | ad pH | ad pH | ad pH | ad pH | ad pH | ad pH | ad pH | Jad pH | ad pH | Jad pH |
| (Merck) | | 6.0 | 6.0 | 6.0 | 6.0 | 6.0 | 6.0 | 6.0 | 6.0 | 6.0 | 6.0 |
| Water | Aqua | qs to | qs to | qs to | qs to | qs to | qs to | qs to | qs to | qs to | qs to |
| | | 100 | 100 | 100 | 100 | 100 | 100 | 100 | 100 | 100 | 100 |

(XI) Surface cleaner spray 3

| | INCI Name/ | 1 | 2 | 3 | 4 | 5 | 6 | 7 | 8 | 9 | 10 |
|---|---|---|---|---|---|---|---|---|---|---|---|
| Trade name | Chemical name | % w/w | % w/w | % w/w | % w/w | % w/w | % w/w | % w/w | % w/w | % w/w | % w/w |
| Antimicrobial | | 0.001 | 0.01 | 0.1 | 0.5 | 1 | 0.001 | 0.01 | 0.1 | 0.5 | 1 |
| agent | | | | | | | | | | | |
| Compound of | | 0.05 | 0.05 | 0.05 | 0.05 | 0.05 | 0.05 | 0.05 | 0.05 | 0.05 | 0.05 |
| formula (I) | | | | | | | | | | | |
| Solvent | | — | — | — | — | — | 3 | 3 | 3 | 3 | 3 |
| Texapon ® K12 | Sodium Lauryl | 11.00 | 1.00 | 1.00 | 1.00 | 1.00 | 1.00 | 1.00 | 1.00 | 1.00 | 1.00 |
| (BASF) | Sulfate | | | | | | | | | | |
| Citric Acid | Citric Acid | 3.00 | 3.00 | 3.00 | 3.00 | 3.00 | 3.00 | 3.00 | 3.00 | 3.00 | 3.00 |
| (Merck) | | | | | | | | | | | |
| Dowanol DPM | PPG-2 Methyl | 10.00 | 10.00 | 10.00 | 10.00 | 10.00 | 10.00 | 10.00 | 10.00 | 10.00 | 10.00 |
| (Dow) | Ether | | | | | | | | | | |
| Sodium Hydroxide | Water (and) | ad pH | ad pH | ad pH | ad pH | ad pH | ad pH | ad pH | ad pH | ad pH | ad pH |
| (10% solution) | Sodium | 7.0 | 7.0 | 7.0 | 7.0 | 7.0 | 7.0 | 7.0 | 7.0 | 7.0 | 7.0 |
| | Hydroxide | | | | | | | | | | |

(XII) Surface cleaner spray 4

| | INCI Name/ | 1 | 2 | 3 | 4 | 5 | 6 | 7 | 8 | 9 | 10 |
|---|---|---|---|---|---|---|---|---|---|---|---|
| Trade name | Chemical name | % w/w | % w/w | % w/w | % w/w | % w/w | % w/w | % w/w | % w/w | % w/w | % w/w |
| Antimicrobial | | 0.001 | 0.01 | 0.1 | 0.5 | 1 | 0.001 | 0.01 | 0.1 | 0.5 | 1 |
| agent | | | | | | | | | | | |
| Compound of | | 0.05 | 0.05 | 0.05 | 0.05 | 0.05 | 0.05 | 0.05 | 0.05 | 0.05 | 0,05 |
| formula (I) | | | | | | | | | | | |
| Solvent | | — | — | — | — | — | 3 | 3 | 3 | 3 | 3 |
| Texapon ® K12 | Sodium Lauryl | 2.00 | 2.00 | 2.00 | 2.00 | 2.00 | 2.00 | 2.00 | 2.00 | 2.00 | 2.00 |
| (BASF) | Sulfate | | | | | | | | | | |
| Propyleneglycol | 1,2-Propane- | 10.00 | 10.00 | 10.00 | 10.00 | 10.00 | 10.00 | 10.00 | 10.00 | 10.00 | 10.00 |
| | diol | | | | | | | | | | |
| Citric Acid sol. | Citric Acid | ad pH | ad pH | ad pH | ad pH | ad pH | ad pH | ad pH | ad pH | ad pH | ad pH |
| 20% | | 3.0 | 3.0 | 3.0 | 3.0 | 3.0 | 3.0 | 3.0 | 3.0 | 3.0 | 3.0 |
| Water | Aqua | qs to | qs to | qs to | qs to | qs to | qs to | qs to | qs to | qs to | qs to |
| | | 100 | 100 | 100 | 100 | 100 | 100 | 100 | 100 | 100 | 100 |

(XIII) Surface cleaner spray 5

| | INCI Name/ | 1 | 2 | 3 | 4 | 5 | 6 | 7 | 8 | 9 | 10 |
|---|---|---|---|---|---|---|---|---|---|---|---|
| Trade name | Chemical name | % w/w | % w/w | % w/w | % w/w | % w/w | % w/w | % w/w | % w/w | % w/w | % w/w |
| Antimicrobial | | 0.001 | 0.01 | 0.1 | 0.5 | 1 | 0.001 | 0.01 | 0.1 | 0.5 | 1 |
| agent | | | | | | | | | | | |
| Compound of | | 0.05 | 0.05 | 0.05 | 0.05 | 0.05 | 0.05 | 10.05 | 10.05 | 10.05 | 0.05 |
| formula (I) | | | | | | | | | | | |
| Solvent | | — | — | — | — | — | 3 | 3 | 3 | 3 | 3 |
| Propyleneglycol | 1,2-Propane- | 10.00 | 10.00 | 10.00 | 10.00 | 10.00 | 10.00 | 10.00 | 10.00 | 10.00 | 10.00 |
| | diol | | | | | | | | | | |
| Glucopon ® 215 | Alkyl | 2.00 | 2.00 | 2.00 | 2.00 | 2.00 | 2.00 | 2.00 | 2.00 | 2.00 | 2.00 |
| CS UP (BASF) | Polyglycoside | | | | | | | | | | |
| Perfume | | qs | qs | qs | qs | qs | qs | qs | qs | qs | qs |
| Citric Acid | Citric Acid | 1.00 | 1.00 | 1.00 | 1.00 | 1.00 | 1.00 | 1.00 | 1.00 | 1.00 | 1.00 |
| Sodium Hydroxide | Water (and) | ad pH | ad pH | ad pH | ad pH | ad pH | ad pH | ad pH | ad pH | ad pH | ad pH |
| (10% solution) | Sodium | 5.0 | 5.0 | 5.0 | 5.0 | 5.0 | 15.0 | 5.0 | 5.0 | 5.0 | 5.0 |
| | Hydroxide | | | | | | | | | | |
| Water | Aqua | qs to | qs to | qs to | qs to | qs to | qs to | qs to | qs to | qs to | qs to |
| | | 100 | 100 | 100 | 100 | 100 | 100 | 100 | 100 | 100 | 100 |

(XIV) Wet wipes 1

| | INCI Name/ | 1 | 2 | 3 | 4 | 5 | 6 | 7 | 8 | 9 | 10 |
|---|---|---|---|---|---|---|---|---|---|---|---|
| Trade name | Chemical name | % w/w | % w/w | % w/w | % w/w | % w/w | % w/w | % w/w | % w/w | % w/w | % w/w |
| Antimicrobial | | 0.001 | 0.01 | 0.1 | 0.5 | 1 | 0.001 | 0.01 | 0.1 | 0.5 | 1 |
| agent | | | | | | | | | | | |
| Compound of | | 0.05 | 0.05 | 0.05 | 0.05 | 0.05 | 0.05 | 0.05 | 0.05 | 0.05 | 0.05 |
| formula (I) | | | | | | | | | | | |
| Solvent | | — | — | — | — | — | 3 | 3 | 3 | 3 | 3 |
| Propyleneglycol | 1,2-Propandiol | 10.00 | 10.00 | 10.00 | 10.00 | 10.00 | 10.00 | 10.00 | 10.00 | 10.00 | 10.00 |
| Texapon ® K12 | Sodium Lauryl | 1.00 | 1.00 | 1.00 | 1.00 | 1.00 | 1.00 | 1.00 | 1.00 | 1.00 | 1.00 |
| (BASF) | Sulfate | | | | | | | | | | |
| Citric Acid | Citric Acid | 3.00 | 3.00 | 3.00 | 3.00 | 3.00 | 3.00 | 3.00 | 3.00 | 3.00 | 3.00 |
| Perfume | | qs | qs | qs | qs | qs | qs | qs | qs | qs | qs |
| Sodium Hydroxide | Water (and) | ad pH | ad pH | ad pH | ad pH | ad pH | ad pH | ad pH | ad pH | ad pH | ad pH |
| (10% solution) | Sodium | 5.5 | 5.5 | 5.5 | 5.5 | 5.5 | 5.5 | 5.5 | 5.5 | 5.5 | 5.5 |
| | Hydroxide | | | | | | | | | | |
| Water | Aqua | qs to | qs to | qs to | qs to | qs to | qs to | qs to | qs to | qs to | qs to |
| | | 100 | 100 | 100 | 100 | 100 | 100 | 100 | 100 | 100 | 100 |

(XV) Wet wipes 2

| | INCI Name/ | 1 | 2 | 3 | 4 | 5 | 6 | 7 | 8 | 9 | 10 |
|---|---|---|---|---|---|---|---|---|---|---|---|
| Trade name | Chemical name | % w/w | % w/w | % w/w | % w/w | % w/w | % w/w | % w/w | % w/w | % w/w | % w/w |
| Antimicrobial | | 0.001 | 0.01 | 0.1 | 0.5 | 1 | 0.001 | 0.01 | 0.1 | 0.5 | 1 |
| agent | | | | | | | | | | | |
| Compound of | | 0.05 | 0.05 | 0.05 | 0.05 | 0.05 | 0.05 | 0.05 | 0.05 | 0.05 | 0.05 |
| formula (I) | | | | | | | | | | | |
| Solvent | | — | — | — | — | — | 3 | 3 | 3 | 3 | 3 |
| Propylen glycol | 1,2-Propane- | 10.00 | 10.00 | 10.00 | 10.00 | 10.00 | 10.00 | 10.00 | 10.00 | 10.00 | 10.00 |
| | diol | | | | | | | | | | |
| Glucopon ® 215 | Alkyl | 2.00 | 2.00 | 2.00 | 2.00 | 2.00 | 2.00 | 2.00 | 2.00 | 2.00 | 2.00 |
| CS UP (BASF) | Polyglycoside | | | | | | | | | | |
| Water | Aqua | qs to | qs to | qs to | qs to | qs to | qs to | qs to | qs to | qs to | qs to |
| | | 100 | 100 | 100 | 100 | 100 | 100 | 100 | 100 | 100 | 100 |
| Citric Acid | Citric Acid | 1.00 | 1.00 | 1.00 | 1.00 | 1.00 | 1.00 | 1.00 | 1.00 | 1.00 | 1.00 |
| Sodium Hydroxide | Water (and) | ad pH | ad pH | lad pH | ad pH | ad pH | ad pH | ad pH | ad pH | ad pH | ad pH |
| (10% solution) | Sodium | 5.0 | 5.0 | 15.0 | 5.0 | 5.0 | 5.0 | 5.0 | 5.0 | 5.0 | 5.0 |
| | Hydroxide | | | | | | | | | | |

(XVI) Wet Wipes 3 (for personal care)

| | INCI Name/ | 1 | 2 | 3 | 4 | 5 | 6 | 7 | 8 | 9 | 10 |
|---|---|---|---|---|---|---|---|---|---|---|---|
| Trade name | Chemical name | % w/w | % w/w | % w/w | % w/w | % w/w | % w/w | % w/w | % w/w | % w/w | % w/w |
| Antimicrobial | | 0.001 | 0.01 | 0.1 | 0.5 | 1 | 0.001 | 0.01 | 0.1 | 0.5 | 1 |
| agent | | | | | | | | | | | |
| Compound of | | 0.05 | 0.05 | 0.05 | 0.05 | 10.05 | 0.05 | 0.05 | 0.05 | 0.05 | 0.05 |
| formula (I) | | | | | | | | | | | |
| Solvent | | — | — | — | — | — | 3 | 3 | 3 | 3 | 3 |
| Glycerine | Glycerine | 0.5 | 0.5 | 0.5 | 0.5 | 0.5 | 0.5 | 0.5 | 0.5 | 0.5 | 0.5 |
| Tween 20 | Polysorbate 20 | 0.6 | 0.6 | 0.6 | 0.6 | 0.6 | 0.6 | 0.6 | 0.6 | 0.6 | 0.6 |
| Miranol C2M | Na₂- | 0.2 | 0.2 | 10.2 | 0.2 | 10.2 | 0.2 | 0.2 | 0.2 | 0.2 | 0.2 |
| | cocoamphodiacetate | | | | | | | | | | |
| Vitamin E | Tocopherol | 0.05 | 0.05 | 0.05 | 0.05 | 0.05 | 0.05 | 0.05 | 0.05 | 0.05 | 0.05 |
| Panthenol | Panthenol | 0.05 | 0.05 | 0.05 | 0.05 | 0.05 | 0.05 | 0.05 | 0.05 | 0.05 | 0.05 |
| Water | Aqua | qs to | qs to | qs to | qs to | qs to | qs to | qs to | qs to | qs to | qs to |
| | | 100 | 100 | 100 | 100 | 100 | 100 | 100 | 100 | 100 | 100 |
| Sodium citrate | Sodium citrate | ad pH | ad pH | ad pH | ad pH | ad pH | ad pH | ad pH | ad pH | ad pH | ad pH |
| | | 5.0 | 5.0 | 5.0 | 5.0 | 5.0 | 5.0 | 5.0 | 5.0 | 5.0 | 5.0 |

(XVII) Window Cleaner

| | INCI Name/ | 1 | 2 | 3 | 4 | 5 | 6 | 7 | 8 | 9 | 10 |
|---|---|---|---|---|---|---|---|---|---|---|---|
| Trade name | Chemical name | % w/w | % w/w | % w/w | % w/w | % w/w | % w/w | % w/w | % w/w | % w/w | % w/w |
| Antimicrobial | | 0.001 | 0.01 | 0.1 | 0.5 | 1 | 0.001 | 0.01 | 0.1 | 0.5 | 1 |
| agent | | | | | | | | | | | |
| Compound of | | 0.05 | 0.05 | 0.05 | 0.05 | 0.05 | 0.05 | 0.05 | 0.05 | 0.05 | 0.05 |
| formula (I) | | | | | | | | | | | |
| Solvent | | — | — | — | — | — | 3 | 3 | 3 | 3 | 3 |
| Ethanol | Ethylalcohol | 10.00 | 10.00 | 10.00 | 10.00 | 10.00 | 10.00 | 10.00 | 10.00 | 10.00 | 10.00 |
| | Alcohol | | | | | | | | | | |
| Glucopon ® 215 | Alkyl | 2.00 | 2.00 | 2.00 | 2.00 | 2.00 | 2.00 | 2.00 | 2.00 | 2.00 | 2.00 |
| CS UP (BASF) | Polyglycoside | | | | | | | | | | |
| Perfume | | qs | qs | qs | qs | qs | qs | qs | qs | qs | qs |
| Water | Aqua | qs to | qs to | qs to | qs to | qs to | qs to | qs to | qs to | qs to | qs to |
| | | 100 | 100 | 100 | 100 | 100 | 100 | 100 | 100 | 100 | 100 |
| Citric Acid | Citric Acid | 1.00 | 1.00 | 1.00 | 1.00 | 1.00 | 1.00 | 1.00 | 1.00 | 1.00 | 1.00 |
| Sodium Hydroxide | Water (and) | ad pH | ad pH | ad pH | ad pH | ad pH | ad pH | ad pH | ad pH | ad pH | ad pH |
| (10% solution) | Sodium | 5.0 | 5.0 | 5.0 | 5.0 | 5.0 | 5.0 | 5.0 | 5.0 | 5.0 | 5.0 |
| | Hydroxide | | | | | | | | | | |

(XVIII) Toilet cleaner

| | INCI Name/ | 1 | 2 | 3 | 4 | 5 | 6 | 7 | 8 | 9 | 10 |
|---|---|---|---|---|---|---|---|---|---|---|---|
| Trade name | Chemical name | % w/w | % w/w | % w/w | % w/w | % w/w | % w/w | % w/w | % w/w | % w/w | % w/w |
| Antimicrobial | | 0.001 | 0.01 | 0.1 | 0.5 | 1 | 10.001 | 10.01 | 0.1 | 0.5 | 1 |
| agent | | | | | | | | | | | |
| Compound of | | 0.05 | 0.05 | 0.05 | 0.05 | 0.05 | 0.05 | 0.05 | 0.05 | 0.05 | 0.05 |
| formula (I) | | | | | | | | | | | |
| Solvent | | — | — | — | — | — | 3 | 3 | 3 | 3 | 3 |
| Glucopon ® 215 | Alkyl | 3.50 | 3.50 | 3.50 | 3.50 | 3.50 | 3.50 | 3.50 | 3.50 | 3.50 | 3.50 |
| CS UP (BASF) | Polyglycoside | | | | | | | | | | |
| Neodol 91-8E | C9-11 pareth-8 | 1.70 | 1.70 | 1.70 | 1.70 | 1.70 | 1.70 | 1.70 | 1.70 | 1.70 | 1.70 |
| RHEOVIS ® CSP | Cationic | 1.30 | 1.30 | 1.30 | 1.30 | 1.30 | 1.30 | 1.30 | 1.30 | 1.30 | 1.30 |
| (BASF) | Polymer | | | | | | | | | | |
| Acetic Acid conc. | Acetic Acid | 2.40 | 2.40 | 2.40 | 2.40 | 2.40 | 2.40 | 2.40 | 2.40 | 2.40 | 2.40 |
| Citric Acid | Citric Acid | 9.00 | 9.00 | 9.00 | 9.00 | 9.00 | 9.00 | 9.00 | 9.00 | 9.00 | 9.00 |
| IRAGON ® Blue | Acid blue 80 | 0.50 | 0.50 | 0.50 | 0.50 | 0.50 | 0.50 | 0.50 | 0.50 | 0.50 | 0.50 |
| ABL80 sol. 1% | | | | | | | | | | | |
| (BASF) | | | | | | | | | | | |
| Water | Aqua | qs to | qs to | qs to | qs to | qs to | qs to | qs to | qs to | qs to | qs to |
| | | 100 | 100 | 100 | 100 | 100 | 100 | 100 | 100 | 100 | 100 |

(XIX) Shoe deodorant

| | INCI Name/ | 1 | 2 | 3 | 4 | 5 | 6 | 7 | 8 | 9 | 10 |
|---|---|---|---|---|---|---|---|---|---|---|---|
| Trade name | Chemical name | % w/w | % w/w | % w/w | % w/w | % w/w | % w/w | % w/w | % w/w | % w/w | % w/w |
| Antimicrobial | | 0.001 | 0.01 | 0.1 | 0.5 | 1 | 0.001 | 0.01 | 0.1 | 0.5 | 1 |
| agent | | | | | | | | | | | |
| Compound of | | 0.05 | 0.05 | 0.05 | 0.05 | 0.05 | 0.05 | 0.05 | 0.05 | 0.05 | 0.05 |
| formula (I) | | | | | | | | | | | |
| Solvent | | — | — | — | — | — | 3 | 3 | 3 | 3 | 3 |
| Ethanol absolut. | ethanol | 10 | 10 | 10 | 10 | 10 | 10 | 10 | 10 | 10 | 10 |
| Propylene Glycol | 1,2- | 15 | 15 | 15 | 15 | 15 | 15 | 15 | 15 | 15 | 15 |
| | Propanediol | | | | | | | | | | |
| Marlipal 24/99 | Laureth-9 | 1.00 | 1.00 | 1.00 | 1.00 | 1.00 | 1.00 | 1.00 | 1.00 | 1.00 | 1.00 |
| (Sasol) | | | | | | | | | | | |
| Glycerine | Glycerine | 1.00 | 1.00 | 1.00 | 1.00 | 1.00 | 1.00 | 1.00 | 1.00 | 1.00 | 1.00 |
| Perfume | | qs | qs | qs | qs | qs | qs | qs | qs | qs | qs |
| Water | Aqua | qs to | qs to | qs to | qs to | qs to | qs to | qs to | qs to | qs to | qs to |
| | | 100 | 100 | 100 | 100 | 100 | 100 | 100 | 100 | 100 | 100 |

(XX) Dishwashing liquid 1

| | INCI Name/ | 1 | 2 | 3 | 4 | 5 | 6 | 7 | 8 | 9 | 10 |
|---|---|---|---|---|---|---|---|---|---|---|---|
| Trade name | Chemical name | % w/w | % w/w | % w/w | % w/w | % w/w | % w/w | % w/w | % w/w | % w/w | % w/w |
| Antimicrobial | | 0.001 | 0.01 | 0.1 | 1 | 2 | 0.001 | 0.01 | 0.1 | 1 | 2 |
| agent | | | | | | | | | | | |
| Compound of | | 1 | 1 | 1 | 1 | 1 | 1 | 1 | 1 | 1 | 1 |
| formula (I) | | | | | | | | | | | |
| Solvent | | — | — | — | — | — | 2 | 2 | 2 | 2 | 2 |
| Texapon K 14 | Sodium Myreth | 2.5 | 2.5 | 2.5 | 2.5 | 2.5 | 2.5 | 2.5 | 2.5 | 2.5 | 2.5 |
| Special (BASF) | Sulfate | | | | | | | | | | |
| Texapon ® LS 35 | Lauryl-myristyl | 3 | 3 | 3 | 3 | 3 | 3 | 3 | 3 | 3 | 3 |
| (BASF) | sulfate Na-salt | | | | | | | | | | |
| Dehyton AB 30 | Coco Betaine | 0.9 | 0.9 | 0.9 | 0.9 | 0.9 | 0.9 | 0.9 | 0.9 | 0.9 | 0.9 |
| (BASF) | | | | | | | | | | | |
| Plantacare 1200 | Lauryl | 1.5 | 1.5 | 1.5 | 1.5 | 1.5 | 1.5 | 1.5 | 1.5 | 1.5 | 1.5 |
| UP (BASF) | Glycoside | | | | | | | | | | |
| SD Alcohol 39-C | alcohol | 1 | 1 | 1 | 1 | 1 | 1 | 1 | 1 | 1 | 1 |
| (Berkel) | | | | | | | | | | | |
| Sodium Chloride | Sodium | 0.6 | 0.6 | 0.6 | 0.6 | 0.6 | 0.6 | 0.6 | 0.6 | 0.6 | 0.6 |
| | Chloride | | | | | | | | | | |
| Perfume | | qs | qs | qs | qs | qs | qs | qs | sb | qs | qs |
| Trisodium Citrate | Trisodium | To pH | To pH | To pH | To pH | To pH | To pH | To pH | To pH | To pH | To pH |
| Dihydrate | Citrate | 6 | 6 | 6 | 6 | 6 | 6 | 6 | 6 | 6 | 6 |
| | Dihydrate | | | | | | | | | | |
| Water | Aqua | qs to | qs to | qs to | qs to | qs to | qs to | qs to | qs to | qs to | qs to |
| | | 100 | 100 | 100 | 100 | 100 | 100 | 100 | 100 | 100 | 100 |

(XXI) Dishwashing Liquid 2

| | INCI Name/ | | | | | | | | | | |
|---|---|---|---|---|---|---|---|---|---|---|---|
| | Chemical | 1 | 2 | 3 | 4 | 5 | 6 | 7 | 8 | 9 | 10 |
| Trade name | name | % w/w | % w/w | % w/w | % w/w | % w/w | % w/w | % w/w | % w/w | % w/w | % w/w |
| Antimicrobial | | 0.001 | 0.01 | 0.1 | 1 | 2 | 0.001 | 0.01 | 0.1 | 1 | 2 |
| agent | | | | | | | | | | | |
| Compound of | | 1 | 1 | 1 | 1 | 1 | 1 | 1 | 1 | 1 | 1 |
| formula (I) | | | | | | | | | | | |
| Solvent | | — | — | — | — | — | 2 | 2 | 2 | 2 | 2 |
| Marlon A 375 | Sodium Dode- | 7.00 | 7.00 | 7.00 | 7.00 | 7.00 | 7.00 | 7.00 | 7.00 | 7.00 | 7.00 |
| (Sasol) | cylbenzenesul- | | | | | | | | | | |
| | fonate | | | | | | | | | | |
| Plantacare 1200 | Lauryl Glyco- | 3 | 3 | 3 | 3 | 3 | 3 | 3 | 3 | 3 | 3 |
| UP (BASF) | side | | | | | | | | | | |
| Citric Acid | Citric Acid | 3.00 | 3.00 | 3.00 | 3.00 | 3.00 | 3.00 | 3.00 | 3.00 | 3.00 | 3.00 |
| Sodium Chloride | Sodium | 1.00 | 1.00 | 1.00 | 1.00 | 1.00 | 1.00 | 1.00 | 1.00 | 1.00 | 1.00 |
| | Chloride | | | | | | | | | | |
| Sodium Sulfate | Sodium Sulfate | 3.50 | 3.50 | 3.50 | 3.50 | 3.50 | 3.50 | 3.50 | 3.50 | 3.50 | 3.50 |
| Sodium Hydrox- | Water (and) | ad pH | ad pH | ad pH | ad pH | ad pH | ad pH | ad pH | ad pH | ad pH | ad pH |
| ide (30% solution) | Sodium Hydro- | 5.0 | 5.0 | 5.0 | 5.0 | 5.0 | 5.0 | 5.0 | 5.0 | 5.0 | 5.0 |
| | xide | | | | | | | | | | |
| Water | Aqua | qs to | qs to | qs to | qs to | qs to | qs to | qs to | qs to | qs to | qs to |
| | | 100 | 100 | 100 | 100 | 100 | 100 | 100 | 100 | 100 | 100 |

(XXII) Dish washing liquid 3

| | INCI Name/ | | 1 | 2 | 3 | 4 | 5 | 6 | 7 | 8 | 9 |
|---|---|---|---|---|---|---|---|---|---|---|---|
| Trade name | Chemical name | % w/w | % w/w | % w/w | % w/w | % w/w | % w/w | % w/w | % w/w | % w/w | % w/w |
| Antimicrobial | | 0.001 | 0.01 | 0.1 | 1 | 2 | 0.001 | 0.01 | 0.1 | 1 | 2 |
| agent | | | | | | | | | | | |
| Compound of | | 1 | 1 | 1 | 1 | 1 | 1 | 1 | 1 | 1 | 1 |
| formula (I) | | | | | | | | | | | |
| Solvent | | — | — | — | — | — | 2 | 2 | 2 | 2 | 2 |
| Marlon A 375 | Sodium Dode- | 7.00 | 7.00 | 7.00 | 7.00 | 7.00 | 7.00 | 7.00 | 7.00 | 7.00 | 7.00 |
| (Sasol) | cylbenzenesul- | | | | | | | | | | |
| | fonate | | | | | | | | | | |
| Texapon NSO | Sodium Laureth | 5.00 | 5.00 | 5.00 | 5.00 | 5.00 | 5.00 | 5.00 | 5.00 | 5.00 | 5.00 |
| (BASF) | Sulfate | | | | | | | | | | |
| Citric Acid | Citric Acid | 3.00 | 3.00 | 3.00 | 3.00 | 3.00 | 3.00 | 3.00 | 3.00 | 3.00 | 3.00 |
| Sodium Hydrox- | Water (and) | ad pH | ad pH | ad pH | ad pH | ad pH | ad pH | ad pH | ad pH | ad pH | ad pH |
| ide (30% solution) | Sodium Hydrox- | 5.0 | 5.0 | 5.0 | 5.0 | 5.0 | 5.0 | 5.0 | 5.0 | 5.0 | 5.0 |
| | ide | | | | | | | | | | |
| Water | Aqua | qs to | qs to | qs to | qs to | qs to | qs to | qs to | qs to | qs to | qs to |
| | | 100 | 100 | 100 | 100 | 100 | 100 | 100 | 100 | 100 | 100 |

(XXIII) Dishwashing liquid 4

| | INCI Name/ | | | | | | | | | | |
|---|---|---|---|---|---|---|---|---|---|---|---|
| | Chemical | 1 | 2 | 3 | 4 | 5 | 6 | 7 | 8 | 9 | 10 |
| Trade name | name | % w/w | % w/w | % w/w | % w/w | % w/w | % w/w | % w/w | % w/w | % w/w | % w/w |
| Antimicrobial | | 0.001 | 0.01 | 0.1 | 1 | 2 | 0.001 | 0.01 | 0.1 | 1 | 2 |
| agent | | | | | | | | | | | |
| Compound of | | 1 | 1 | 1 | 1 | 1 | 1 | 1 | 1 | 1 | 1 |
| formula (I) | | | | | | | | | | | |
| Solvent | | — | — | — | — | — | 2 | 2 | 2 | 2 | 2 |
| Texapon ® LS 35 | Lauryl-myristyl | 7.00 | 7.00 | 7.00 | 7.00 | 7.00 | 7.00 | 7.00 | 7.00 | 7.00 | 7.00 |
| (BASF) | sulfate Na-salt | | | | | | | | | | |
| Texapon ® K14 | Sodium Myreth | 7.00 | 7.00 | 7.00 | 7.00 | 7.00 | 7.00 | 7.00 | 7.00 | 7.00 | 7.00 |
| Special (BASF) | Sulfate | | | | | | | | | | |
| Plantacare ® 1200 | Lauryl Gluco- | 4.00 | 4.00 | 4.00 | 4.00 | 4.00 | 4.00 | 4.00 | 4.00 | 4.00 | 4.00 |
| UP (BASF) | side | | | | | | | | | | |
| Dehyton ® AB 30 | Coco Betaine | 1.1 | 1.1 | 1.1 | 1.1 | 1.1 | 1.1 | 1.1 | 1.1 | 1.1 | 1.1 |
| (BASF) | | | | | | | | | | | |
| SD Alcohol 39-C | Alcohol | 5.00 | 5.00 | 5.00 | 5.00 | 5.00 | 5.00 | 5.00 | 5.00 | 5.00 | 5.00 |
| (Berkel) | | | | | | | | | | | |
| Sodium Chloride | Sodium Chlor- | 1.00 | 1.00 | 1.00 | 1.00 | 1.00 | 1.00 | 1.00 | 1.00 | 1.00 | 1.00 |
| | ide | | | | | | | | | | |
| Citric Acid | Citric Acid | ad pH | ad pH | ad pH | ad pH | ad pH | ad pH | ad pH | ad pH | ad pH | ad pH |
| | | 6.5 | 6.5 | 6.5 | 6.5 | 6.5 | 6.5 | 6.5 | 6.5 | 6.5 | 6.5 |
| Water | Aqua | qs to | qs to | qs to | qs to | qs to | qs to | qs to | qs to | qs to | qs to |
| | | 100 | 100 | 100 | 100 | 100 | 100 | 100 | 100 | 100 | 100 |

(XXIV) Liquid Laundry Detergent 1

| | INCI Name/ | | | | | | | | | | |
|---|---|---|---|---|---|---|---|---|---|---|---|
| | Chemical | 1 | 2 | 3 | 4 | 5 | 6 | 7 | 8 | 9 | 10 |
| Trade name | name | % w/w | % w/w | % w/w | % w/w | % w/w | % w/w | % w/w | % w/w | % w/w | % w/w |
| Antimicrobial | | 0.001 | 0.01 | 0.1 | 1 | 2 | 0.001 | 0.01 | 0.1 | 1 | 2 |
| agent | | | | | | | | | | | |
| Compound of | | 1 | 1 | 1 | 1 | 1 | 1 | 1 | 1 | 1 | 1 |
| formula (I) | | | | | | | | | | | |
| Solvent | | — | — | — | — | — | 2 | 2 | 2 | 2 | 2 |
| Marlon A 375 | Sodium Dode- | 10 | 10 | 10 | 10 | 10 | 10 | 10 | 10 | 10 | 10 |
| (Sasol) | cylbenzenesul- | | | | | | | | | | |
| | fonate | | | | | | | | | | |
| Neodol 45-7 E | C14-15 Pareth- | 7 | 7 | 7 | 7 | 7 | 7 | 7 | 7 | 7 | 7 |
| (Shell Chemicals) | 7 | | | | | | | | | | |
| SD Alcohol 39-C | Alcohol | 9.00 | 9.00 | 9.00 | 9.00 | 9.00 | 9.00 | 9.00 | 9.00 | 9.00 | 9.00 |
| (Berkel) | | | | | | | | | | | |
| Soap Base | Sodium Tal- | 5 | 5 | 5 | 5 | 5 | 5 | 5 | 5 | 5 | 5 |
| (Mettler) | lowate (and) | | | | | | | | | | |
| | Sodium Co- | | | | | | | | | | |
| | coate | | | | | | | | | | |
| Trisodium Citrate | Trisodium | 4.00 | 4.00 | 4.00 | 4.00 | 4.00 | 4.00 | 4.00 | 4.00 | 4.00 | 4.00 |
| Dihydrate | Citrate Dihy- | | | | | | | | | | |
| | drate | | | | | | | | | | |
| Triethanolamine | Triethano- | 5.00 | 5.00 | 5.00 | 5.00 | 5.00 | 5.00 | 5.00 | 5.00 | 5.00 | 5.00 |
| | lamine | | | | | | | | | | |
| Tinopal ® CBS-X | Fluorescent | 0.10 | 0.10 | 0.10 | 0.10 | 0.10 | 0.10 | 0.10 | 0.10 | 0.10 | 0.10 |
| (BASF) | Whitening | | | | | | | | | | |
| | Agent (FWA) | | | | | | | | | | |
| Perfume | | qs | qs | qs | qs | qs | qs | qs | qs | qs | qs |
| Water | Aqua | qs to | qs to | qs to | qs to | qs to | qs to | qs to | qs to | qs to | qs to |
| | | 100 | 100 | 100 | 100 | 100 | 100 | 100 | 100 | 100 | 100 |

(XXV) Liquid Detergent 2

| | INCI Name/ | | | | | | | | | | |
|---|---|---|---|---|---|---|---|---|---|---|---|
| | Chemical | 1 | 2 | 3 | 4 | 5 | 6 | 7 | 8 | 9 | 10 |
| Trade name | name | % w/w | % w/w | % w/w | % w/w | % w/w | % w/w | % w/w | % w/w | % w/w | % w/w |
| Antimicrobial | | 0.001 | 0.01 | 0.1 | 1 | 2 | 0.001 | 0.01 | 0.1 | 1 | 2 |
| agent | | | | | | | | | | | |
| Compound of | | 1 | 1 | 1 | 1 | 1 | 1 | 1 | 1 | 1 | 1 |
| formula (I) | | | | | | | | | | | |
| Solvent | | — | — | — | — | — | 2 | 2 | 2 | 2 | 2 |
| Nansa SSA/A | Dodecylben- | 8 | 8 | 8 | 8 | 8 | 8 | 8 | 8 | 8 | 8 |
| (Albright & Wil- | zene Sulfonic | | | | | | | | | | |
| son/Rhodia) | Acid | | | | | | | | | | |
| Edenor ® K12-18 | Coconut Fatty | 3 | 3 | 3 | 3 | 3 | 3 | 3 | 3 | 3 | 3 |
| (BASF) | Acid | | | | | | | | | | |
| Neodol 23-6, 5 E | C12-13 Pareth- | 2 | 2 | 2 | 2 | 2 | 2 | 2 | 2 | 2 | 2 |
| (Shell Chemicals) | 7 | | | | | | | | | | |
| Elfan NS 243 S | Sodium Lau- | 4 | 4 | 4 | 4 | 4 | 4 | 4 | 4 | 4 | 4 |
| (Akzo Nobel) | reth Sulfate 3 | | | | | | | | | | |
| | EO | | | | | | | | | | |
| Trisodium Citrate | Trisodium | 2 | 2 | 2 | 2 | 2 | 2 | 2 | 2 | 2 | 2 |
| Dihydrate | Citrate Dihy- | | | | | | | | | | |
| | drate | | | | | | | | | | |
| Sodium Hydro- | Water (and) | To pH 8 | To pH 8 | To pH 8 | To pH 8 | To pH 8 | To pH 8 | To pH 8 | To pH 8 | To pH 8 | To pH 8 |
| xide | Sodium Hydro- | | | | | | | | | | |
| (30% solution) | xide | | | | | | | | | | |
| Water and Per- | Aqua | qs to | qs to | qs to | qs to | qs to | qs to | qs to | qs to | qs to | qs to |
| fume | | 100 | 100 | 100 | 100 | 100 | 100 | 100 | 100 | 100 | 100 |

(XXVI) Liquid Laundry Detergent 3

| | INCI Name/ | | | | | | | | | | |
|---|---|---|---|---|---|---|---|---|---|---|---|
| | Chemical | 1 | 2 | 3 | 4 | 5 | 6 | 7 | 8 | 9 | 10 |
| Trade name | name | % w/w | % w/w | % w/w | % w/w | % w/w | % w/w | % w/w | % w/w | % w/w | % w/w |
| Antimicrobial | | 0.001 | 0.01 | 0.1 | 1 | 2 | 0.001 | 0.01 | 0.1 | 1 | 2 |
| agent | | | | | | | | | | | |
| Compound of | | 1 | 1 | 1 | 1 | 1 | 1 | 1 | 1 | 1 | 1 |
| formula (I) | | | | | | | | | | | |
| Solvent | | — | — | — | — | — | 2 | 2 | 2 | 2 | 2 |
| Marlon A 375 | Sodium Dode- | 7 | 7 | 7 | 7 | 7 | 7 | 7 | 7 | 7 | 7 |
| (Sasol) | cylbenzenesul- | | | | | | | | | | |
| | fonate | | | | | | | | | | |
| Marlipal O | Trideceth-12 | 5 | 5 | 5 | 5 | 5 | 5 | 5 | 5 | 5 | 5 |
| 13/129 (Sasol) | | | | | | | | | | | |
| Penta Sodium | Penta Sodium | 10 | 10 | 10 | 10 | 10 | 10 | 10 | 10 | 10 | 10 |
| Triphosphate | Triphosphate | | | | | | | | | | |
| Sodium Sulfate | Sodium Sulfate | 1 | 1 | 1 | 1 | 1 | 1 | 1 | 1 | 1 | 1 |
| Sodium Hydro- | Water (and) | To pH 9 | To pH 9 | To pH 9 | To pH 9 | To pH 9 | To pH 9 | To pH 9 | To pH 9 | To pH 9 | To pH 9 |
| xide (10% | Sodium Hydro- | | | | | | | | | | |
| solution) | xide | | | | | | | | | | |
| Glycerin | Glycerin | 2 | 2 | 2 | 2 | 2 | 2 | 2 | 2 | 2 | 2 |
| Oleic Acid | Oleic Acid | 1 | 1 | 1 | 1 | 1 | 1 | 1 | 1 | 1 | 1 |
| Tylose C 10000 | Cellulose Gum | 0.1 | 0.1 | 0.1 | 0.1 | 0.1 | 0.1 | 0.1 | 0.1 | 0.1 | 0.1 |
| (Clariant) | | | | | | | | | | | |
| Water and Per- | Aqua | qs to | qs to | qs to | qs to | qs to | qs to | qs to | qs to | qs to | qs to |
| fume | | 100 | 100 | 100 | 100 | 100 | 100 | 100 | 100 | 100 | 100 |

(XXVII) Liquid Laundry Detergent 4

| | INCI Name/ | | | | | | | | | | |
|---|---|---|---|---|---|---|---|---|---|---|---|
| | Chemical | 1 | 2 | 3 | 4 | 5 | 6 | 7 | 8 | 9 | 10 |
| Trade name | name | % w/w | % w/w | % w/w | % w/w | % w/w | % w/w | % w/w | % w/w | % w/w | % w/w |
| Antimicrobial | | 0.001 | 0.01 | 0.1 | 1 | 2 | 0.001 | 0.01 | 0.1 | 1 | 2 |
| agent | | | | | | | | | | | |
| Compound of | | 1 | 1 | 1 | 1 | 1 | 1 | 1 | 1 | 1 | 1 |
| formula (I) | | | | | | | | | | | |
| Solvent | | — | — | — | — | — | 2 | 2 | 2 | 2 | 2 |
| Wilfarin DK-1218 | Soap | 5 | 5 | 5 | 5 | 5 | 5 | 5 | 5 | 5 | 5 |
| (Wilmar Ltd.) | | | | | | | | | | | |
| Monoethano- | | To pH 8 | To pH 8 | To pH 8 | To pH 8 | To pH 8 | To pH 8 | To pH 8 | To pH 8 | To pH 8 | To pH |
| amine | | | | | | | | | | | 7.5-9.0 |
| Maranil DBS/LC | LABS | 11 | 11 | 11 | 11 | 11 | 11 | 11 | 11 | 11 | 11 |
| (BASF) | | | | | | | | | | | |
| Texapon N705 | Ethersulfate | 4 | 4 | 4 | 4 | 4 | 4 | 4 | 4 | 4 | 4 |
| (BASF) | | | | | | | | | | | |
| Lutensol AO 7 | Nonionic | 2 | 2 | 2 | 2 | 2 | 2 | 2 | 2 | 2 | 2 |
| (BASF) | Surfactant | | | | | | | | | | |
| Sodium-Citrate | | 1 | 1 | 1 | 1 | 1 | 1 | 1 | 1 | 1 | 1 |
| Lavergy Pro 104 | Enzyme | 0.1 | 0.1 | 0.1 | 0.1 | 0.1 | 0.1 | 0.1 | 0.1 | 0.1 | 0.1 |
| LS (BASF) | | | | | | | | | | | |
| Cublen NCD 732 | Phosphonate | 0.1 | 0.1 | 0.1 | 0.1 | 0.1 | 0.1 | 0.1 | 0.1 | 0.1 | 0.1 |
| (Zim- | | | | | | | | | | | |
| mer&Schwarz) | | | | | | | | | | | |
| Water and | Aqua | qs to | qs to | qs to | qs to | qs to | qs to | qs to | qs to | qs to | qs to |
| Perfume | | 100 | 100 | 100 | 100 | 100 | 100 | 100 | 100 | 100 | 100 |

(XXVIII) Fabric Softener 1

| | INCI Name/ | | | | | | | | | | |
|---|---|---|---|---|---|---|---|---|---|---|---|
| | Chemical | 1 | 2 | 3 | 4 | 5 | 6 | 7 | 8 | 9 | 10 |
| Trade name | name | % w/w | % w/w | % w/w | % w/w | % w/w | % w/w | % w/w | % w/w | % w/w | % w/w |
| Antimicrobial | | 0.001 | 0.01 | 0.1 | 0.5 | 1 | 0.001 | 0.01 | 0.1 | 0.5 | 1 |
| agent | | | | | | | | | | | |
| Compound of | | 0.05 | 0.05 | 0.05 | 0.05 | 0.05 | 0.05 | 0.05 | 0.05 | 0.05 | 0.05 |
| formula (I) | | | | | | | | | | | |
| Solvent | | — | — | — | — | — | 3 | 3 | 3 | 3 | 3 |
| Neodol 25-7 E | C12-15 Pareth- | 0.50 | 0.50 | 0.50 | 0.50 | 0.50 | 0.50 | 0.50 | 0.50 | 0.50 | 0.50 |
| (Shell Chemicals) | 7 | | | | | | | | | | |
| Arquad 2HT-75 | Quaternium 18 | 4.00 | 4.00 | 4.00 | 4.00 | 4.00 | 4.00 | 4.00 | 4.00 | 4.00 | 4.00 |
| (Akzo Nobel) | (and) Isopropyl | | | | | | | | | | |
| | Alcohol | | | | | | | | | | |
| Perfume + dye | | qs | qs | qs | qs | qs | qs | qs | qs | qs | qs |
| Water | Aqua | qs to | qs to | qs to | qs to | qs to | qs to | qs to | qs to | qs to | qs to |
| | | 100 | 100 | 100 | 100 | 100 | 100 | 100 | 100 | 100 | 100 |

(XXIX) Fabric Softener 2

| | INCI Name/ | | | | | | | | | | |
|---|---|---|---|---|---|---|---|---|---|---|---|
| | Chemical | 1 | 2 | 3 | 4 | 5 | 6 | 7 | 8 | 9 | 10 |
| Trade name | name | % w/w | % w/w | % w/w | % w/w | % w/w | % w/w | % w/w | % w/w | % w/w | % w/w |
| Antimicrobial | | 0.001 | 0.01 | 0.1 | 0.5 | 1 | 0.001 | 0.01 | 0.1 | 0.5 | 1 |
| agent | | | | | | | | | | | |
| Compound of | | 0.05 | 0.05 | 0.05 | 0.05 | 0.05 | 0.05 | 0.05 | 0.05 | 0.05 | 0.05 |
| formula (I) | | | | | | | | | | | |
| Solvent | | — | — | — | — | — | 3 | 3 | 3 | 3 | 3 |
| Rewoquat WE 18 | Dihydrogen- | 4.00 | 4.00 | 4.00 | 4.00 | 4.00 | 4.00 | 4.00 | 4.00 | 4.00 | 4.00 |
| (Evonic) | ated Tallowethyl | | | | | | | | | | |
| | Hydroxyethyl- | | | | | | | | | | |
| | amonium | | | | | | | | | | |
| Neodol 25-7 E | C12-15 Pareth- | 0.50 | 0.50 | 0.50 | 0.50 | 0.50 | 0.50 | 0.50 | 0.50 | 0.50 | 0.50 |
| (Shell Chemicals) | 7 | | | | | | | | | | |
| Antifoam DB 31 | | 0.10 | 0.10 | qs | qs | qs | qs | qs | qs | qs | qs |
| (Dow Corning) | | | | | | | | | | | |
| Perfume + dye | | qs | qs | qs | qs | qs | qs | qs | qs | qs | qs |
| Water | Aqua | qs to | qs to | qs to | qs to | qs to | qs to | qs to | qs to | qs to | qs to |
| | | 100 | 100 | 100 | 100 | 100 | 100 | 100 | 100 | 100 | 100 |

(XXX) Fabric Softener 3

| | INCI Name/ | | | | | | | | | | |
|---|---|---|---|---|---|---|---|---|---|---|---|
| | Chemical | 1 | 2 | 3 | 4 | 5 | 6 | 7 | 8 | 9 | 10 |
| Trade name | name | % w/w | % w/w | % w/w | % w/w | % w/w | % w/w | % w/w | % w/w | % w/w | % w/w |
| Antimicrobial | | 0.001 | 0.01 | 0.1 | 0.5 | 1 | 0.001 | 0.01 | 0.1 | 0.5 | 1 |
| agent | | | | | | | | | | | |
| Compound of | | 0.05 | 0.05 | 0.05 | 0.05 | 0.05 | 0.05 | 0.05 | 0.05 | 0.05 | 0.05 |
| formula (I) | | | | | | | | | | | |
| Solvent | | — | — | — | — | — | 3 | 3 | 3 | 3 | 3 |
| Genapol O 100 | Oleth-10 | 2.00 | 2.00 | 2.00 | 2.00 | 2.00 | 2.00 | 2.00 | 2.00 | 2.00 | 2.00 |
| (Clariant) | | | | | | | | | | | |
| Arquad 2HT-75 | Quaternium 18 | 15.00 | 15.00 | 15.00 | 15.00 | 15.00 | 15.00 | 15.00 | 15.00 | 15.00 | 15.00 |
| (Akzo Nobel) | (and) Isopropyl | | | | | | | | | | |
| | Alcohol | | | | | | | | | | |
| Magnesium | Magnesium | 1.00 | 1.00 | 1.00 | 1.00 | 1.00 | 1.00 | 1.00 | 1.00 | 1.00 | 1.00 |
| Chloride satur- | Chloride | | | | | | | | | | |
| ated solution | | | | | | | | | | | |
| Perfume dye | | qs | qs | qs | qs | qs | qs | qs | qs | qs | qs |
| Water | Aqua | qs to | qs to | qs to | qs to | qs to | qs to | qs to | qs to | qs to | qs to |
| | | 100 | 100 | 100 | 100 | 100 | 100 | 100 | 100 | 100 | 100 |

(XXXI) Fabric Softener 4

| | INCI Name/ | | | | | | | | | | |
|---|---|---|---|---|---|---|---|---|---|---|---|
| | Chemical | 1 | 2 | 3 | 4 | 5 | 6 | 7 | 8 | 9 | 10 |
| Trade name | name | % w/w | % w/w | % w/w | % w/w | % w/w | % w/w | % w/w | % w/w | % w/w | % w/w |
| Antimicrobial | | 0.001 | 0.01 | 0.1 | 0.5 | 1 | 0.001 | 0.01 | 0.1 | 0.5 | 1 |
| agent | | | | | | | | | | | |
| Compound of | | 0.05 | 0.05 | 0.05 | 0.05 | 0.05 | 0.05 | 0.05 | 0.05 | 0.05 | 0.05 |
| formula (I) | | | | | | | | | | | |
| Solvent | | — | — | — | — | — | 3 | 3 | 3 | 3 | 3 |
| Rewoquat WE 18 | Dihydrogena- | 15.00 | 15.00 | 15.00 | 15.00 | 15.00 | 15.00 | 15.00 | 15.00 | 15.00 | 15.00 |
| (Evonik) | ted Tallowethyl | | | | | | | | | | |
| | Hydroxyethyl- | | | | | | | | | | |
| | amonium | | | | | | | | | | |
| Genapol O 100 | Oleth-10 | 2.00 | 2.00 | 2.00 | 2.00 | 2.00 | 2.00 | 2.00 | 2.00 | 2.00 | 2.00 |
| (Clariant) | | | | | | | | | | | |
| Antifoam DB 31 | | 0.50 | 0.50 | 0.50 | 0.50 | 0.50 | 0.50 | 0.50 | 0.50 | 0.50 | 0.50 |
| (Dow Corning) | | | | | | | | | | | |
| Magnesium | Magnesium | 1.00 | 1.00 | 1.00 | 1.00 | 1.00 | 1.00 | 1.00 | 1.00 | 1.00 | 1.00 |
| Chloride satur- | Chloride | | | | | | | | | | |
| ated solution | | | | | | | | | | | |
| Perfume + dye | | qs | qs | qs | qs | qs | qs | qs | qs | qs | qs |
| Water | Aqua | qs to | qs to | qs to | qs to | qs to | qs to | qs to | qs to | qs to | qs to |
| | | 100 | 100 | 100 | 100 | 100 | 100 | 100 | 100 | 100 | 100 |

(XXXII) Polymer emulsion

| | INCI Name/ | | | | | | | | | | |
|---|---|---|---|---|---|---|---|---|---|---|---|
| | Chemical | 1 | 2 | 3 | 4 | 5 | 6 | 7 | 8 | 9 | 10 |
| Trade name | name | % w/w | % w/w | % w/w | % w/w | % w/w | % w/w | % w/w | % w/w | % w/w | % w/w |
| Antimicrobial | | 0.001 | 0.01 | 0.1 | 1 | 2 | 0.001 | 0.01 | 0.1 | 1 | 2 |
| agent | | | | | | | | | | | |
| Compound of | | 1 | 1 | 1 | 1 | 1 | 1 | 1 | 1 | 1 | 1 |
| formula (I) | | | | | | | | | | | |
| Solvent | | — | — | — | — | — | 2 | 2 | 2 | 2 | 2 |
| Polyethylene wax | | 30.00 | 30.00 | 30.00 | 30.00 | 30.00 | 30.00 | 30.00 | 30.00 | 30.00 | 30.00 |
| Lutensol TO 10 | Alcoholethoxy- | 8.5 | 8.5 | 8.5 | 8.5 | 8.5 | 8.5 | 8.5 | 8.5 | 8.5 | 8.5 |
| (BASF) | late | | | | | | | | | | |
| KOH | KOH | 0.5 | 0.5 | 0.5 | 0.5 | 0.5 | 0.5 | 0.5 | 0.5 | 0.5 | 0.5 |
| Water | Aqua | qs to | qs to | qs to | qs to | qs to | qs to | qs to | qs to | qs to | qs to |
| | | 100 | 100 | 100 | 100 | 100 | 100 | 100 | 100 | 100 | 100 |
| pH | | 9.2 | 9.2 | 9.2 | 9.2 | 9.2 | 9.2 | 9.2 | 9.2 | 9.2 | 9.2 |

(XXXIII) Cellulose pulp

| | INCI Name/ | | | | | | | | | | |
|---|---|---|---|---|---|---|---|---|---|---|---|
| | Chemical | 1 | 2 | 3 | 4 | 5 | 6 | 7 | 8 | 9 | 10 |
| Trade name | name | % w/w | % w/w | % w/w | % w/w | % w/w | % w/w | % w/w | % w/w | % w/w | % w/w |
| Antimicrobial | | 0.001 | 0.01 | 0.1 | 0.5 | 1 | 0.001 | 0.01 | 10.1 | 0.5 | 1 |
| agent | | | | | | | | | | | |
| Compound of | | 0.05 | 0.05 | 0.05 | 10.05 | 0.05 | 0.05 | 0.05 | 0.05 | 0.05 | 0.05 |
| formula (I) | | | | | | | | | | | |
| Solvent | | — | — | — | — | — | 3 | 3 | 3 | 3 | 3 |
| Cellulose (Eifeltor | Cellulose | 2.0 | 2.0 | 2.0 | 2.0 | 2.0 | 2.0 | 2.0 | 2.0 | 2.0 | 2.0 |
| Mühle) | | | | | | | | | | | |
| Water | Aqua | qs to | qs to | qs to | qs to | qs to | qs to | qs to | qs to | qs to | qs to |
| | | 100 | 100 | 100 | 100 | 100 | 100 | 100 | 100 | 100 | 100 |
| pH | | 7.2 | 7.2 | 7.2 | 7.2 | 7.2 | 7.2 | 7.2 | 7.2 | 7.2 | 7.2 |

(XXXIV) CaCO₃ Slurry

| | INCI Name/ | | | | | | | | | | |
|---|---|---|---|---|---|---|---|---|---|---|---|
| | Chemical | 1 | 2 | 3 | 4 | 5 | 6 | 7 | 8 | 9 | 10 |
| Trade name | name | % w/w | % w/w | % w/w | % w/w | % w/w | % w/w | % w/w | % w/w | % w/w | % w/w |
| Antimicrobial | | 0.001 | 0.01 | 0.1 | 0.5 | 1 | 0.001 | 0.01 | 0.1 | 0.5 | 1 |
| agent | | | | | | | | | | | |
| Compound of | | 0.05 | 0.05 | 0.05 | 0.05 | 0.05 | 0.05 | 0.05 | 0.05 | 0.05 | 0.05 |
| formula (I) | | | | | | | | | | | |
| Solvent | | — | — | — | — | — | 3 | 3 | 3 | 3 | 3 |
| | CaCO₃ | 50.0 | 50.0 | 50.0 | 50.0 | 50.0 | 50.0 | 50.0 | 50.0 | 50.0 | 50.0 |
| Dispex AA 4140 | Polyacrylate | 0.5 | 0.5 | 0.5 | 0.5 | 0.5 | 0.5 | 0.5 | 0.5 | 0.5 | 0.5 |
| (BASF) | | | | | | | | | | | |
| Water | Aqua | qs to | qs to | qs to | qs to | qs to | qs to | qs to | qs to | qs to | qs to |
| | | 100 | 100 | 100 | 100 | 100 | 100 | 100 | 100 | 100 | 100 |

(XXXV) Kaolin Slurry

| | INCI Name/ | | | | | | | | | | |
|---|---|---|---|---|---|---|---|---|---|---|---|
| | Chemical | 1 | 2 | 3 | 4 | 5 | 6 | 7 | 8 | 9 | 10 |
| Trade name | name | % w/w | % w/w | % w/w | % w/w | % w/w | % w/w | % w/w | % w/w | % w/w | % w/w |
| Antimicrobial | | 0.001 | 0.01 | 0.1 | 0.5 | 1 | 0.001 | 0.01 | 0.1 | 0.5 | 1 |
| agent | | | | | | | | | | | |
| Compound of | | 0.05 | 0.05 | 0.05 | 0.05 | 0.05 | 0.05 | 0.05 | 0.05 | 0.05 | 0.05 |
| formula (I) | | | | | | | | | | | |
| Solvent | | — | — | — | — | — | 3 | 3 | 3 | 3 | 3 |
| Kaolin DSK 50 | Kaolin | 50.0 | 50.0 | 50.0 | 50.0 | 50.0 | 50.0 | 50.0 | 50.0 | 50.0 | 50.0 |
| (Dorfner GmbH) | | | | | | | | | | | |
| Sokalan CP 10 | Polyacrylate | 0.1 | 0.1 | 0.1 | 0.1 | 0.1 | 0.1 | 0.1 | 0.1 | 0.1 | 0.1 |
| (BASF) | | | | | | | | | | | |
| Water | Aqua | qs to | qs to | qs to | qs to | qs to | qs to | qs to | qs to | qs to | qs to |
| | | 100 | 100 | 100 | 100 | 100 | 100 | 100 | 100 | 100 | 100 |

(XXXVI) Starch solution

| | INCI Name/ | 1 | 2 | 3 | 4 | 5 | 6 | 7 | 8 | 9 | 10 |
|---|---|---|---|---|---|---|---|---|---|---|---|
| | Chemical | % | % | % | % | % | % | % | % | % | % |
| Trade name | name | w/w | w/w | w/w | w/w | w/w | w/w | w/w | w/w | w/w | w/w |
| Antimicrobial | | 0.001 | 0.01 | 0.1 | 0.5 | 1 | 0.001 | 0.01 | 0.1 | 0.5 | 1 |
| agent | | | | | | | | | | | |
| Compound of | | 0.05 | 0.05 | 0.05 | 0.05 | 0.05 | 0.05 | 0.05 | 0.05 | 0.05 | 0.05 |
| formula (I) | | | | | | | | | | | |
| Solvent | | — | — | — | — | — | 3 | 3 | 3 | 3 | 3 |
| Starch | CAS 9005-25-8 | 2.0 | 2.0 | 2.0 | 2.0 | 2.0 | 2.0 | 2.0 | 2.0 | 2.0 | 2.0 |
| Water | Aqua | qs to | qs to | qs to | qs to | qs to | qs to | qs to | qs to | qs to | qs to |
| | | 100 | 100 | 100 | 100 | 100 | 100 | 100 | 100 | 100 | 100 |

(XXXVII) Pigment Slurry

| | INCI Name/ | 1 | 2 | 3 | 4 | 5 | 6 | 7 | 8 | 9 | 10 |
|---|---|---|---|---|---|---|---|---|---|---|---|
| | Chemical | % | % | % | % | % | % | % | % | % | % |
| Trade name | name | w/w | w/w | w/w | w/w | w/w | w/w | w/w | w/w | w/w | w/w |
| Antimicrobial | | 0.001 | 0.01 | 0.1 | 0.5 | 1 | 0.001 | 0.01 | 0.1 | 0.5 | 1 |
| agent | | | | | | | | | | | |
| Compound of | | 0.05 | 0.05 | 0.05 | 0.05 | 0.05 | 0.05 | 0.05 | 0.05 | 0.05 | 0.05 |
| formula (I) | | | | | | | | | | | |
| Solvent | | — | — | — | — | — | 3 | 3 | 3 | 3 | 3 |
| Pigment Blue | P BL 015 | 20.0 | 20.0 | 20.0 | 20.0 | 20.0 | 20.0 | 20.0 | 20.0 | 20.0 | 20.0 |
| 015 | | | | | | | | | | | |
| Dispergator CC | | 0.5-4 | 0.5-4 | 0.5-4 | 0.5-4 | 0.5-4 | 0.5-4 | 0.5-4 | 0.5-4 | 0.5-4 | 0.5-4 |
| Water | Aqua | qs to | qs to | qs to | qs to | qs to | qs to | qs to | qs to | qs to | qs to |
| | | 100 | 100 | 100 | 100 | 100 | 100 | 100 | 100 | 100 | 100 |

(XXXVIII) Paint

| | INCI Name/ | 1 | 2 | 3 | 4 | 5 | 6 | 7 | 8 | 9 | 10 |
|---|---|---|---|---|---|---|---|---|---|---|---|
| | Chemical | % | % | % | % | % | % | % | % | % | % |
| Trade name | name | w/w | w/w | w/w | w/w | w/w | w/w | w/w | w/w | w/w | w/w |
| Antimicrobial | | 0.001 | 0.01 | 10.1 | 0.5 | 1 | 0.001 | 0.01 | 0.1 | 0.5 | 1 |
| agent | | | | | | | | | | | |
| Compound of | | 0.05 | 0.05 | 0.05 | 0.05 | 0.05 | 0.05 | 0.05 | 0.05 | 0.05 | 0.05 |
| formula (I) | | | | | | | | | | | |
| Solvent | | — | — | — | — | — | 3 | 3 | 3 | 3 | 3 |
| Natrosol 250HHR | Hydroxyethylcel- | 0.3 | 0.3 | 0.3 | 0.3 | 0.3 | 0.3 | 0.3 | 0.3 | 0.3 | 0.3 |
| (Brenntag) | lulose | | | | | | | | | | |
| Rheovis PE 133 | Polyether | 1.0 | 1.0 | 1.0 | 1.0 | 1.0 | 1.0 | 1.0 | 1.0 | 1.0 | 1.0 |
| (BASF)0 | | | | | | | | | | | |
| Na- | (NaPO3)ₙ | 0.1 | 0.1 | 0.1 | 0.1 | 0.1 | 0.1 | 0.1 | 10.1 | 0.1 | 0.1 |
| polyphosphate | | | | | | | | | | | |
| NaOH | NaOH | 0.04 | 10.04 | 0.04 | 0.04 | 0.04 | 0.04 | 0.04 | 0.04 | 0.04 | 0.04 |
| Texamol (Alpha | Sodium Alkyl | 0.6 | 0.6 | 0.6 | 0.6 | 0.6 | 0.6 | 0.6 | 0.6 | 0.6 | 0.6 |
| Chemistry) | Ethoxy Sulphate | | | | | | | | | | |
| Foammaster MO | | 0.5 | 0.5 | 0.5 | 0.5 | 0.5 | 0.5 | 0.5 | 0.5 | 0.5 | 0.5 |
| 2114 (BASF) | | | | | | | | | | | |
| Omyacarb 5 EU | CaCO₃ | 19.8 | 19.8 | 19.8 | 19.8 | 19.8 | 19.8 | 19.8 | 19.8 | 19.8 | 19.8 |
| (Omya) | | | | | | | | | | | |
| Socal P2 (Sol- | CaCO₃ | 11.0 | 11.0 | 11.0 | 11.0 | 11.0 | 11.0 | 11.0 | 11.0 | 11.0 | 11.0 |
| vay) | | | | | | | | | | | |
| Finntalc M 30 | Talc | 5.5 | 5.5 | 5.5 | 5.5 | 5.5 | 5.5 | 5.5 | 5.5 | 5.5 | 5.5 |
| (Elementis) | | | | | | | | | | | |
| Kronos 2119 | TiO₂ | 10.0 | 10.0 | 10.0 | 10.0 | 10.0 | 10.0 | 10.0 | 10.0 | 10.0 | 10.0 |
| (Kronos) | | | | | | | | | | | |
| Acronal EDGE | p-Acrylate | 23.0 | 23.0 | 23.0 | 23.0 | 23.0 | 23.0 | 23.0 | 23.0 | 23.0 | 23.0 |
| 6205 (BASF) | | | | | | | | | | | |
| Water | Aqua | qs to | qs to | qs to | qs to | qs to | qs to | qs to | qs to | qs to | qs to |
| | | 100 | 100 | 100 | 100 | 100 | 100 | 100 | 100 | 100 | 100 |

(XXXIX) O/W Emulsion for skin care

| | INCI Name/ | 1 | 2 | 3 | 4 | 5 | 6 | 7 | 8 | 9 | 10 |
|---|---|---|---|---|---|---|---|---|---|---|---|
| | Chemical | % | % | % | % | % | % | % | % | % | % |
| Trade name | name | w/w | w/w | w/w | w/w | w/w | w/w | w/w | w/w | w/w | w/w |
| Antimicrobial agent | | 0.001 | 0.01 | 0.1 | 0.5 | 1 | 0.001 | 0.01 | 0.1 | 0.5 | 1 |
| Compound of | | 0.05 | 0.05 | 0.05 | 0.05 | 0.05 | 0.05 | 0.05 | 0.05 | 0.05 | 0.05 |
| formula (I) | | | | | | | | | | | |
| Solvent | | — | — | — | — | — | 3 | 3 | 3 | 3 | 3 |
| Cremophor A 6 | Ceteareth-6, | 2 | 2 | 2 | 2 | 2 | 2 | 2 | 2 | 2 | 2 |
| (Sigma) | Stearyl- | | | | | | | | | | |
| | alcohol | | | | | | | | | | |
| Cremophor A 25 | | 2 | 2 | 2 | 2 | 2 | 2 | 2 | 2 | 2 | 2 |
| (Sigma) | | | | | | | | | | | |
| Tegosoft liquid | Cetearyl | 5 | 5 | 5 | 5 | 5 | 5 | 5 | 5 | 5 | 5 |
| (Evonik) | Ethyl- | | | | | | | | | | |
| | hexanoate | | | | | | | | | | |
| Paraffinoil | Minearal oil | 5 | 5 | 5 | 5 | 5 | 5 | 5 | 5 | 5 | 5 |
| Lanette 16 (BASF) | Cetyl Alcohol | 2.5 | 2.5 | 2.5 | 2.5 | 2.5 | 2.5 | 2.5 | 2.5 | 2.5 | 2.5 |
| Water | Aqua | qs to 100 | qs to | qs to | qs to | qs to | qs to | qs to | qs to | qs to | qs to |
| | | | 100 | 100 | 100 | 100 | 100 | 100 | 100 | 100 | 100 |

(XL) W/O Lotion

| | | INCI Name/ | | | | | | | | | | |
|---|---|---|---|---|---|---|---|---|---|---|---|---|
| | | Chemical | 1 | 2 | 3 | 4 | 5 | 6 | 7 | 8 | 9 | 10 |
| | Trade name | name | % w/w | % w/w | % w/w | % w/w | % w/w | % w/w | % w/w | % w/w | % w/w | % w/w |
| Part | Antimicrobial | | 0.001 | 0.01 | 0.1 | 1 | 2 | 0.001 | 0.01 | 0.1 | 1 | 2 |
| A | agent | | | | | | | | | | | |
| | Compound of | | 1 | 1 | 1 | 1 | 1 | 1 | 1 | 1 | 1 | 1 |
| | formula (I) | | | | | | | | | | | |
| | Solvent | | — | — | — | — | — | 2 | 2 | 2 | 2 | 2 |
| Part | Dehymuls | Polyglyceryl- | 2.0 | 2.0 | 2.0 | 2.0 | 2.0 | 2.0 | 2.0 | 2.0 | 2.0 | 2.0 |
| B | PGPH | Dipolyhydro- | | | | | | | | | | |
| | | xystearate | | | | | | | | | | |
| | Lameform | Polyglyceryl- | 2.0 | 2.0 | 2.0 | 2.0 | 2.0 | 2.0 | 2.0 | 2.0 | 2.0 | 2.0 |
| | TGI | 3- | | | | | | | | | | |
| | | Diisostearate | | | | | | | | | | |
| | Zinc Stearate | Zinc Stearate | 1.0 | 1.0 | 1.0 | 1.0 | 1.0 | 1.0 | 1.0 | 1.0 | 1.0 | 1.0 |
| | Cosmedia | Dicaprylyl | 2.0 | 2.0 | 2.0 | 2.0 | 2.0 | 2.0 | 2.0 | 2.0 | 2.0 | 2.0 |
| | Gel CC | Carbonate, | | | | | | | | | | |
| | | Staealkonium | | | | | | | | | | |
| | | Hectorite, | | | | | | | | | | |
| | | Propylene | | | | | | | | | | |
| | | Carbonate | | | | | | | | | | |
| | Cetiol Sen- | Propylheptyl | 5.0 | 5.0 | 5.0 | 5.0 | 5.0 | 5.0 | 5.0 | 5.0 | 5.0 | 5.0 |
| | soft | Caprylate | | | | | | | | | | |
| | Cetiol CC | Dicaprylyl | 4.0 | 4.0 | 4.0 | 4.0 | 4.0 | 4.0 | 4.0 | 4.0 | 4.0 | 4.0 |
| | | Carbonate | | | | | | | | | | |
| | Cetiol C 5C | Coco- | 5.0 | 5.0 | 5.0 | 5.0 | 5.0 | 5.0 | 5.0 | 5.0 | 5.0 | 5.0 |
| | | Capry- | | | | | | | | | | |
| | | late/Caprate | | | | | | | | | | |
| | Glycerin | Glycerin | 10.0 | 10.0 | 10.0 | 10.0 | 10.0 | 10.0 | 10.0 | 10.0 | 10.0 | 10.0 |
| | Mg2SO4 × | Magnesi- | 1.0 | 1.0 | 1.0 | 1.0 | 1.0 | 1.0 | 1.0 | 1.0 | 1.0 | 1.0 |
| | 7H2O | umsulfate | | | | | | | | | | |
| | Perfume | | q.s. | q.s. | q.s. | q.s. | q.s. | q.s. | q.s. | q.s. | q.s. | q.s. |
| Part | Water | | q.s. to | q.s. to | q.s. to | q.s. to | q.s. to | q.s. to | q.s. to | q.s. to | q.s. to | q.s. to |
| C | | | 100 | 100 | 100 | 100 | 100 | 100 | 100 | 100 | 100 | 100 |

(XLI) Roll-on Deodorant

| | INCI Name/ | | | | | | | | | | |
|---|---|---|---|---|---|---|---|---|---|---|---|
| | Chemical | 1 | 2 | 3 | 4 | 5 | 6 | 7 | 8 | 9 | 10 |
| Trade name | name | % w/w | % w/w | % w/w | % w/w | % w/w | % w/w | % w/w | % w/w | % w/w | % w/w |
| Antimicrobial | | 0.001 | 0.01 | 0.1 | 0.5 | 1 | 0.001 | 0.01 | 0.1 | 0.5 | 1 |
| agent | | | | | | | | | | | |
| Compound of | | 0.05 | 0.05 | 0.05 | 0.05 | 0.05 | 0.05 | 0.05 | 0.05 | 0.05 | 0.05 |
| formula (I) | | | | | | | | | | | |
| Solvent | | — | — | — | — | — | 3 | 3 | 3 | 3 | 3 |
| Arlanol HD | Isohexadecane | 8.0 | 8.0 | 18.0 | 8.0 | 8.0 | 18.0 | 8.0 | 8.0 | 8.0 | 8.0 |
| (Croda) | | | | | | | | | | | |
| Tegosoft CT | Caprylic/Capric | 5.0 | 5.0 | 5.0 | 5.0 | 5.0 | 5.0 | 5.0 | 5.0 | 5.0 | 5.0 |
| (Evonik) | Triglyceride | | | | | | | | | | |
| Cetiol OE (BASF) | Stearylether | 3.0 | 3.0 | 3.0 | 3.0 | 3.0 | 3.0 | 3.0 | 3.0 | 3.0 | 3.0 |
| Arlatone 983 | PEG5_Glyceryl | 2.0 | 2.0 | 2.0 | 2.0 | 2.0 | 2.0 | 2.0 | 2.0 | 2.0 | 2.0 |
| (Croda) | Stearate | | | | | | | | | | |
| Brij 76 NENA | Steareth-10 | 2.0 | 2.0 | 2.0 | 2.0 | 2.0 | 2.0 | 2.0 | 2.0 | 2.0 | 2.0 |
| (Sigma) | | | | | | | | | | | |
| Lanette 16 | Cetylalcohol | 0.5 | 0.5 | 0.5 | 0.5 | 0.5 | 0.5 | 0.5 | 0.5 | 0.5 | 0.5 |
| (BASF) | | | | | | | | | | | |
| Atlas G-2330 | Sorbeth-30 | 1.0 | 1.0 | 1.0 | 1.0 | 1.0 | 1.0 | 1.0 | 1.0 | 1.0 | 1.0 |
| (Croda) | | | | | | | | | | | |
| Water | Aqua | qs to | qs to | qs to | qs to | qs to | qs to | qs to | qs to | qs to | qs to |
| | | 100 | 100 | 100 | 100 | 100 | 00 | 100 | 100 | 100 | 100 |
| NaOH (1%) | | Add to | Add to | Add to | Add to | Add to | Add to | Add to | Add to | Add to | Add to |
| | | pH 5.7 | pH 5.7 | pH 5.7 | pH 5.7 | pH 5.7 | pH 5.7 | pH 5.7 | pH 5.7 | pH 5.7 | pH 5.7 |

(XLII) Shower Gel

| | INCI Name/ | | | | | | | | | | |
|---|---|---|---|---|---|---|---|---|---|---|---|
| | Chemical | 1 | 2 | 3 | 4 | 5 | 6 | 7 | 8 | 9 | 10 |
| Trade name | name | % w/w | % w/w | % w/w | % w/w | % w/w | % w/w | % w/w | % w/w | % w/w | % w/w |
| Antimicrobial | | 0.001 | 0.01 | 0.1 | 1 | 2 | 0.001 | 0.01 | 0.1 | 1 | 2 |
| agent | | | | | | | | | | | |
| Compound of | | 1 | 1 | 1 | 1 | 1 | 1 | 1 | 1 | 1 | 1 |
| formula (I) | | | | | | | | | | | |
| Solvent | | — | — | — | — | — | 2 | 2 | 2 | 2 | 2 |
| Texapon N 70 | Sodium Lau- | 8.5 | 8.5 | 8.5 | 8.5 | 8.5 | 8.5 | 8.5 | 8.5 | 8.5 | 8.5 |
| | reth Sulfate | | | | | | | | | | |
| Plantacare 818 | Coco- | 3.8 | 3.8 | 3.8 | 3.8 | 3.8 | 3.8 | 3.8 | 3.8 | 3.8 | 3.8 |
| UP | Glucoside | | | | | | | | | | |
| Lamesoft PO 65 | Coco- | 1.0 | 1.0 | 1.0 | 1.0 | 1.0 | 1.0 | 1.0 | 1.0 | 1.0 | 1.0 |
| | Glucoside, | | | | | | | | | | |
| | Glycerol Oleate | | | | | | | | | | |
| Dehyquart CC7 | Polyquternium- | 1.0 | 1.0 | 1.0 | 1.0 | 1.0 | 1.0 | 1.0 | 1.0 | 1.0 | 1.0 |
| BZ | 7 | | | | | | | | | | |
| Citic Acid 50% | Citric Acid | Add to | Add to | Add to | Add to | Add to | Add to | Add to | Add to | Add to | Add to |
| | | pH 5-7 | pH 5-7 | pH 5-7 | pH 5-7 | pH 5-7 | pH 5-7 | pH 5-7 | pH 5-7 | pH 5-7 | pH 5-7 |
| Sodium Chloride | Sodium Chlor- | q.s. | q.s. | q.s. | q.s. | q.s. | q.s. | q.s. | q.s. | q.s. | q.s. |
| | ide | | | | | | | | | | |
| Water and Per- | Aqua | qs to | qs to | qs to | qs to | qs to | qs to | qs to | qs to | qs to | qs to |
| fume | | 100 | 100 | 100 | 100 | 100 | 100 | 100 | 100 | 100 | 100 |

(XLIII) Shampoo

| | INCI Name/ | | | | | | | | | | |
|---|---|---|---|---|---|---|---|---|---|---|---|
| | Chemical | 1 | 2 | 3 | 4 | 5 | 6 | 7 | 8 | 9 | 10 |
| Trade name | name | % w/w | % w/w | % w/w | % w/w | % w/w | % w/w | % w/w | % w/w | % w/w | % w/w |
| Antimicrobial | | 0.001 | 0.01 | 0.1 | 1 | 2 | 0.001 | 0.01 | 0.1 | 1 | 2 |
| agent | | | | | | | | | | | |
| Compound of | | 1 | 1 | 1 | 1 | 1 | 1 | 1 | 1 | 1 | 1 |
| formula (I) | | | | | | | | | | | |
| Solvent | | — | — | — | — | — | 2 | 2 | 2 | 2 | 2 |
| Texapon N 70 | Sodium Lau- | 14.0 | 14.0 | 14.0 | 14.0 | 14.0 | 14.0 | 14.0 | 14.0 | 14.0 | 14.0 |
| | reth Sulfate | | | | | | | | | | |
| Dehyton PK 45 | Cocoamido- | 5.0 | 5.0 | 5.0 | 5.0 | 5.0 | 5.0 | 5.0 | 5.0 | 5.0 | 5.0 |
| | propyl Betaine | | | | | | | | | | |
| Cetiol LDO | Dicapryl Ether, | 0.7 | 0.7 | 0.7 | 0.7 | 0.7 | 0.7 | 0.7 | 0.7 | 0.7 | 0.7 |
| | Lauryl Alcohol | | | | | | | | | | |
| Euperlan PK 710 | Glycol | 3.0 | 3.0 | 3.0 | 3.0 | 3.0 | 3.0 | 3.0 | 3.0 | 3.0 | 3.0 |
| Benz | Distearate, | | | | | | | | | | |
| | Sodium | | | | | | | | | | |
| | Laureth | | | | | | | | | | |
| | Sulfate, | | | | | | | | | | |
| | Cocoamide | | | | | | | | | | |
| | MEA | | | | | | | | | | |
| Perfume | | q.s. | q.s. | q.s. | q.s. | q.s. | q.s. | q.s. | q.s. | q.s. | q.s. |
| Dehyquart Guar | Guar Hydroxy- | 0.2 | 0.2 | 0.2 | 0.2 | 0.2 | 0.2 | 0.2 | 0.2 | 0.2 | 0.2 |
| N | propyl- | | | | | | | | | | |
| | tirmonuim | | | | | | | | | | |
| | Chliride | | | | | | | | | | |
| | Citric Acid | Add to | Add to | Add to | Add to | Add to | Add to | Add to | Add to | Add to | Add to |
| | | pH 5-7 | pH 5-7 | pH 5-7 | pH 5-7 | pH 5-7 | pH 5-7 | pH 5-7 | pH 5-7 | pH 5-7 | pH 5-7 |
| Sodium Chloride | Sodium Chlor- | q.s. | q.s. | q.s. | q.s. | q.s. | q.s. | q.s. | q.s. | q.s. | q.s. |
| | ide | | | | | | | | | | |
| Water and Per- | Aqua | qs to | qs to | qs to | qs to | qs to | qs to | qs to | qs to | qs to | qs to |
| fume | | 100 | 100 | 100 | 100 | 100 | 100 | 100 | 100 | 100 | 100 |

(XLIV) Metal Working Fluid (in use)

| | INCI Name/ | | | | | | | | | | |
|---|---|---|---|---|---|---|---|---|---|---|---|
| | Chemical | 1 | 2 | 3 | 4 | 5 | 6 | 7 | 8 | 9 | 10 |
| Trade name | name | % w/w | % w/w | % w/w | % w/w | % w/w | % w/w | % w/w | % w/w | % w/w | % w/w |
| Antimicrobial | | 0.001 | 0.01 | 0.1 | 0.5 | 1 | 0.001 | 0.01 | 0.1 | 0.5 | 1 |
| agent | | | | | | | | | | | |
| Compound of | | 0.05 | 0.05 | 0.05 | 0.05 | 0.05 | 0.05 | 0.05 | 0.05 | 0.05 | 0.05 |
| formula (I) | | | | | | | | | | | |
| Solvent | | — | — | — | — | — | 3 | 3 | 3 | 3 | 3 |
| Monoethanol- | | 0.08 | 0.08 | 0.08 | 0.08 | 0.08 | 0.08 | 0.08 | 0.08 | 0.08 | 0.08 |
| amine | | | | | | | | | | | |
| Triethanolamine | | 0.08 | 0.08 | 0.08 | 0.08 | 0.08 | 0.08 | 0.08 | 0.08 | 0.08 | 0.08 |
| Amino- | | 0.08 | 0.08 | 0.08 | 0.08 | 0.08 | 0.08 | 0.08 | 0.08 | 0.08 | 0.08 |
| methylpropanol | | | | | | | | | | | |
| Pluronic RPE | Nonionic | 0.25 | 0.25 | 0.25 | 0.25 | 0.25 | 0.25 | 0.25 | 0.25 | 0.25 | 0.25 |
| 1720 (BASF) | Surfactant | | | | | | | | | | |
| Pluronic RPE | Nonionic | 0.25 | 0.25 | 0.25 | 0.25 | 0.25 | 0.25 | 0.25 | 0.25 | 0.25 | 0.25 |
| 1740 (BASF) | Surfactant | | | | | | | | | | |
| Korantin LUB | Poly[oxy(meth- | 0.15 | 0.15 | 0.15 | 0.15 | 0.15 | 0.15 | 0.15 | 0.15 | 0.15 | 0.15 |
| (BASF) | yl-1,2- | | | | | | | | | | |
| | ethandiyl)], α- | | | | | | | | | | |
| | phosphono-ω- | | | | | | | | | | |
| | hydroxy- | | | | | | | | | | |
| Oleic Acid | | 0.08 | 0.08 | 0.08 | 0.08 | 0.08 | 0.08 | 0.08 | 0.08 | 0.08 | 0.08 |
| Erucic Acid | | 0.08 | 0.08 | 0.08 | 0.08 | 0.08 | 0.08 | 0.08 | 0.08 | 0.08 | 0.08 |
| Water | | qs to | qs to | qs to | qs to | qs to | qs to | qs to | qs to | qs to | qs to |
| | | 100 | 100 | 100 | 100 | 100 | 100 | 100 | 100 | 100 | 100 |

(XLV) Drilling Mud 1

| | INCI Name/ | | | | | | | | | | |
|---|---|---|---|---|---|---|---|---|---|---|---|
| | Chemical | 1 | 2 | 3 | 4 | 5 | 6 | 7 | 8 | 9 | 10 |
| Trade name | name | % w/w | % w/w | % w/w | % w/w | % w/w | % w/w | % w/w | % w/w | % w/w | % w/w |
| Antimicrobial | | 0.001 | 0.01 | 0.1 | 0.5 | 1 | 0.001 | 0.01 | 0.1 | 0.5 | 1 |
| agent | | | | | | | | | | | |
| Compound of | | 0.05 | 0.05 | 0.05 | 0.05 | 0.05 | 0.05 | 0.05 | 0.05 | 0.05 | 0.05 |
| formula (I) | | | | | | | | | | | |
| Solvent | | — | — | — | — | — | 3 | 3 | 3 | 3 | 3 |
| Potassium | KCl | 11.3 | 11.3 | 11.3 | 11.3 | 11.3 | 11.3 | 11.3 | 11.3 | 11.3 | 11.3 |
| Chloride | | | | | | | | | | | |
| Polysaccharide | | 1.3 | 1.3 | 1.3 | 1.3 | 1.3 | 1.3 | 1.3 | 1.3 | 1.3 | 1.3 |
| Xantan Gum | | 0.5 | 0.5 | 0.5 | 0.5 | 0.5 | 0.5 | 0.5 | 0.5 | 0.5 | 0.5 |
| Calcium | CaCO₃ | 10.0 | 10.0 | 10.0 | 10.0 | 10.0 | 10.0 | 10.0 | 10.0 | 10.0 | 10.0 |
| Carbonate | | | | | | | | | | | |
| Water | Aqua | qs to | qs to | qs to | qs to | qs to | qs to | qs to | qs to | qs to | qs to |
| | | 100 | 100 | 100 | 100 | 100 | 100 | 100 | 100 | 100 | 100 |

(XLVI) Drilling Mud 2

| | INCI Name/ | | | | | | | | | | |
|---|---|---|---|---|---|---|---|---|---|---|---|
| | Chemical | 1 | 2 | 3 | 4 | 5 | 6 | 7 | 8 | 9 | 10 |
| Trade name | name | % w/w | % w/w | % w/w | % w/w | % w/w | % w/w | % w/w | % w/w | % w/w | % w/w |
| Antimicrobial | | 0.001 | 0.01 | 0.1 | 0.5 | 1 | 0.001 | 0.01 | 0.1 | 0.5 | 1 |
| agent | | | | | | | | | | | |
| Compound of | | 0.05 | 0.05 | 0.05 | 0.05 | 0.05 | 0.05 | 0.05 | 0.05 | 0.05 | 0.05 |
| formula (I) | | | | | | | | | | | |
| Solvent | | — | — | — | — | — | 3 | 3 | 3 | 3 | 3 |
| Potassium | KCl | 11.3 | 11.3 | 11.3 | 11.3 | 11.3 | 11.3 | 11.3 | 11.3 | 11.3 | 11.3 |
| Chloride | | | | | | | | | | | |
| Polyanionic | | 1.3 | 1.3 | 1.3 | 1.3 | 1.3 | 1.3 | 1.3 | 1.3 | 1.3 | 1.3 |
| Cellulose | | | | | | | | | | | |
| Biopolymer | | 0.5 | 0.5 | 0.5 | 0.5 | 0.5 | 0.5 | 0.5 | 0.5 | 0.5 | 0.5 |
| Calcium | CaCO₃ | 10.0 | 10.0 | 10.0 | 10.0 | 10.0 | 10.0 | 10.0 | 10.0 | 10.0 | 10.0 |
| Carbonate | | | | | | | | | | | |
| Disodium | Na₂CO₃ | 0.2 | 0.2 | 0.2 | 0.2 | 0.2 | 0.2 | 0.2 | 0.2 | 0.2 | 0.2 |
| Carbonate | | | | | | | | | | | |
| Water | Aqua | qs to | qs to | qs to | qs to | qs to | qs to | qs to | qs to | qs to | qs to |
| | | 100 | 100 | 100 | 100 | 100 | 100 | 100 | 100 | 100 | 100 |

(XLVII) Workover Fluid used in Oilfield

| | INCI Name/ | | | | | | | | | | |
|---|---|---|---|---|---|---|---|---|---|---|---|
| | Chemical | 1 | 2 | 3 | 4 | 5 | 6 | 7 | 8 | 9 | 10 |
| Trade name | name | % w/w | % w/w | % w/w | % w/w | % w/w | % w/w | % w/w | % w/w | % w/w | % w/w |
| Antimicrobial | | 0.001 | 0.01 | 0.1 | 0.5 | 1 | 0.001 | 0.01 | 0.1 | 0.5 | 1 |
| agent | | | | | | | | | | | |
| Compound of | | 0.05 | 0.05 | 0.05 | 0.05 | 0.05 | 0.05 | 0.05 | 0.05 | 0.05 | 0.05 |
| formula (I) | | | | | | | | | | | |
| Solvent | | — | — | — | — | — | 3 | 3 | 3 | 3 | 3 |
| Bentonite | | 2.5 | 2.5 | 2.5 | 2.5 | 2.5 | 2.5 | 2.5 | 2.5 | 2.5 | 2.5 |
| Xantan Gum | | 0.4 | 0.4 | 0.4 | 0.4 | 0.4 | 0.4 | 0.4 | 0.4 | 0.4 | 0.4 |
| Modified Starch | | 1.5 | 1.5 | 1.5 | 1.5 | 1.5 | 1.5 | 1.5 | 1.5 | 1.5 | 1.5 |
| Barium Sulfate | | 11.2 | 11.2 | 11.2 | 11.2 | 11.2 | 11.2 | 11.2 | 11.2 | 11.2 | 11.2 |
| Disodium | | 0.1 | 0.1 | 0.1 | 0.1 | 0.1 | 0.1 | 0.1 | 0.1 | 0.1 | 0.1 |
| Carbonate | | | | | | | | | | | |
| Sea Water | | qs to | qs to | qs to | qs to | qs to | qs to | qs to | qs to | qs to | qs to |
| | | 100 | 100 | 100 | 100 | 100 | 100 | 100 | 100 | 100 | 100 |

(XLVIII) Cooling water

| | INCI Name/ | | | | | | | | | | |
|---|---|---|---|---|---|---|---|---|---|---|---|
| | Chemical | 1 | 2 | 3 | 4 | 5 | 6 | 7 | 8 | 9 | 10 |
| Trade name | name | % w/w | % w/w | % w/w | % w/w | % w/w | % w/w | % w/w | % w/w | % w/w | % w/w |
| Antimicrobial | | 0.001 | 0.01 | 0.1 | 0.5 | 1 | 0.001 | 0.01 | 0.1 | 0.5 | 1 |
| agent | | | | | | | | | | | |
| Compound of | | 0.05 | 0.05 | 0.05 | 0.05 | 0.05 | 0.05 | 0.05 | 0.05 | 0.05 | 0.05 |
| formula (I) | | | | | | | | | | | |
| Solvent | | — | — | — | — | — | 3 | 3 | 3 | 3 | 3 |
| Ca²⁺ | | 0-0.05 | 0-0.05 | 0-0.05 | 0-0.05 | 0-0.05 | 0-0.05 | 0-0.05 | 0-0.05 | 0-0.05 | 0-0.05 |
| Plurafac LF 221 | Non-ionic | 0.01- | 0.01- | 0.01- | 0.01- | 0.01- | 0.01- | 0.01- | 0.01- | 0.01- | 0.01- |
| (BASF) | surfactant | 0.1 | 0.1 | 0.1 | 0.1 | 0.1 | 0.1 | 0.1 | 0.1 | 0.1 | 0.1 |
| Korantin PP | 2-propyn-1-ol | 0.001- | 0.001- | 0.001- | 0.001- | 0.001- | 0.001- | 0.001- | 0.001- | 0.001- | 0.001- |
| (BASF) | | 0.05 | 0.05 | 0.05 | 0.05 | 0.05 | 0.05 | 0.05 | 0.05 | 0.05 | 0.05 |
| | | pH 6-10 | pH 6-10 | pH 6-10 | pH 6-10 | pH 6-10 | pH 6-10 | pH 6-10 | pH 6-10 | pH 6-10 | pH 6-10 |
| Water | | qs to | qs to | qs to | qs to | qs to | qs to | qs to | qs to | qs to | qs to |
| | | 100 | 100 | 100 | 100 | 100 | 100 | 100 | 100 | 100 | 100 |

(XLIX) Plant protection Product 1

| | | INCI | | | | | | | | | | |
|---|---|---|---|---|---|---|---|---|---|---|---|---|
| | | Name/ | | | | | | | | | | |
| | | Chemical | 1 | 2 | 3 | 4 | 5 | 6 | 7 | 8 | 9 | 10 |
| | Trade name | name | % w/w | % w/w | % w/w | % w/w | % w/w | % w/w | % w/w | % w/w | % w/w | % w/w |
| Part | Antimicrobial | | 0.001 | 0.01 | 0.2 | 1 | 2 | 0.001 | 0.01 | 0.2 | 1 | 2 |
| A | agent | | | | | | | | | | | |
| | Compound of | | 1 | 1 | 1 | 1 | 1 | 1 | 1 | 1 | 1 | 1 |
| | formula (I) | | | | | | | | | | | |
| | Solvent | | — | — | — | — | — | 2 | 2 | 2 | 2 | 2 |
| Part | Azoxystrobin | | 25 | 25 | 25 | 25 | 25 | 25 | 25 | 25 | 25 | 25 |
| B | Agnique CP 72 | | 2.5 | 2.5 | 2.5 | 2.5 | 2.5 | 2.5 | 2.5 | 2.5 | 2.5 | 2.5 |
| | L (BASF) | | | | | | | | | | | |
| | Sokalan CP 10 | | 1.6 | 1.6 | 1.6 | 1.6 | 1.6 | 1.6 | 1.6 | 1.6 | 1.6 | 1.6 |
| | (BASF) | | | | | | | | | | | |
| | 1,2-Propane- | | 5.0 | 5.0 | 5.0 | 5.0 | 5.0 | 5.0 | 5.0 | 5.0 | 5.0 | 5.0 |
| | diol | | | | | | | | | | | |
| | Lutensol XP 80 | | 15 | 15 | 15 | 15 | 15 | 15 | 15 | 15 | 15 | 15 |
| | (BASF) | | | | | | | | | | | |
| | Attagel 50 | | 0.2 | 0.2 | 0.2 | 0.2 | 0.2 | 0.2 | 0.2 | 0.2 | 0.2 | 0.2 |
| | (BASF) | | | | | | | | | | | |
| | Agnique DFM | | 0.2 | 0.2 | 0.2 | 0.2 | 0.2 | 0.2 | 0.2 | 0.2 | 0.2 | 0.2 |
| | 111 S (BASF) | | | | | | | | | | | |
| Part | Water | | qs to | qs to | qs to | qs to | qs to | qs to | qs to | qs to | qs to | qs to |
| C | | | 100 | 100 | 100 | 100 | 100 | 100 | 100 | 100 | 100 | 100 |

(L) Plant protection Product 2

| | Trade name | INCI | | | | | | | | | | |
|---|---|---|---|---|---|---|---|---|---|---|---|---|
| | | Name/ | | | | | | | | | | |
| | | Chemical | 1 | 2 | 3 | 4 | 5 | 6 | 7 | 8 | 9 | 10 |
| | | name | % w/w | % w/w | % w/w | % w/w | % w/w | % w/w | % w/w | % w/w | % w/w | % w/w |
| Part | Antimicrobial | | 0.001 | 0.01 | 0.2 | 0.5 | 1 | 0.001 | 0.01 | 0.2 | 0.5 | 1 |
| A | agent | | | | | | | | | | | |
| | Compound of | | 0.05 | 0.05 | 0.05 | 0.05 | 0.05 | 0.05 | 0.05 | 0.05 | 0.05 | 0.05 |
| | formula (I) | | | | | | | | | | | |
| | Solvent | | — | — | — | — | — | 2 | 2 | 2 | 2 | 2 |
| Part | Azoxystrobin | | 25 | 25 | 25 | 25 | 25 | 25 | 25 | 25 | 25 | 25 |
| B | Agnique CP 72 | | 2.5 | 2.5 | 2.5 | 2.5 | 2.5 | 2.5 | 2.5 | 2.5 | 2.5 | 2.5 |
| | L (BASF) | | | | | | | | | | | |
| | Sokalan CP 10 | | 1.6 | 1.6 | 1.6 | 1.6 | 1.6 | 1.6 | 1.6 | 1.6 | 1.6 | 1.6 |
| | (BASF) | | | | | | | | | | | |
| | 1,2-Propane- | | 5.0 | 5.0 | 5.0 | 5.0 | 5.0 | 5.0 | 5.0 | 5.0 | 5.0 | 5.0 |
| | diol | | | | | | | | | | | |
| | Attagel 50 | | 0.2 | 0.2 | 0.2 | 0.2 | 0.2 | 0.2 | 0.2 | 0.2 | 0.2 | 0.2 |
| | (BASF) | | | | | | | | | | | |
| | Agnique DFM | | 0.2 | 0.2 | 0.2 | 0.2 | 0.2 | 0.2 | 0.2 | 0.2 | 0.2 | 0.2 |
| | 111 S (BASF) | | | | | | | | | | | |
| Part | Water | | qs to | qs to | qs to | qs to | qs to | qs to | qs to | qs to | qs to | qs to |
| C | | | 100 | 100 | 100 | 100 | 100 | 100 | 100 | 100 | 100 | 100 |

In each of the above formulations 1 to 10 in each of the above tables I to L one of the following antimicrobial agents is used in each case: 2-phenoxyethanol, phenoxyisopropanol, 4,4′-dichloro 2′-hydroxydiphenylether, 2-bromo-2-nitropropane-1,3-diol, glutaraldehyde, 2,4-dichlorobenzylalcohol, 1,3,5-tris-(2-hydroxyethyl)-1,3,5-hexahydrotriazine, formic acid and salts thereof, benzoic acid and salts thereof, sorbic acid and salts thereof, lactic acid and salts thereof, isothiazolinones selected from the group consisting of 1,2-benzisothiazol-3(2H)-one (BIT), 2-methyl-2H-isothiazol-3-one (MIT), 2-octyl-2H-isothiazol-3-one (QIT), 5-chloro-2-methyl-2H-isothiazol-3-one (CMIT), and 2-butyl-benzo[d]isothiazol-3-one (BBIT); 3-iodo-2-propynylbutylcarbamate (IPBC), benzyl alcohol, pyridine-2-thiol 1-oxide and salts thereof, 2,2-dibromo-2-cyanoacetamide (DBNPA), N-(3-aminopropyl)-N-dodecylpropane-1,3-diamine (Diamine), tetrakis(hydroxymethyl)phosphonium sulphate(2:1) (THPS), 2,2-dithiobis[N-methylbenzamide](DTBMA), 2-bromo-2-(bromomethyl)pentanedinitril (DBDCB) and biphenyl-2-ol (synonyms 2-phenylphenol, o-phenylphenol) and salts thereof. Specifically, 2-phenoxyethanol, 4,4′-dichloro 2′-hydroxydiphenylether (diclosan) or 1,2-benzisothiazol-3(2H)-one (BIT) is used. More specifically, 2-phenoxyethanol is used. In another more specific embodiment, phenoxyisopropanol is used.

Each of these antimicrobial agents is combined in each of the above formulations with one or more of the amides (I) as defined above. Specifically, one of the following amides or a mixture of two or three of the following amides is used: n-octanoyl-N,N-dimethylamide, isononanoyl-N, N-dimethylamide, 2-propylheptanoyl-N, N-dimethylamide, n-octanoyl-N,N-dimethylamide, n-decanoyl-N,N-dimethylamide, dodecanoyl-N,N-dimethylamide, n-decanoyl-morpholine, n-propanoyl-N,N-dibutylamide, ethanoyl-N,N-dihexylamide, maleic acid N-2-ethylhexyl-amide, N,N-dimethyl 9-decenamide. More specifically, one of the following amides is used: n-octanoyl-N,N-dimethylamide, isononanoyl-N,N-dimethylamide, 2-propylheptanoyl-N,N-dimethylamide, n-decanoyl-N,N-dimethylamide, mixture of n-octanoyl- and n-decanoyl-N,N-dimethylamide, dodecanoyl-N,N-dimethylamide, n-octanoyl-morpholine, n-decanoyl-morpholine, mixture of n-octanoyl-morpholine and n-decanoyl-morpholine, n-propanoyl-N,N-dibutylamide, ethanoyl-N,N-dihexylamide, maleic acid N-2-ethylhexyl-amide, N,N-dimethyl 9-decenamide.

If a solvent is used in the above formulations, this is as defined above. Specifically, the solvent is ethanol, n-propanol, isopropanol, ethylene gycol, propylene glycol, ethylene glycol mono-n-butylether, propylene glycol mono-n-butylether, γ-butyrolacton, γ-valerolactone, γ-octalactone, γ-nonalactone or ε-caprolacton.

In the above tables, the % w/w are relative to the overall weight of the respective composition.

Disclosed are moreover formulations, where in each of the above formulations 1 to 10 in each of the above tables I to L 2-phenoxyethanol is used as antimicrobial agent in combination with one of the following amides or with a mixture of two or more of the following amides: N-decanoylsarcosinate, N-dodecanoylsarcosinate, N-decanoyl-N-methylglucamine, N-octyl-N-methyl-glucamine, N,N-bis(2-hydroxyethyl)dodecanamide, N,N-bis(2-hydroxyethyl) decanamide, N-(2-hydroxyethyl)-dodecanamide, N-(2-hydroxyethyl)decanamide, N-octylpyrrolidone.

The invention relates moreover to a kit of parts comprising at least two parts, where the first part comprises at least one antimicrobial agent as defined above; the second part comprises at least one carboxamide compound of the formula (I) as defined above and optionally at least one organic solvent [different from the carboxamide compounds of the formula (I) (and of course also from said antimicrobial agent)], preferably as defined above; and an optional third part comprises at least one organic solvent [different from the carboxamide compounds of the formula (I) (and of course also from said antimicrobial agent)], preferably as defined above;
where the first part does not comprise any carboxamide compound of the formula (I);
where the second part does not comprise any antimicrobial agent as defined above;
where the optional third part does not comprise any antimicrobial agent as defined above nor any carboxamide compound of the formula (I); and
where the first and second parts contain the at least one antimicrobial agent as defined above and the at least one carboxamide compound of the formula (I) in such amounts that when the first and the second part are mixed the resulting overall weight ratio is as defined above, i.e. 500:1 to 1:1000, preferably 200:1 to 1:500, more preferably from 100:1 to 1:200, in particular from 15:1 to 1:15, specifically from 10:1 to 1:10; where in case that the antimicrobial agent is 2-phenoxyethanol, phenoxyisopropanol, formic acid or a salt thereof, benzoic acid or a salt thereof, sorbic acid or a salt thereof, lactic acid or a salt thereof or N-(3-aminopropyl)-N-dodecylpropane-1,3-diamine (Diamine), the resulting overall weight ratio is preferably 500:1 to 1:1000, more preferably 200:1 to 1:500, even more preferably from 100:1 to 1:100, in particular from 15:1 to 1:10, specifically from 10:1 to 1:5.

While in the above-described compositions components (a) and (b) are present as a physical mixture, in a kit of parts they are formulated separately, but provided in such a form that they nevertheless form a functional unity. They form thus a true combination through a purpose-directed application. The functional unity is expressed for example in the fact that the parts contain the antimicrobial agent and the carboxamide compound (I) in such amounts that when mixed, they result in the desired weight ratio. Another way to express functional unity may be a use instruction explaining the combined use of the two or more parts of the kit. Yet another way to express functional unity may be a physical connection. For instance, the different parts of the kit may be bond to each other via an adhesive tape or strap or any other type of tie, or may be assembled in a common container, such as a box, package, basket etc. or packed together in a plastic foil.

In a preferred embodiment, the kit of parts is a kit of two parts, where the first part comprises at least one antimicrobial agent as above; and the second part comprises at least one carboxamide compound of the formula (I) as defined above and at least one organic solvent [different from the carboxamide compounds of the formula (I) (and of course also from said antimicrobial agent)], where the organic solvent has preferably one of the above preferred meanings.

In an alternatively preferred embodiment, the kit of parts is a kit of three parts, where the first part comprises at least one antimicrobial agent as defined above; the second part comprises at least one carboxamide compound of the formula (I) as defined above; and the third part comprises at least one organic solvent [different from the carboxamide compounds of the formula (I) (and of course also from said antimicrobial agent)], where the organic solvent has preferably one of the above preferred meanings.

The invention relates moreover to a mixture consisting of
(a) at least one antimicrobial agent as defined above;
(b) at least one carboxamide compound of the formula (I) as defined above; and
(c) optionally at least one organic solvent [different from component (b)], preferably as defined above.

“Consisting of” means that the mixture contains no other components apart from (a), (b) and optionally (c), except for impurities as present in the components (a), (b) and (c) and stemming, for example from their production process or their storage conditions. The amount of such impurities is generally at most 10% by weight, preferably at most 5% by weight, relative to the total weight of the mixture.

Regarding preferred carboxamide compounds, antimicrobial agents, weight ratios thereof and solvents, reference is made to the above details. In particular, the antimicrobial agent selected from the group consisting of 2-phenoxyethanol, 4,4′-dichloro 2′-hydroxydiphenylether and 1,2-benzisothiazol-3(2H)one (BIT) and is more preferably 2-phenoxyethanol; the carboxamide compound is one of those defined above as preferred; the antimicrobial agent and the carboxamide compound of the formula (I) are present in an overall weight ratio of from 15:1 to 1:15, more preferably from 10:1 to 1:10; and the solvent, if present, is one of those defined above as preferred. More preferably, the antimicrobial agent and the carboxamide compound of the formula (I) are present in an overall weight ratio of from 15:1 to 1:1, preferably from 10:1 to 1:1, if the antimicrobial agent is 2-phenoxyethanol; and the antimicrobial agent and the carboxamide compound of the formula (I) are present in an overall weight ratio of from 1:1 to 1:15, preferably from 1:1 to 1:10, if the antimicrobial agent is 4,4′-dichloro 2′-hydroxydiphenylether and 1,2-benzisothiazol-3(2H)one (BIT).

The invention relates moreover to the use of a carboxamide compound of the formula (I) as defined above for enhancing the antimicrobial, in particular the preserving, activity of the antimicrobial agent as defined above.

Regarding preferred carboxamide compounds, antimicrobial agents, weight ratios thereof, compositions in which these are used, materials for which these are used, etc., reference is made to the above details.

In particular, the carboxamide compounds of the formula (I), especially those defined above as preferred, are used for enhancing the antimicrobial, in particular the preserving, activity of an antimicrobial agent selected from the group consisting of 2-phenoxyethanol, 4,4′-dichloro 2′-hydroxydiphenylether and 1,2-benzisothiazol-3(2H)one (BIT). Preferably, the antimicrobial agent and the carboxamide compound of the formula (I) are used in an overall weight ratio of from 15:1 to 1:15, more preferably from 10:1 to 1:10. More preferably, the antimicrobial agent and the carboxamide compound of the formula (I) are used in an overall weight ratio of from 15:1 to 1:1, preferably from 10:1 to 1:1, if the antimicrobial agent is 2-phenoxyethanol; and the antimicrobial agent and the carboxamide compound of the formula (I) are present in an overall weight ratio of from 1:1 to 1:15, preferably from 1:1 to 1:10, if the antimicrobial agent is 4,4′-dichloro 2′-hydroxydiphenylether and 1,2-benzisothiazol-3(2H)one (BIT).

The invention relates also to the use of said antimicrobial agent in combination with said carboxamide (I) for combating microbes. Regarding preferred carboxamide compounds, antimicrobial agents, weight ratios thereof, compositions in which these are used, materials for which these are used, etc., reference is made to the above details.

The invention relates also to a method for enhancing the antimicrobial, in particular the preserving, activity of the antimicrobial agent as defined above as component (a), comprising using the antimicrobial agent (a) in combination with the carboxamide (I).

The invention relates also to a method for combating microbes, comprising applying said antimicrobial agent in combination with the carboxamide (I) to a composition, surface, area or space in or on which microbes are to be combated.

Regarding preferred carboxamide compounds, antimicrobial agents, weight ratios thereof, compositions in which these are used, materials for which these are used, etc., reference is made to the above details.

“Using in combination” or “applying in combination” means that the antimicrobial agent and the carboxamide (I) are used in admixture in a composition in or by which the antimicrobial agent is to exert its antimicrobial, in particular its preserving, activity, or by applying separately the antimicrobial agent and the carboxamide (I) to a composition, surface, area or space in or on which microbes are to be combated, where the separate application the antimicrobial agent and the carboxamide (I) takes place simultaneously or subsequently, the subsequent application taking place within a sufficiently short time interval (e.g. within a few seconds to 1 h) to allow the antimicrobial agent and the carboxamide (I) to interact.

The invention is now illustrated by the following examples.

### EXAMPLES

### Example 1 Antimicrobial Activity Against Fungi

### 1.1 Preservative Activity of a Basic Composition Using 2-Phenoxyethanol (PE) as Antimicrobial Agent

An aqueous composition of pH 7 comprising 10% by weight of propyleneglycol (PG) as organic solvent, 0.36% by weight of 2-phenoxyethanol (PE) as antimicrobial and 0.04% by weight of the amide listed in the below table was tested for its preserving activity against fungal contamination (the percentages are weight percent and relate to the total weight of the composition). For this purpose, the samples were contaminated with a fungal mix (including yeasts and molds) consisting of:
Aspergillus brasiliensis DS M 1988
Rhodotorula mucilaginosa DSM 13621
Yarrowia lipolytica DS M 8218

To control the efficacy, following control compositions were tested:
“Reference”, consisting of only 10% by weight of propylene glycol in water
“Comparative 1” containing 10% by weight of propylene glycol and amide in the given concentration, but no 2-phenoxyethanol
“Comparative 1” containing 10% by weight of propylene glycol and 2-phenoxyethanol in the given concentration, but no amide.

The samples were inoculated with the fungal mix at day 0, 7 and 14 to obtain a cell density in the range of 1-3×10E+05 CFU/ml (CFU=colony forming units) in the test samples (compositions listed in the below table) and stored at 25° C. for 21 days.

CFU was determined before re-inoculation at days 7 and 14, and on day 21.

Any CFU value at day 7 (d7), day 14 (d14) or day 21 (d21) obtained with a sample according to the invention containing 2-phenoxyethanol and amide (10% PG+0.36% PE+0.04% Amide in water) lower than the respective value of the “comparative 2” example (10% PG+0.4% by weight of 2-phenoxyethanol in water) indicates a better performance.

TABLE 1.1

| | d7 | d14 | d21 |
|---|---|---|---|
| | [CFU/ml] | [CFU/ml] | [CFU/ml] |
| 10% PG − Reference | >100,000 | >100,000 | >100,000 |
| 10% PG + 0.04% Amide − Comparative 1 | >100,000 | >100,000 | >100,000 |
| 10% PG + 0.4% PE − Comparative 2 | 10,000 | 16,000 | 38,500 |

10% PG + 0.36% PE + 0.04% Amide
Amide

| | | | | |
|---|---|---|---|---|
| Isono- nanoyl- N,N- dimethyl- amide | 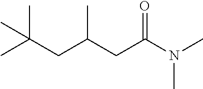 | 3,600 | 3,350 | 15,000 |
| 2-Propyl- heptanoyl- N,N- dimethyl- amide | 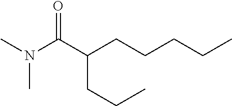 | 5,200 | 3,250 | 8,000 |
| n- Decanoyl- N,N- dimethyl- amide | 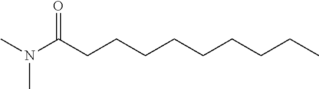 | <10 | <10 | <10 |
| Mix of n- Octanoyl- and n- Decanoyl- N,N- | 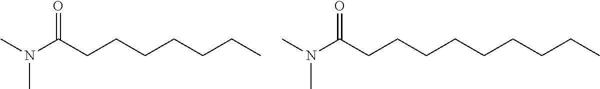 | 25 | 165 | 4,150 |
| dimethyl- | | | | |
| amide | | | | |
| Dodecanoyl- N,N- dimethyl- amide | 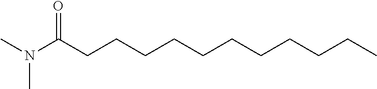 [SMILES: CCCCCCCCCCCC(=O)N(C)C] | 25 | 170 | 245 |
| n-Decanoyl- morpholine | 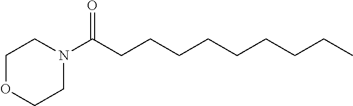 [SMILES: CCCCCCCCCC(=O)N1CCOCC1] | 55 | <10 | 35 |
| n- Propanoyl- N,N- dibutyl- amide | 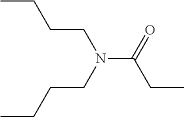 | 1,750 | 3,750 | 25,000 |
| Ethanoyl- N,N- dihexyl- amide | 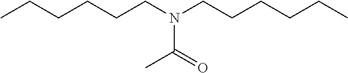 [SMILES: CCCCCCN(CCCCCC)C(C)=O] | 3,100 | 2,750 | 2,450 |
| Maleic acid N- 2-ethyl- hexyl- amide | 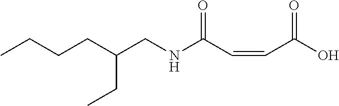 [SMILES: CCCCC(CC)CNC(=O)/C=C\C(=O)O] | 875 | 8,500 | 18,500 |

The comparison of the results obtained with the “Reference” composition and the “Comparative 1” composition shows that the tested amides have no antifungal activity. The results furthermore show that the combination of 2-phenoxyethanol and amide overadditively enhances the preservative activity of 2-phenoxyethanol alone.

### 1.2 Preservative Activity in a Manual Dishwashing Composition Using 2-Phenoxyethanol (PE) as Antimicrobial Agent

A manual dish wash detergent (MDW) of pH 7.1 containing the following components was used:

| | | |
|---|---|---|
| Texapon K 12 G | Sodium lauryl sulfate; anionic | 3.5% |
| | surfactant from BASF | |
| Glucopon 600 CSUP | C₁₀₋₁₆-alkyl polyglycoside; | 5% |
| | non-ionic surfactant | |
| Texapon N 701 | Sodium laureth sulfate; | 5% |
| | anionic surfactant from BASF | |
| Dehyton PK 45 | 1-Propanaminium, 3-amino-N- | 3% |
| | (carboxymethyl)- N,N-dimethyl-, | |
| | N-(C8-18 and C18-unsaturated acyl) | |
| | derivatives, hydroxides, inner salts; | |
| | amphoteric surfactant from BASF | |
| n-Propanol | Organic solvent | 2% |
| Deionat | Deionized water | ad 100% |

The samples were contaminated with a fungal mix consisting of:
Aspergillus brasiliensis DSM 1988
Rhodotorula mucilaginosa DSM 13621
Yarrowia lipolytica DSM 8218

The samples were inoculated with the fungal mix at day 0 and 7 to obtain 1-3×10E+05 CFU/ml inoculation in the test sample consisting of the above-defined dish wash detergent MDW and stored at 25° C. for 21 days. CFU was determined before re-inoculation at day 7, and on days 14 and 21.

Any CFU value at d7, d14 or d21 obtained with a MDW sample of the invention containing 2-phenoxyethanol and amide (MDW+1.0% PE+x % of Amide) lower than the respective value of the comparative example (MDW+1.0% by weight of 2-phenoxyethanol) indicates a better performance of the inventive combination of 2-phenoxyethanol with the amide.

TABLE 1.2

| | d7 | d14 | d21 |
|---|---|---|---|
| | [CFU/ml] | [CFU/ml] | [CFU/ml] |
| MDW + 1.0% PE − Comparative | 38,000 | 27,000 | 3,700 |

MDW + 1.0% PE + x % of Amide
Amide

| | | | | |
|---|---|---|---|---|
| Maleic acid N-2- ethylhexyl- amide (0.6%) | 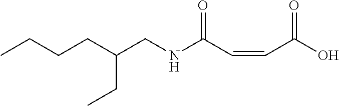 [SMILES: CCCCC(CC)CNC(=O)/C=C\C(=O)O] | 14,500 | 2,900 | 225 |
| n-Decanoyl- morpholine (1.0%) | 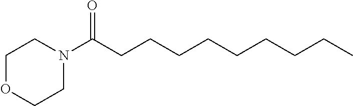 [SMILES: CCCCCCCCCC(=O)N1CCOCC1] | 1,200 | 305 | 245 |

### 1.3 Preservative Activity in a Manual Dishwashing Composition Using 2-Phenoxyethanol (PE) as Antimicrobial Agent

A manual dish wash detergent (MDW) of pH 7.1 containing the following components was used:

| | |
|---|---|
| Texapon K 12 G | 3.5% |
| Glucopon 600 CSUP | 5% |
| Texapon N 701 | 5% |
| Dehyton PK 45 | 3% |
| Deionat | ad 100% |

The samples were contaminated with a fungal mix consisting of:
Aspergillus brasiliensis DSM 1988
Rhodotorula mucilaginosa DSM 13621
Yarrowia lipolytica DSM 8218

The samples were inoculated with the fungal mix at day 0 and 7 to obtain 1-3×10E+05 CFU/ml inoculation in the test sample consisting of the above-defined dish wash detergent MDW and stored at 25° C. for 21 days. CFU was determined before re-inoculation at day 7, and on days 14 and 21.

Any CFU value at d7, d14 or d21 obtained with a MDW sample of the invention containing 2-phenoxyethanol and amide (MDW+2.0% PE+1% of Amide) lower than the respective value of the “comparative 2” example (MDW+2.0% by weight of 2-phenoxyethanol) indicates a better performance of the inventive combination of 2-phenoxyethanol with the amide.

TABLE 1.3

| | d7 | d14 | d21 |
|---|---|---|---|
| | [CFU/ml] | [CFU/ml] | [CFU/ml] |
| MDW - Reference | 67,500 | 57,500 | 75,000 |
| MDW + 1.0% n-Decanoyl-N,N-dimethylamide − | 50,500 | 97,500 | 83,000 |
| Comparative 1 | | | |
| MDW + 2.0% PE − Comparative 2 | 27,500 | 22,000 | 18,000 |

MDW + 2.0% PE + 1.0% Amide

| | | | | |
|---|---|---|---|---|
| 1.0% n-Decanoyl- N,N- dimethylamide | 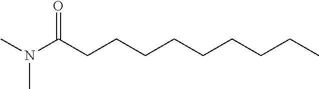 | 19,000 | 10,000 | 5,000 |

The results at d14 and d21 show that the combination of 2-phenoxyethanol and amide overadditively enhances the preservative activity of 2-phenoxyethanol alone.

### 1.4 Preservative Activity in an Enzyme Solution Using 2-Phenoxyethanol (PE) as Antimicrobial Agent

A enzyme solution of pH 6 containing the hydrolase mannanase of the following composition was used:

| | |
|---|---|
| Enzyme (active) | 0.5% |
| Glycerol | 25% |
| Sorbitol | 25% |
| Deionat | ad 100% |

The samples were contaminated with the fungus Aspergillus brasiliensis DSM 1988.

The samples were inoculated with the fungus at day 0 and 15 to obtain 1-3×10E+05 CFU/ml inoculation in the test sample consisting of the above-defined enzyme solution and stored at 25° C. for 29 days. CFU was determined at days 0, 2, 7, 14, 15 (after re-inoculation), 22 and 29 (abbreviated d0, d2, d7, d14, d15, d22, d29).

Any CFU value at d2, d7, d14, d22 or d29 obtained with an enzyme solution sample of the invention containing 2-phenoxyethanol and amide (enzyme solution+0.7% PE+0.07% of amide) lower than the respective value of the comparative example (enzyme solution+0.7% by weight of 2-phenoxyethanol) indicates a better performance of the inventive combination of 2-phenoxyethanol with the amide.

The amide used was N,N-dimethyl-n-decanoyl amide (=n-decanoyl-N,N-dimethylamide).

TABLE 1.4

| | | Enzyme | Enzyme |
|---|---|---|---|
| | Enzyme | solution + | solution + |
| | solution- | 0.7% PE - | 0.7% PE + |
| | Reference | Comparative | 0.07% amide |
| d0 | 110,000 | 110,000 | 110,000 |
| [CFU/ml] | | | |
| d2 | 120,000 | 92,000 | 80,000 |
| [CFU/ml] | | | |
| d7 | 22,000 | 29,000 | 240 |
| [CFU/ml] | | | |
| d14 | 20,000 | 21,000 | 30 |
| [CFU/ml] | | | |
| d15 | 300,000 | 300,000 | 300,000 |
| [CFU/ml] | | | |
| d22 | 120,000 | 67,000 | 14,000 |
| [CFU/ml] | | | |
| d29 | 540,000 | 100,000 | 70 |
| [CFU/ml] | | | |

The use of 0.07% by weight of N,N-dimethyl-n-decanoyl amide alone (no PE) does not have any preservative effect on the enzyme solution at all.

The results at d2, d7, d14, d22 and d29 show that the combination of 2-phenoxyethanol and amide overadditively enhances the preservative activity of 2-phenoxyethanol alone.

### 1.5 Preservative Activity in a Hard Surface Cleaner Composition Using 2-Phenoxyethanol (PE) as Antimicrobial Agent

A manual hard surface cleaner (HSC) of pH 7.0 containing the following components was used:

| | | |
|---|---|---|
| Maranil DBS/LC | Linear C₁₀—C₁₃-alkyl benzene | 2.0% |
| | sulfonate from BASF | |
| Ethanol | | 2.0% |
| Lutensol CS 6250 | Ethoxylated 1-hexanol from BASF | 1.0% |
| Lutensol AO7 | C₁₃/C₁₅ OXO alcohol ethoxylated | 0.66% |
| | with 7 EO from BASF | |
| Edenor K 12-18 | Coconut fatty acid from BASF | 0.66% |
| Deionat | Deionized water | ad 100% |

The samples were contaminated with a fungal mix consisting of:
Aspergillus brasiliensis DSM 1988
Rhodotorula mucilaginosa DSM 13621
Yarrowia lipolytica DSM 8218

The samples were inoculated with the fungal mix at day 0 and 7 to obtain 1-3×10E+05 CFU/ml inoculation in the test sample consisting of the above-defined hard surface cleaner HSC and stored at 25° C. for 21 days. CFU was determined before re-inoculation at day 7, and on days 14 and 21.

Any CFU value at d7, d14 or d21 obtained with a HSC sample of the invention containing 2-phenoxyethanol and amide (HSC+1.35% PE+x % of Amide) lower than the respective value of the “comparative 2” example (HSC+1.35% by weight of 2-phenoxyethanol) indicates a better performance of the inventive combination of 2-phenoxyethanol with the amide.

TABLE 1.5

| | d7 | d14 | d21 |
|---|---|---|---|
| | [CFU/ml] | [CFU/ml] | [CFU/ml] |
| HSC − Reference | 81,000 | >100,000 | 71,000 |
| HSC + 1.35% PE − Comparative 2 | 37,000 | 36,000 | 3200 |

HSC + 1.35% PE + x % Amide

| | | | | |
|---|---|---|---|---|
| 0.25% of mix of n-Octanoyl- and n- Decanoyl-N,N- dimethylamide | 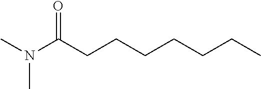 | 2000 | 3000 | 430 |
| | 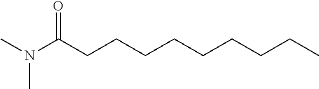 | | | |

The use of 0.25% by weight of the mix of n-cctanoyl- and n-decanoyl-N,N-dimethylamide alone (no PE) does not have any preservative effect on the HSC at all.

The results at d14 and d21 show that the combination of 2-phenoxyethanol and amide overadditively enhances the preservative activity of 2-phenoxyethanol alone.

1.6 Preservative Activity in a Diluted Non-Ionic Surfactant Solution Using 2-phenoxyethanol (PE) as Antimicrobial Agent

A surfactant solution in phosphate buffer of pH 7.0 containing 1% by weight of Lutensol ON 70, a C₁₀-fatty alcohol ethoxylated with 7EO, was used.

The samples were contaminated with a fungal mix consisting of:
Aspergillus brasiliensis DSM 1988
Rhodotorula mucilaginosa DSM 13621
Yarrowia lipolytica DSM 8218

The samples were inoculated with the fungal mix at day 0 and 7 to obtain 1-3×10E+05 CFU/ml inoculation in the test sample consisting of the above-defined surfactant solution and stored at 25° C. for 14 days. CFU was determined before re-inoculation at day 7, and on day 14.

Any CFU value at d7 and d14 obtained with a surfactant solution sample of the invention containing 2-phenoxyethanol and amide (surfactant solution+0.81% PE+0.09% of amide) lower than the respective value of the “comparative 2” example (surfactant solution+0.81% by weight of 2-phenoxyethanol) indicates a better performance of the inventive combination of 2-phenoxyethanol with the amide.

TABLE 1.6

| | d7 | d14 |
|---|---|---|
| | [CFU/ml] | [CFU/ml] |
| Surfactant solution − Reference | >100,000 | >100,000 |
| Surfactant solution + 0.09% amide − Comparative 1 | >100,000 | >100,000 |
| Surfactant solution + 0.81% PE − Comparative 2 | 16,500 | 45,00 |

Surfactant solution + 0.81% PE + 0.09% amide:

| | | | |
|---|---|---|---|
| Mix of n-Octanoyl- and n- Decanoyl-N,N- dimethylamide | 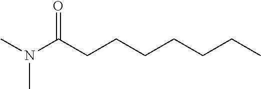 | 15 | 115 |
| | 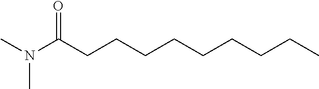 | | |

The results at d7 and d14 show that the combination of 2-phenoxyethanol and amide overadditively enhances the preservative activity of 2-phenoxyethanol alone.

### Example 2 Antimicrobial Activity Against Bacteria

### 2.1 Preservative Activity of a Basic Composition Using 2-Phenoxyethanol (PE) as Antimicrobial Agent

An aqueous composition of pH 7 comprising 10% by weight of propyleneglycol (PG) as organic solvent, 0.36% by weight of 2-phenoxyethanol (PE) as antimicrobial and 0.04% by weight of the amide listed in the below table was tested for its preserving activity against bacterial contamination (the weight percentages relate to the total weight of the composition). For this purpose, the samples were contaminated with a bacterial mix consisting of:
Escherichia coli DSM 1576
Alcaligenes faecalis DSM 13644
Pseudomonas aeuginosa ATCC 15442
Staphylococcus aureus ATCC 6538
Burkholderia cepacia DSM 7288
Pseudomonas putida DSM 12735

The samples were inoculated with the bacterial mix at day 0, 7 and 14 to obtain 10E+06 to 10E+07 CFU/ml inoculation in the test samples (compositions listed in the below table) consisting of 10% by weight of propylene glycol in water and stored at 25° C. for 21 days.

CFU was determined before re-inoculation at days 7 and 14, and on day 21.

Any CFU value at day 7 (d7), day 14 (d14) or day 21 (d21) obtained with a sample according to the invention containing 2-phenoxyethanol and amide (10% PG+0.36% PE+0.04% Amide in water) lower than the respective value of the “comparative 2” example (10% by weight of propyleneglycol+0.4% by weight of 2-phenoxyethanol in water) indicates a better performance.

TABLE 2.1

| | d7 | d14 | d21 |
|---|---|---|---|
| | [CFU/ml] | [CFU/ml] | [CFU/ml] |
| 10% PG − Reference | >100,000 | >100,000 | >100,000 |
| 10% PG + 0.04% Amide − Comparative 1 | >100,000 | >100,000 | >100,000 |
| 10% PG + 0.4% PE − Comparative 2 | 65,000 | >100,000 | >100,000 |

10% PG + 0.36% PE + 0.04% Amide
Amide

| | | | | |
|---|---|---|---|---|
| n-Octanoyl- N,N- dimethylamide | 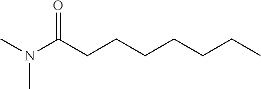 | 25 | 2,100 | 5,550 |
| Isononanoyl- N,N- dimethylamide | 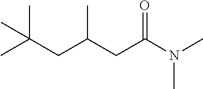 | 3,850 | 13,500 | 5,000 |
| 2-Propyl- heptanoyl- N,N- dimethylamide | 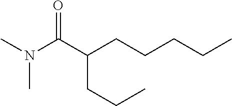 | <10 | 90 | 2,700 |
| n-Decanoyl- N,N- dimethylamide | 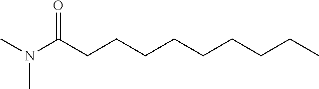 | <10 | <10 | <10 |
| Mix of n- Octanoyl- and n-Decanoyl- N,N- dimethylamide | 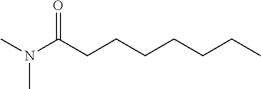 | <10 | <10 | <10 |
| | 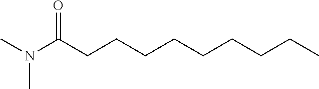 | | | |
| Dodecanoyl- N,N- dimethylamide | 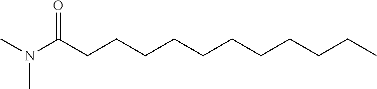 [SMILES: CCCCCCCCCCCC(=O)N(C)C] | <10 | <10 | 450 |
| n-Decanoyl- morpholine | 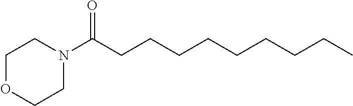 [SMILES: CCCCCCCCCC(=O)N1CCOCC1] | <10 | 30 | 190 |
| Mix of n- Octanoyl- and n-Decanoyl- morpholine | 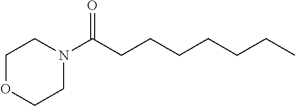 | <10 | <10 | 180 |
| | 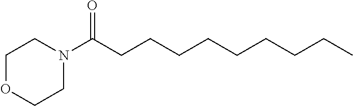 [SMILES: CCCCCCCCCC(=O)N1CCOCC1] | | | |
| n-Propanoyl- N,N- dibutylamide | 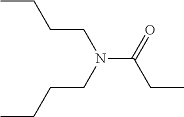 | 39,500 | 39,000 | 23,500 |
| Ethanoyl-N,N- | | 75 | 200 | 1,450 |
| dihexylamide | | | | |
| Maleic acid N- 2-ethylhexyl- amide | 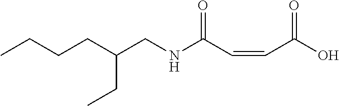 [SMILES: CCCCC(CC)CNC(=O)/C=C\C(=O)O] | 545 | 22,000 | 20,500 |

The comparison of the results obtained with the “Reference” composition and the “Comparative 1” composition shows that the tested amides have no antibacterial activity. The results furthermore show that the combination of 2-phenoxyethanol and amide overadditively enhances the preservative activity of 2-phenoxyethanol alone.

2.2 Preservative Activity of a Basic Composition Using 4,4′-dichloro-2-hydroxydiphenyl Ether (Diclosan) as Antimicrobial Agent

An aqueous composition of pH 7 comprising 10% by weight of propyleneglycol (PG) as organic solvent, 0.015% by weight of 4,4′-dichloro-2-hydroxydiphenyl ether (diclosan) as antimicrobial and 0.04 or 0.1% by weight of the amides listed in the below table was tested for its preserving activity against bacterial contamination (the weight percentages relate to the total weight of the composition). For this purpose, the samples were contaminated with a bacterial mix consisting of:
Escherichia coli DSM 1576
Alcaligenes faecalis DSM 13644
Pseudomonas aeruginosa ATCC 15442
Staphylococcus aureus ATCC 6538
Burkholderia cepacia DSM 7288
Pseudomonas putida DSM 12735

The samples were inoculated with the bacterial mix at day 0 to obtain 10E+06 to 10E+07 CFU/ml inoculation in the test sample and stored at 25° C. for 7 days.

CFU was determined at day 7.

Any CFU value at day 7 (d7) obtained with a sample according to the invention containing diclosan and amide (10% PG+0.015% diclosan+Amide in water) lower than the respective value of the “comparative 3” example (10% by weight of propyleneglycol+0.015% by weight of 4,4′-dichloro-2-hydroxydiphenyl ether (diclosan) in water) indicates a better performance.

TABLE 2.2

| | d7 [CFU/ml] |
|---|---|
| 10% PG − Reference | >100,000 |
| 10% PG + 0.04% n-Decanoyl-morpholine − Comparative 1a | >100,000 |
| 10% PG + 0.1% n-Decanoyl-N,N-dimethylamide − Comparative 1b | >100,000 |
| 10% PG + 0.015% diclosan − Comparative | >100,000 |

10% PG + 0.015% diclosan + Amide
Amide

| | | |
|---|---|---|
| 0.04% n-Decanoyl- morpholine | 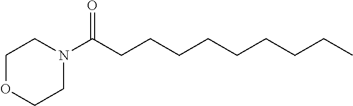 [SMILES: CCCCCCCCCC(=O)N1CCOCC1] | 41,500 |
| 0.1% n-Decanoyl- N,N-dimethylamide | 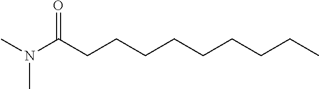 | 43,000 |

The comparison of the results obtained with the “Reference” composition and the “Comparative 1” and “Comparative 2” composition shows that the tested amide has no antibacterial activity. The results furthermore show that the combination of diclosan and amide overadditively enhances the preservative activity of diclosan alone.

2.3 Preservative Activity of a Basic Composition Using 1,2-benzisothiazol-3(2H)-one (BIT) as Antimicrobial Agent

An aqueous composition of pH 7 comprising 10% by weight of propyleneglycol (PG) as organic solvent, 0.004% by weight of 1,2-benzisothiazol-3(2H)-one (BIT) as antimicrobial and 0.04% by weight of the amide listed in the below table was tested for its preserving activity against bacterial contamination (the percentages are weight percent and relate to the total weight of the composition). For this purpose, the samples were contaminated with a bacterial mix consisting of:
Escherichia coli DSM 1576
Alcaligenes faecalis DSM 13644
Pseudomonas aeruginosa ATCC 15442
Staphylococcus aureus ATCC 6538
Burkholderia cepacia DSM 7288
Pseudomonas putida DSM 12735

The samples were inoculated with the bacterial mix at day 0 to obtain 10E+06 to 10E+07 CFU/ml inoculation in the test sample and stored at 25° C. for 7 days.

CFU was determined at day 7.

Any CFU value at day 7 (d7) obtained with a sample according to the invention containing BIT and amide (10% PG+0.004% BIT+Amide in water) lower than the respective value of the “comparative 2” example (10% by weight of propyleneglycol+0.004% by weight of 1,2-benzisothiazol-3(2H)-one (BIT) in water) indicates a better performance.

TABLE 2.3

| | d7 [CFU/ml] |
|---|---|
| 10% PG − Reference | >100,000 |
| 10% PG + 0.1% Amide − Comparative 1 | >100,000 |
| 10% PG + 0.004% BIT − Comparative 2 | >100,000 |

10% PG + 0.004% BIT + Amide
Amide

| | | |
|---|---|---|
| 0.04% n-Decanoyl- N,N-dimethylamide | 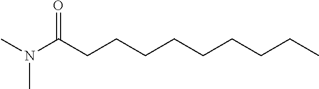 | 4,000 |

The comparison of the results obtained with the “Reference” composition and the “Comparative 1” composition shows that the tested amide has no antibacterial activity. The results furthermore show that the combination of BIT and amide overadditively enhances the preservative activity of BIT alone.

2.4 Preservative Activity in a Manual Dishwashing Composition Using 2-phenoxyethanol (PE) as Antimicrobial Agent

A manual dish wash detergent (MDW) of pH 7.1 containing the following components was used:

| | |
|---|---|
| Texapon K 12 G | 3.5% |
| Glucopon 600 CSUP | 5% |
| Texapon N 701 | 5% |
| Dehyton PK 45 | 3% |
| Deionat | ad 100% |

The samples were contaminated with a bacterial mix consisting of:
Escherichia coli DSM 1576
Alcaligenes faecalis DSM 13644
Pseudomonas aeruginosa ATCC 15442
Staphylococcus aureus ATCC 6538
Burkholderia cepacia DSM 7288
Pseudomonas putida DSM 12735

The samples were inoculated with the bacterial mix at day 0 and 7 to obtain 10E+06 to 10E+07 CFU/ml inoculation in the test sample and stored at 25° C. for 21 days. CFU was determined before re-inoculation at day 7 and on days 14 and 21.

Any CFU value at day 7 (d7), day 14 (d14) or day 21 (d21) obtained with a sample according to the invention containing 2-phenoxyethanol and amide (MDW+2.0% PE+x % Amide) lower than the respective value of the “comparative 2” example (MOW+2.0% by weight of 2-phenoxyethanol) indicates a better performance.

TABLE 2.4a

| | d7 | d14 | d21 |
|---|---|---|---|
| | [CFU/ml] | [CFU/ml] | [CFU/ml] |
| MDW − Reference | >100,000 | >100,000 | >100,000 |
| MDW + 1.0% 50:50 Mix of | >100,000 | >100,000 | >100,000 |
| n-Octyl- and n-Decanoyl-N,N-dimethylamide − Com- | | | |
| parative 1a | | | |
| MDW + 0.5% 50:50 Mix of | >100,000 | >100,000 | >100,000 |
| n-Octyl- and n-Decanoyl-N,N-dimethylamide − Com- | | | |
| parative 1b | | | |
| MDW + 0.25% 50:50 Mix of | >100,000 | >100,000 | >100,000 |
| n-Octyl- and n-Decanoyl-N,N-dimethylamide − Com- | | | |
| parative 1c | | | |
| MDW + 2.0% PE − Comparative 2 | 330 | 2,800 | 38,500 |

MDW + 2.0% PE + x % Amide
Amide

| | | | | |
|---|---|---|---|---|
| 1.0% 50:50 Mix of n-Octyl- and n- Decanoyl-N,N- dimethylamide | 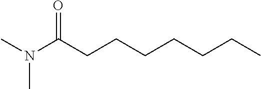 | <10 | 15 | 2,000 |
| | 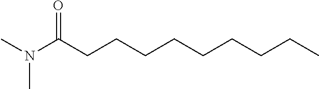 | | | |
| 0.5% 50:50 Mix of n-Octyl- and n- Decanoyl-N,N- dimethylamide | 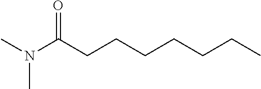 | <10 | 20 | 2.000 |
| | 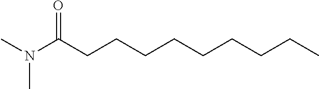 | | | |
| 0.25% 50:50 Mix of n-Octyl- and n- Decanoyl-N,N- dimethylamide | 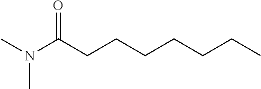 | 120 | 220 | 1.750 |
| | 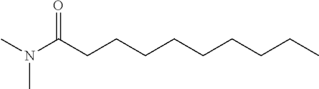 | | | |

TABLE 2.4b

| | d7 | d14 | d21 |
|---|---|---|---|
| | [CFU/ml] | [CFU/ml] | [CFU/ml] |
| MDW − Reference | >100,000 | >100,000 | >100,000 |
| MDW + 5.0% Maleic acid N-2-ethylhexyl-amide- | >100,000 | >100,000 | >100,000 |
| Comparative 1a | | | |
| MDW + 1.0% Maleic acid N-2-ethylhexyl-amide- | >100,000 | >100,000 | >100,000 |
| Comparative 1b | | | |
| MDW + 0.25% Maleic acid N-2-ethylhexyl-amide- | >100,000 | >100,000 | >100,000 |
| Comparative 1c | | | |
| MDW + 2.0% PE − Comparative 2 | 330 | 2,800 | 38,500 |

MDW + 2.0% PE + x % Amide
Amide

| | | | | |
|---|---|---|---|---|
| 5.0% Maleic acid N- 2-ethylhexyl- amide | 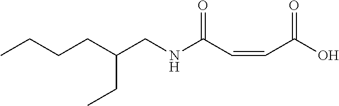 [SMILES: CCCCC(CC)CNC(=O)/C=C\C(=O)O] | <10 | <10 | <10 |
| 1.0% Maleic acid N- 2-ethylhexyl- amide | 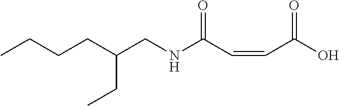 [SMILES: CCCCC(CC)CNC(=O)/C=C\C(=O)O] | <10 | <10 | <10 |
| 0.25% Maleic acid N- 2-ethylhexyl- amide | 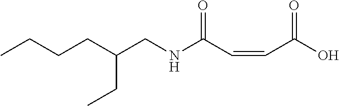 [SMILES: CCCCC(CC)CNC(=O)/C=C\C(=O)O] | <10 | <10 | <10 |

The comparison of the results obtained with the “Reference” composition and the “Comparative 1a/1b/1c” compositions shows that the tested amides have no antibacterial activity. The results furthermore show that the combination of 2-phenoxyethanol and amide overadditively enhances the preservative activity of BIT alone.

2.5 Preservative Activity in a Manual Dishwashing Composition Using 2-phenoxyethanol (PE) as Antimicrobial Agent

A manual dish wash detergent (MOW) of pH 7.1 containing the following components was used:

| | |
|---|---|
| Texapon K 12 G | 3.5% |
| Glucopon 600 CSUP | 5% |
| Texapon N 701 | 5% |
| Dehyton PK 45 | 3% |
| n-Propanol | 2% |
| Deionat | ad 100% |

The samples were contaminated with a bacterial mix consisting of:
Escherichia coli DSM 1576
Alcaligenes faecalis DSM 13644
Pseudomonas aeruginosa ATCC 15442
Staphylococcus aureus ATCC 6538
Burkholderia cepacia DSM 7288
Pseudomonas putida DSM 12735

The samples were inoculated with the bacterial mix at day 0 and 7 to obtain 10E+06 to 10E+07 CFU/ml inoculation in the test sample and stored at 25° C. for 21 days. CFU was determined before re-inoculation at day 7 and on day 21.

Any CFU value at day 7 (d7) or day 21 (d21) obtained with a sample according to the invention containing 2-phenoxyethanol and amide (MDW+1.0% PE+1.0% Amide) lower than the respective value of the comparative example (MDW+1% by weight of 2-phenoxyethanol) indicates a better performance.

TABLE 2.5

| | d7 | d21 |
|---|---|---|
| | [CFU/ml] | [CFU/ml] |
| MDW + 1.0% PE − Comparative | 820 | 135 |

MDW + 1.0% PE + 1.0% Amide
Amide

| | | | |
|---|---|---|---|
| 1% N,N- dimethyl 9- decenoylamide | 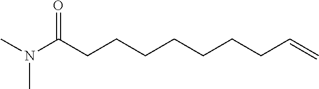 | <10 | <10 |

The results show that the combination of 2-phenoxyethanol and amide or diclosan and amide or BIT and amide overadditively enhances the preservative activity of 2-phenoxyethanol alone or diclosan alone or BIT alone.

1: A composition comprising
(a) at least one antimicrobial agent selected from the group consisting of 2-phenoxyethanol, phenoxyisopropanol, 4,4′-dichloro 2′-hydroxydiphenylether, 2-bromo-2-nitropropane-1,3-diol, glutaraldehyde, 2,4-dichlorobenzylalcohol, 1,3,5-tris-(2-hydroxyethyl)-1,3,5-hexahydrotriazine, formic acid and salts thereof, benzoic acid and salts thereof, sorbic acid and salts thereof, lactic acid and salts thereof, isothiazolinones selected from the group consisting of 1,2-benzisothiazol-3(2H)-one (BIT), 2-methyl-2H-isothiazol-3-one (MIT), 2-octyl-2H-isothiazol-3-one (OIT), 5-chloro-2-methyl-2H-isothiazol-3-one (CMIT), and 2-butyl-benzo[d]isothiazol-3-one (BBIT); 3-iodo-2-propynylbutylcarbamate (IPBC), benzyl alcohol, pyridine-2-thiol 1-oxide and salts thereof; 2,2-dibromo-2-cyanoacetamide (DBNPA), N-(3-aminopropyl)-N-dodecylpropane-1,3-diamine (Diamine), tetrakis(hydroxymethyl)phosphonium sulphate(2:1) (THPS), 2,2-dithiobis[N-methylbenzamide](DTBMA), 2-bromo-2-(bromomethyl)pentanedinitril (DBDCB), biphenyl-2-ol and salts thereof; and mixtures thereof; and
(b) at least one carboxamide compound of the formula (I) or a mixture of different carboxamide compounds of the formula (I) 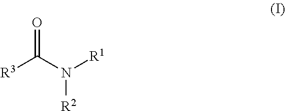
where
R¹ is hydrogen or C₁-C₈-alkyl;
R² is C₆-C₁₈-alkyl or C₆-C₁₈-alkenyl; and
R³ is C₂-C₆-alkenyl which carries a group —C(O)OH or C(O)O⁻M⁺, where M⁺ is a cation equivalent;
or
R¹ and R², independently of each other, are C₁-C₈-alkyl; and
R³ is C₁-C₁₃-alkyl or C₄-C₁₂-alkenyl;
where R¹, R² and R³ have in sum from 6 to 18 carbon atoms;
or
R¹ and R², together with the nitrogen atom to which they are bound, form a 5-, 6-, or 7-membered saturated, partially unsaturated or maximally unsaturated heterocyclic ring which may contain a further heteroatom or heteroatom group selected from O, N, S, S(O) or S(O)₂ as ring member, where the heterocyclic ring may carry one or more substituents R;
R³ is C₁-C₁₃-alkyl; and
each R⁴ is independently selected from the group consisting of halogen, CN, NO₂, OH, SH, NH₂, C(O)OH, C(O)O⁻M⁺, where M⁺ is a cation equivalent; C(O)NH₂, oxo and C₁-C₄-alkyl;
or
R¹ and R³, together with the atoms to which they are bound, form a 5-, 6-, or 7-membered saturated, heterocyclic ring which may contain a further heteroatom or heteroatom group selected from O, N, S, S(O) or S(O)₂ as ring member, where the heterocyclic ring may carry one or more substituents R⁴;
R² is hydrogen or C₁-C₅-alkyl; and
each R⁴ is independently selected from the group consisting of halogen, CN, NO₂, OH, SH, NH₂, C(O)OH, C(O)O⁻M⁺, where M⁺ is a cation equivalent; C(O)NH₂, oxo and C₁-C₄-alkyl;
where components (a) and (b) are present in an overall weight ratio of from 500:1 to 1:1000;
with the proviso that the composition does not contain poly(hexamethylene biguanidine) and salts thereof; and with the proviso that in case the composition is non-aqueous, the composition does not contain any alkali metal hydroxide.

2: The composition as claimed in claim 1,
where the carboxamide compound of the formula (I) is not N-methylpyrrolidione;
where the composition does not contain an alkyl lactate if the antimicrobial agent is benzyl alcohol and simultaneously in the carboxamide compound of the formula (I) R¹ and R² are C₁-C₄-alkyl and R³ is C₆-C₁₃-alkyl;
where the antimicrobial agent is not formic acid or benzoic acid or lactic acid or a salt thereof if in the carboxamide compound of the formula (I) R¹ and R² are C₁-C₈-alkyl; and R³ is C₁-C₁₃-alkyl;
where the composition does not contain any parabene if the antimicrobial agent is 2-phenoxyethanol and simultaneously in the carboxamide compound of the formula (I) R¹ and R² methyl and R³ is C₃-C₁₃-alkyl; and
where the composition does not contain simultaneously benzyl alcohol, N,N-dimethyloctanamide, N,N-dimethyldecanamide, castor oil ethoxylate, EO/PO copolymer and an ethoxylated phosphate ester.

3: The composition as claimed in claim 1, where the antimicrobial agent is selected from the group consisting of 2-phenoxyethanol, phenoxyisopropanol, 4,4′-dichloro 2′-hydroxydiphenylether, 2-bromo-2-nitropropane-1,3-diol and isothiazolinones selected from the group consisting of 1,2-benzisothiazol-3(2H)-one (BIT), 2-methyl-2H-isothiazol-3-one (MIT), 2-octyl-2H-isothiazol-3-one (OIT), 5-chloro-2-methyl-2H-isothiazol-3-one (CMIT) and 2-butyl-benzo[d]isothiazol-3-one (BBIT).

4: The composition as claimed in claim 3, where the antimicrobial agent is selected from the group consisting of 2-phenoxyethanol, 4,4′-dichloro 2′-hydroxydiphenylether and 1,2-benzisothiazol-3(2H)one (BIT).

5: The composition as claimed in claim 4, where the antimicrobial agent is 2-phenoxyethanol.

6: The composition as claimed in claim 1, where in compounds (I)
R¹ is hydrogen or C₁-C₈-alkyl;
R² is C₆-C₁₈-alkyl or C₆-C₁₈-alkenyl; and
R³ is C₂-C₆-alkenyl which carries a group —C(O)OH or C(O)O⁻M⁺, where M⁺ is a cation equivalent;
or
R¹ and R², independently of each other, are C₁-C₈-alkyl; and
R³ is C₁-C₁₃-alkyl or C₄-C₁₂-alkenyl;
where R¹, R² and R³ have in sum from 6 to 18 carbon atoms;
or
R¹ and R², together with the nitrogen atom to which they are bound, form a 5-, 6-, or 7-membered saturated, partially unsaturated or maximally unsaturated heterocyclic ring which may contain a further heteroatom or heteroatom group selected from O, N, S, S(O) or S(O)₂ as ring member, where the heterocyclic ring may carry one or more substituents R;
R³ is C₁-C₁₃-alkyl; and
each R⁴ is independently selected from the group consisting of halogen, CN, NO₂, OH, SH, NH₂, C(O)OH, C(O)O⁻M⁺, where M⁺ is a cation equivalent; C(O)NH₂, oxo and C₁-C₄-alkyl.

7: The composition as claimed in claim 6, where
R¹ is hydrogen or C₁-C₈-alkyl; R² is C₆-C₁₈-alkyl or C₆-C₁₈-alkenyl; and R³ is —CH═CH—COOH or —CH═CH—C(O)O⁻M⁺; or
R¹ and R² are C₁-C₄-alkyl; and R³ is C₆-C₁₃-alkyl; or
R¹ and R² are C₄-C₈-alkyl; and R³ is C₁-C₃-alkyl; or
R¹ and R² are C₁-C₄-alkyl; and R³ is C₇-C₁₁-alkenyl; or
R¹ and R², together with the nitrogen atom to which they are bound, form a 6-membered saturated heterocyclic ring which contains a further heteroatom selected from 0 and N as ring member; and R³ is C₁-C₁₃-alkyl, in particular C₆-C₁₃-alkyl.

8: The composition as claimed in claim 7, where
R¹ is hydrogen; R² is C₆-C₁₂-alkyl; and R³ is —CH═CH—COOH or —CH═CH—C(O)O⁻M⁺, where M⁺ is an alkali metal cation or an ammonium cation of the formula [NR^{a}R^{b}R^{c}R^{d}]⁺, where R^{a}, R^{b}, R^{c} and R^{d}, independently of each other, are selected from the group consisting of hydrogen, C₁-C₄-alkyl and C₁-C₄-alkoxy; or
R¹ and R² are C₁-C₂-alkyl; and R³ is C₇-C₁₁-alkyl; or
R¹ and R² are C₁-C₂-alkyl; and R³ is C₇-C₁₁-alkenyl; or
R¹ and R² form together a bridging group —CH₂—CH₂—O—CH₂—CH₂—; and R³ is C₅-C₁₃-alkyl, in particular C₇-C₁₁-alkyl.

9: The composition as claimed in claim 8, where
R¹ is hydrogen; R² is C₆-C₁₂-alkyl; and R³ is —CH═CH—COOH or —CH═CH—C(O)O⁻M⁺; or
R¹ and R² form together a bridging group —CH₂—CH₂—O—CH₂—CH₂—; and R³ is C₅-C₁₃-alkyl.

10: The composition as claimed in claim 8, where the compound of the formula (I) is selected from the group consisting of n-decanoyl-N,N-dimethylamide; n-octanoyl-N,N-dimethylamide; a mixture of n-decanoyl-N,N-dimethylamide and n-octanoyl-N,N-dimethylamide; n-decanoylmorpholine; n-octanoylmorpholine; a mixture of n-decanoylmorpholine and n-octanoylmorpholine; and N,N-dimethyl 9-decenamide.

11: The composition as claimed in claim 1, where
R¹ and R³, together with the atoms to which they are bound, form a 5-, 6-, or 7-membered saturated heterocyclic ring which may contain a further heteroatom or heteroatom group selected from O, N, S, S(O) or S(O)₂ as ring member, where the heterocyclic ring may carry one or more substituents R⁴; and
R² is selected from the group consisting of hydrogen and C₁-C₄-alkyl;
where the carboxamide compound of the formula (I) is not N-methylpyrrolidione.

12: The composition as claimed in claim 1, where the antimicrobial agent and the carboxamide compound of the formula (I) are present in an overall weight ratio of from 200:1 to 1:500.

13: The composition as claimed in claim 12, where the antimicrobial agent and the carboxamide compound of the formula (I) are present in an overall weight ratio of from 15:1 to 1:15.

14: The composition as claimed in claim 1, where:
the antimicrobial agent is selected from the group consisting of 2-phenoxyethanol, 4,4′-dichloro 2′-hydroxydiphenylether and 1,2-benzisothiazol-3(2H)one (BIT);
in the carboxamide compound of the formula (I)
R¹ is hydrogen; R² is C₆-C₁₂-alkyl; and R³ is —CH═CH—COOH or —CH═CH—C(O)O⁻M⁺, where M⁺ is an alkali metal cation or an ammonium cation of the formula [NR^{a}R^{b}R^{c}R^{d}]⁺, where R^{a}, R^{b}, R^{c} and R^{d}, independently of each other, are selected from the group consisting of hydrogen, C₁-C₄-alkyl and C₁-C₄-alkoxy; or
R¹ and R² are C₁-C₂-alkyl; and R³ is C₇-C₁₁-alkyl; or
R¹ and R² are C₁-C₂-alkyl; and R³ is C₇-C₁₁-alkenyl; or
R¹ and R² form together a bridging group —CH₂—CH₂—O—CH₂—CH₂—; and R³ is C₅-C₁₃-alkyl, in particular C₇-C₁₁-alkyl;
and the antimicrobial agent and the carboxamide compound of the formula (I) are present in an overall weight ratio of from 15:1 to 1:15; and
where in case that the antimicrobial agent is 2-phenoxyethanol and in compounds (I) R¹ and R² are C₁-C₂-alkyl and R³ is C₇-C₁₁-alkyl, 2-phenoxyethanol and compounds (I) are present in an overall weight ratio of from 15:1 to 1:1.

15: The composition as claimed in claim 1, further comprising at least one organic solvent.

16: The composition as claimed in claim 15, where the solvent is selected from the group consisting of C₂-C₃-alkanols, C₁-C₆-alkylmonoethers of C₂-C₄-alkanediols and 5-, 6- or 7-membered lactones which may carry one or ore C₁-C₁₂-alkyl groups.

17: The composition as claimed in claim 1, which is selected from the group consisting of antimicrobial concentrates, homecare compositions, compositions for cleaning or disinfecting on an industrial scale, personal care compositions, process water, water in fish or shrimp ponds, water in drinking troughs, metal working fluids; water based raw materials, polymer solutions, polymer dispersions, polymer emulsions, inorganic slurries, organic slurries, surfactant compositions; compositions for treating animal hide; compositions for treating leather; compositions for treating textiles during the manufacturing process thereof; compositions for treating lumber; compositions for treating paper or the precursor material during papermaking processes; crop protection compositions; pharmaceutical compositions; paints, glues, adhesives, sealants, dyes, pigments and dispersions thereof, inks, and wet wipes.

18: (canceled)

19: A kit of parts for preparing the composition as claimed in claim 1, the kit comprising:
a first part comprising (a) the at least one antimicrobial agent;
a second part comprising (b) the at least one carboxamide compound of formula (I) and optionally at least one organic solvent different from the at least one carboxamide compound of formula (I); and
optionally a third part comprising at least one organic solvent different from the at least one carboxamide compound of formula (I);
wherein:
the first part does not comprise the carboxamide compound of formula (I);
the second part does not comprise the antimicrobial agent;
the third part does not comprise the carboxamide compound of formula (I) or the antimicrobial agent components (a) and (b) are present in the first part and the second part, respectively, such that an overall weight ratio (a):(b) is 500:1 to 1:1000.

20-26: (canceled)

27: A method for enhancing antimicrobial properties of an antimicrobial agent, comprising forming the composition as claimed in claim 1 by:
combining component (a) and component (b): or
separately applying component (a) and component (b) to a composition, surface, area, or space in or on which microbes are to be combated.

28: A method for combating microbes with the composition as claimed in claim 1, comprising:
applying the composition to a composition, surface, area, or space in or on which microbes are to be combated: or
separately applying component (a) and component (b) to the composition, surface, area, or space in or on which microbes are to be combated.
